(19) United States
(12) Patent Application Publication
(10) Pub. No.: US 2012/0135060 A1
(43) Pub. Date: May 31, 2012

(54) COMPOSITIONS AND METHODS FOR CELL KILLING

(76) Inventors: Shmuel BUKSHPAN, Ramat Hasharon (IL); Avi SHANI, Kfar Haoranim (IL); Gleb ZILBERSTEIN, Rehovot (IL)

(21) Appl. No.: 13/284,305

(22) Filed: Oct. 28, 2011

Related U.S. Application Data
(63) Continuation-in-part of application No. 12/823,354, filed on Jun. 25, 2010.
Application No. 12/823,354 is a continuation-in-part of application No. 11/590,756, filed on Nov. 1, 2006, now Pat. No. 7,794,698.
Application No. 11/590,756 is a continuation-in-part of application No. 12/594,384, filed on Oct. 2, 2009.
(60) Provisional application No. 60/732,130, filed on Nov. 2, 2005.
(60) Provisional application No. 60/907,463, filed on Apr. 3, 2007.
(60) Provisional application No. 61/552,106, filed on Oct. 27, 2011.
(60) Provisional application No. 61/439,887, filed on Feb. 6, 2011.

(51) Int. Cl. A01N 41/04; A01N 55/10; A01N 25/10; A01P 1/00; C08F 14/26; A01N 25/34; B82Y 99/00

(52) U.S. Cl. 424/404; 521/25; 424/78.1; 424/400; 977/773; 977/902; 977/788

(57) ABSTRACT

Provided herein are biocidic compositions including an ion exchange material, wherein when said material is in an environment capable of transporting H⁺, said ion exchange material is adapted to cause the death of at least one cell within or in contact with said environment. A selectively permeable barrier layer may be provided covering the ion exchange material. Also provided herein are methods of making the foregoing biocidic compositions. In addition, provided herein are methods of using the foregoing biocidic compositions to cause the death of at least one cell.

### CROSS-REFERENCE TO RELATED APPLICATIONS

This application is a Continuation-in-Part of U.S. patent application Ser. No. 12/823,354, filed Jun. 25, 2010, which is a Continuation-in-Part of U.S. patent application Ser. No. 11/590,756 (now U.S. Pat. No. 7,794,698), filed Nov. 1, 2006, which claims the benefit of U.S. Provisional Patent Application No. 60/732,130, filed Nov. 2, 2005; this application is also a Continuation-in-Part of U.S. patent application Ser. No. 12/594,384, filed Oct. 2, 2009, which is a National Phase Application of PCT International Application No. PCT/IL08/00465, filed on Apr. 3, 2008, and which claims priority to U.S. Provisional Patent Application No. 60/907,463, filed on Apr. 3, 2007; this application also claims priority to U.S. Provisional Patent Application Nos. 61/552,106, filed on Oct. 27, 2011 and 61/439,887, filed on Feb. 2, 2011. The contents of each of the foregoing applications are hereby incorporated by reference in its entirety.

### FIELD OF THE INVENTION

The present invention generally relates to biocide compositions, as well as to methods of using and preparing the same. The present invention further pertains to articles of manufacture which comprises said biocides.

### BACKGROUND OF THE INVENTION

Various forms of cellular material are known to be harmful and potentially lethal to humans. For example, cellular microorganisms are responsible for a wide range of diseases. Microorganisms can invade the host tissues and proliferate, causing severe disease symptoms. Pathogenic bacteria have been identified as a root cause of a variety of debilitating or fatal diseases including, for example, tuberculosis, cholera, whooping cough, plague, and the like. To treat such severe infections, drugs such as antibiotics are administered that kill the infectious agent. However, pathogenic bacteria commonly develop resistance to antibiotics and improved agents are needed to prevent the spread of infections due to such microorganisms.

One of the principal concerns with respect to products that are introduced into the body or provide a pathway into the body is bacterial infection. Avoiding such infections with implantable medical devices can be particularly problematic because bacteria can develop into biofilms, which protect the microbes from clearing by the subject's immune system. As these infections are difficult to treat with antibiotics, removal of the device is often necessitated, which is traumatic to the patient and increases the medical cost. Accordingly, for such medical apparatuses, the art has long sought means and methods of rendering those medical apparatuses and devices antibacterial and, hopefully, antimicrobial.

One general approach in the art has been that of coating the medical apparatuses, or a surface thereof, with a bactericide. However, since most bactericides are partly water soluble, or at least require sufficient solubilization for effective antibacterial action, simple coatings of the bactericides have been proven unreliable.

For this reason, the art has sought to incorporate the bactericides into the medical apparatus or at least provide a stabilized coating thereon.

Alternatively, materials can be impregnated with antimicrobial agents, such as antibiotics, quarternary ammonium compounds, silver ions, or iodine, which are gradually released into the surrounding solution over time and kill microorganisms there. Although these strategies have been verified in aqueous solutions containing bacteria, they would not be expected to be effective against airborne bacteria in the absence of a liquid medium; this is especially true for release-based materials, which are also liable to become impotent when the leaching antibacterial agent is exhausted.

Biofilm formation has further important public health implications. Drinking water systems are known to harbor biofilms, even though these environments often contain disinfectants. Any system providing an interface between a surface and a fluid has the potential for biofilm development. Water cooling towers for air conditioners are well-known to pose public health risks from biofilm formation, as episodic outbreaks of infections like Legionnaires' disease attest. Biofilms have been identified in flow conduits like hemodialysis tubing, and in water distribution conduits. Biofilms have also been identified to cause biofouling in selected municipal water storage tanks, private wells and drip irrigation systems, unaffected by treatments with up to 200 ppm chlorine.

Biofilms are also a constant problem in food processing environments. Food processing involves fluids, solid material and their combination. As an example, milk processing facilities provide fluid conduits and areas of fluid residence on surfaces. Cleansing milking and milk processing equipment presently utilizes interactions of mechanical, thermal and chemical processes in air-injected clean-in-place methods. Additionally, the milk product itself is treated with pasteurization. In cheese production, biofilms can lead to the production of calcium lactate crystals in Cheddar cheese. Meat processing and packing facilities are in like manner susceptible to biofilm formation. Non-metallic and metallic surfaces can be affected. Biofilms in meat processing facilities have been detected on rubber “fingers,” plastic curtains, conveyor belt material, evisceration equipment and stainless steel surfaces. Controlling biofilms and microorganism contamination in food processing is hampered by the additional need that the agents and/or processes used not affect the taste, texture or aesthetics of the product.

There exists, therefore, a need to be able to render general surfaces bactericidal. There is a keen interest in materials capable of killing harmful microorganisms. Such materials could be used to coat surfaces of common objects touched by people in everyday lives, e.g., door knobs, children toys, computer keyboards, telephones, fabrics, medical devices etc., to render them antiseptic and thus unable to transmit bacterial infections. Since ordinary materials are not antimicrobial or cell-killing, their modification is required. For example, surfaces chemically modified with poly(ethylene glycol) and certain other synthetic polymers can repel (although not kill) microorganisms (Bridgett, M. J., et al., (1992) Biomaterials 13, 411-416; Arciola, C. R., et al Alvergna, P., Cenni, E. & Pizzoferrato, A. (1993) Biomaterials 14, 1161-1164; Park, K. D., Kim, Y. S., Han, D. K., Kim, Y. H., Lee, E. H. B., Suh, H. & Choi, K. S. (1998) Biomaterials 19, 51-859.).

Food and beverages are also a source of bacterial infection and the preservation thereof is of utmost importance in order to keep them safe for consumption and inhibit or prevent nutrient deterioration or organoleptic changes, causing them to become less palatable and even toxic. Preservation of food and beverage products can be achieved using a variety of approaches. Physical manipulations of food and beverage products that have a preservative effect include, for example, freezing, refrigerating, cooking, retorting, pasteurizing, drying, vacuum packing and sealing in an oxygen-free package. Some of these approaches can be part of a food or beverage processing operation. Food processing steps preferably are selected to strike a balance between obtaining a microbially-safe product, while producing a product with desirable qualities.

With the increasing use of polymeric materials for construction of medical apparatuses and packaging and handling of food and beverages, utilizing an antimicrobial polymer has become ever more desirable. Although, antimicrobial polymers exist in the art, there is still a need for an improved antimicrobial polymer coating that may be easily and cheaply applied to a substrate to provide an article which has excellent antimicrobial properties and which retains its antimicrobial properties in a permanent and non-leachable fashion when in contact with cellular material for prolonged periods

U.S. Pat. Appl No. 20050271780 teaches a bactericidal polymer matrix being bound to an ion exchange material such as a quaternary ammonium salt for use in food preservation. This polymer matrix kills bacteria by virtue of incorporating therein of a bactericidal agent (e.g. the quaternary ammonium salt). The positive charge of the agent merely aids in electrostatic attraction between itself and the negatively charged cell walls. In addition, the above described application does not teach use of solid ion exchange materials having a buffering capacity throughout their entire body.

U.S. Pat. Appl. No. 20050249695 teaches immobilization of antimicrobial molecules such as quarternary ammonium or phosphonium salts (cationic, positively charged entities) covalently bound onto a solid surface to render the surface bactericidal. The polymers described herein are attached to a solid surface by virtue of amino groups attached thereto and as such the polymer is only capable of forming a monolayer on the solid surface.

U.S. Pat. Appl. No. 20050003163 teaches substrates having antimicrobial and/or antistatic properties. Such properties are imparted by applying a coating or film formed from a cationically-charged polymer composition.

The activity of the polymers as described in U.S. Pat. Appl. Nos. 20050271780, 20050249695 and 20050003163 relies on the direct contact of the bactericidal materials with the cellular membrane. The level of toxicity is strongly dependent on the surface concentration of the bactericidal entities. This requirement presents a strong limitation since the exposed cationic materials can be saturated very fast in ion exchange reactions.

In addition, none of the above described U.S. patent applications teach killing eukaryotic cells. Nor do they teach the in vivo use of polymers as cytotoxic agents against either eukaryotic or prokaryotic cell types. Furthermore, none of the above mentioned U.S. patent applications teach configuration of the polymers to selectively kill certain cell types.

Certain zeolites are also known biocidic materials. Zeolites are crystalline aluminosilicate minerals with a structure characterized by a framework of linked tetrahedra, each consisting of four O atoms surrounding a wide variety of cations, such as Na⁺, K⁺, Ca²⁺, Mg²⁺, etc. These positive ions are rather loosely held and can readily be exchanged for others. The zeolite structure comprises a regular framework surrounding pores that are generally of molecular dimensions. These molecular-sized pores give zeolites the ability to sort molecules selectively based primarily on a size exclusion process, and hence, one of the primary uses of zeolites is as “molecular sieves.” The maximum size of the molecular or ionic species that can enter the pores of a zeolite is controlled by the dimensions of the channels. These are conventionally defined by the ring size of the aperture, where, for example, the term “8-ring” refers to a closed loop that is built from 8 tetrahedrally coordinated silicon or aluminum atoms and 8 oxygen atoms. These rings are not always perfectly symmetrical due to a variety of effects, including strain induced by the bonding between units that are needed to produce the overall structure, or coordination of some of the oxygen atoms of the rings to cations within the structure.

Zeolites comprising cations, salts or oxides of metals such as zinc, silver, and tin, are known biocidic materials. For example, U.S. Pat. No. 4,115,130 discloses organo-tin zeolites suitable for use in marine anti-fouling coatings. U.S. Pat. No. 5,256,390 discloses a method of producing zeolite particles with reduced carbonate species so that the zeolite particles are ion exchangeable with biocidal transition metal ions, such as Ag⁺, Cu²⁺, and Zn²⁺. U.S. Pat. Appl. 20100221486 discloses a biocidic zeolite composition comprising an inorganic biocide and at least one organic biocidic compound, wherein the inorganic biocide consists of at least one nanoscale metal oxide selected from ZnO, BaTiO₃, SrTiO₃, TiO₂, WO₃, Al₂O₃, CuO, NiO, ZrO₂ and MgO.

These metallic zeolites, despite their effectiveness as biocides, possess marked disadvantages such as the possibility of leaching of the toxic metal ion or salts into the body. These materials may cause skin, eye and respiratory irritations. Silver zeolite, for example, is considered to be a toxic material; the MSDS of commercially available silver-exchanged zeolite, Ag₈₄Na₂[(AlO₂)₈₆(SiO₂)₁₀₆]·xH₂O, lists the material as harmful by inhalation and irritating to the eyes and respiratory system.

Because zeolites are widely found in nature, they tend to be relatively inexpensive. Zeolite biocides and methods for using them as biocides that do not involve incorporation into to the zeolite of a biocidic material such a heavy metal or ion or salt thereof would thus be both economically advantageous and of increased safety relative to methods known in the art. Development of such a biocidic zeolitic compositions and methods for using them thus represents a long-felt yet unmet need.

There thus remains a need for and it would be highly advantageous to have additional biocide compositions and methods for using and making them.

### SUMMARY OF THE INVENTION

Provided herein are biocide compositions including an ion exchange material, wherein when said material is in an environment capable of transporting H⁺, said ion exchange material is adapted to cause the death of at least one cell within or in contact with said environment. A selectively permeable barrier layer may be provided covering the ion exchange material. Also provided herein are methods of making the foregoing biocide compositions. In addition, provided herein are methods of using the biocide compositions described herein to cause the death of at least one cell.

According to one aspect, methods of generating a change in a cellular process of a target cell of a multicellular organism are provided; the methods comprising contacting the target cell with an ion exchange material, so as to alter an intracellular pH value in at least a portion of the cell, thereby generating the change in a cellular process of a target cell of a multicellular organism.

According to another aspect, methods of killing a target cell of a multicellular organism are provided; the methods comprising contacting the target cell with an ion exchange material, so as to alter an intracellular pH value in at least a portion of the cell, thereby killing the target cell.

According to still another aspect, methods of generating a change in a cellular process of a cell; the methods comprising contacting the cell with a biocide composition, wherein the biocide composition comprises an ion exchange material covered at least in part with a water permeable layer being disposed on an external surface of the buffering layer, so as to alter an intracellular pH value in at least a portion of the cell, thereby killing the cell.

According to certain embodiments of the foregoing methods, the ion exchange material is anionic; while according to other embodiments the ion exchange material is cationic.

According to an additional aspect, methods of killing a cell are provided; the methods comprising contacting the cell with a an ion exchange material, the ion exchange material comprising a volumetric buffering capacity greater than 20 mM H⁺/L.pH or greater than 50 mM H⁺/L.pH or greater than 100 mM H⁺/L.pH, and a pH either greater than pH 8, or less than pH 4.5, thereby killing the cell.

According to still an additional aspect, there are provided method of selecting an ion exchange material capable of killing a cell, the methods comprising selecting an ion exchange material having a volumetric buffering capacity greater than 50 mM H⁺/L.pH, and a pH greater than pH 8 or a pH less than pH 4.5, the ion exchange material being capable of killing the cell.

According to still an additional, methods of killing a sub-population of cells of interest are provided; the methods comprising contacting a sample which comprises the sub-population of cells of interest with an ion exchange material having a volumetric buffering capacity and a pH selected suitable for specifically killing the sub-population of cells of interest, thereby killing the sub-population of cells of interest.

According to yet an additional aspect of embodiments of the present invention, articles of manufacture are provided comprising:

(i) a support; and

(ii) a layer of an ion exchange material being attached to at least part of a surface of the support, the ion exchange material comprises a buffering layer and an ion permeable layer being disposed on an external surface of the buffering layer.

According to still an additional aspect of embodiments of the present invention, articles of manufacture are provided comprising:

(i) a support; and

(ii) an ion exchange material layer being attached to at least part of a surface of the support, the ion exchange material being anionic.

According to still an additional aspect of embodiments of the present invention there is provided a use of a biocide composition described herein for the manufacture of a medicament for treating a medical condition associated with a pathological cell population.

According to a further aspect of embodiments of the present invention there is provided a pharmaceutical composition comprising as an active ingredient a biocide composition described herein and a pharmaceutically acceptable carrier or diluent.

According to yet a further aspect of embodiments of the present invention there is provided an assay for selecting an optimal ion exchange material for killing a cell of interest, the assay comprising:

(i) contacting a plurality of cells with a plurality of ion exchange agents; and

(ii) identifying an ion exchange agent from the plurality of ion exchange agents capable of killing a cell of the plurality of cells, the ion exchange agent being optimized for killing the cell of interest.

According to yet a further aspect, there are provided methods of treating a medical condition associated with a pathological cell population; the methods comprising administering into a subject in need thereof a therapeutically effective amount of an ion exchange material so as to alter at least a portion of an intracellular pH value of the pathological cell population, thereby treating the medical condition associated with the pathological cell population.

According to certain embodiments, generation a change in a cellular process results in death of the cell.

According to still further features in certain embodiments the multicellular organism is a higher plant. According to still further features in other embodiments the multicellular organism is a mammal.

According to certain embodiments, the contacting is effected in vivo. According to other embodiments, the contacting is effected ex vivo. According to yet other embodiments, the contacting is effected in vitro.

According to certain embodiments, the biocide composition comprises a pH gradient along at least a portion thereof.

According to still certain embodiments, the ion exchange material is internalized by the cell.

According to still further embodiments, the biocide composition is attached to an affinity moiety (e.g., an affinity moiety is selected from the group consisting of an antibody, a receptor ligand and a carbohydrate).

According to still further embodiments, the ion exchange material is at least partially covered by a selective barrier (e.g., a mechanical barrier).

According to certain embodiments, the biocide composition comprises an ion exchange material and a water permeable layer being disposed on an external surface of the ion exchange material. For example, the water permeable layer is an open pore polymer, such as an open pore polymer is selected from the group consisting of PVOH, cellulose and polyurethane.

According to certain embodiments, the ion exchange material is formulated in particles. For example, the particles are selected from the group consisting of polymeric particles, microcapsules liposomes, microspheres, microemulsions, nanoparticles, nanocapsules and nanospheres. According to certain of these embodiments the ion exchange material is encapsulated within the particles. According to other of these embodiments the ion exchange material is attached on the particle surface. According to other embodiments, the ion exchange material is formulated as a spray.

According to certain embodiments, the ion exchange material is anionic and incorporated in a water permeable polymer matrix. According to other embodiments, the ion exchange material is cationic and incorporated in a water permeable polymer matrix.

According to certain embodiments, the cationic ion exchange material is selected from the group consisting of sulfonic acid and derivatives thereof, phosphonic acid and derivatives thereof, carboxylic acid and derivatives thereof, phosphinic acid and derivatives thereof, phenols and derivatives thereof, arsonic acid and derivatives thereof and selenic acid and derivatives thereof.

According to other embodiments, the anionic ion exchange material is selected from the group consisting of a quaternary amine, a tertiary amine, a secondary amine and a primary amine.

According to certain embodiments the ion exchange material is a polymer. According to still further embodiments the ion exchange material comprises an intrinsically ion conducting matrix. According to still further embodiments the ion exchange material is an ionomer (e.g., sulfonated tertafluorethylene copolymer (Nafion) and derivatives thereof).

According to certain embodiments, the ion exchange material comprises a volumetric buffering capacity between about 20-100 mM H⁺/L.pH.

According to certain embodiments, the ion exchange material comprises a pH greater than pH 8. According to other embodiments, the ion exchange material comprises a pH less than pH 4.5.

According to certain embodiments, the cell is a diseased cell.

According to certain embodiments, the ion exchange material is attached to at least part of a surface of a support.

According to still further features in the described preferred embodiments the sample comprises at least a second sub-population of cells, wherein the sub-population of cells of interest and the second sub-population of cells exhibit different plasma buffering capacities.

According to certain embodiments, the treating is effected ex-vivo. According to still other embodiments, the treating is effected in-vivo.

According to still further embodiments the article of manufacture forms at least a part of a packaging material, a metical device, a fabric, a scaffold, a filter, or a bactericidal device.

It is an object of embodiments of the present invention to provide a biocide composition comprising one or more ion exchange materials, wherein when said material is in an environment capable of transporting H⁺ ions, said ion exchange material is adapted to cause the death of at least one cell within or in contact with said environment. According to certain embodiments, the ion exchange material has a volumetric buffering capacity greater than about 20 mM H⁺/(L.pH unit), greater than about 50 mM H⁺/(L.pH unit), or greater than about 100 mM H⁺/(L.pH unit).

It is a further object of embodiments of the present invention to provide the aforementioned biocide composition wherein said cell is a bacterial cell, a fungal cell or a yeast cell. It is a further object of embodiments of the present invention to provide the aforementioned biocide composition wherein said cell is a prokaryotic cell or a eukaryotic cell. It is a further object of embodiments of the present invention to provide the biocide composition wherein said cell is a bacterial cell.

It is a further object of embodiments of the present invention to provide the ion exchange material wherein said ion exchange materials is adapted to kill said cell without inserting any of its structure into the membrane of said cell and/or without creating a covalent bond with the membrane of said cell.

It is a further object of embodiments of the present invention to provide the ion exchange material wherein said ion exchange material comprises one or more functional groups selected from the group consisting of sulfonic acid, phosphonic acid, quaternary amine, tertiary amine, hydroxyl, and derivatives thereof.

It is a further object of embodiments of the present invention to provide the ion exchange material wherein said ion exchange material comprises one or more functional groups selected from the group consisting of carboxylic acid and derivatives thereof, phosphinic acid and derivatives thereof, phenol and derivatives thereof, arsonic acid and derivatives thereof, selenic acid and derivatives thereof, secondary amine and derivatives thereof, and primary amine and derivatives thereof. It is a further object of embodiments of the present invention to provide the ion exchange material wherein said ion exchange material comprises sulfonated tetrafluoroethylene copolymer and/or derivatives thereof.

It is a further object of embodiments of the present invention to provide the ion exchange material wherein the ion exchange material is selected from the group consisting of polyacrylamide-immobilines, agarose-immobilines, poly(diethylaminoethyl acrylate), cationic polyurethane, cationic sub micron silica, and ion exchange beads.

It is a further object of embodiments of the present invention to provide the biocide composition, wherein the composition has an H⁺ concentration of greater than about 3.2×10⁻⁵ M or less than about 10⁻⁸ M.

It is a further object of embodiments of the present invention to provide a biocide composition comprising a pH gradient along at least a portion thereof.

It is a further object of embodiments of the present invention to provide a biocide composition comprising a plurality of regions of differing pH.

It is a further object of embodiments of the present invention to provide a biocide composition wherein the ion exchange material comprises a polymer.

It is a further object of embodiments of the present invention to provide a biocide composition wherein the ion exchange material comprises a zeolite.

It is a further object of embodiments of the present invention to provide a biocide composition wherein the ion exchange material comprises cationic silica.

It is a further object of embodiments of the present invention to provide a biocide composition comprising one or more of an ion exchange bead, a polymer-coated ion exchange bead, and an ion exchange material incorporated in a matrix.

It is a further object of embodiments of the present invention to provide a biocide composition comprising one or more of a water permeable zeolite, a water soluble polymer, a water permeable polymer, an intrinsically ion-conducting polymer, an ion permeable polymer, and a water permeable ceramic.

It is a further object of embodiments of the present invention to provide a biocide composition wherein the biocide composition comprises at least a portion of a coating or a component of a medical device, a wound dressing, sutures, cloth, fabric and a wound ointment.

It is a further object of embodiments of the present invention to provide a biocide composition wherein the biocide composition is in the form of a shaped article, a coating, a spray, a film, a laminate on a film, a film in a laminate, sheets, beads, beads incorporated in fabric, particles, microparticles, microcapsules, microemulsions or nanoparticles.

It is a further object of embodiments of the present invention to provide an ion exchange material covered by a barrier layer, said barrier layer characterized as being selectively permeable to water. In certain of these embodiments, said barrier layer is characterized as being permeable to a preselected target cell but not to preselected non-target cells.

It is a further object of embodiments of the present invention to provide the composition of matter comprising (a) one or more ion exchange materials; and (b) a selectively permeable barrier layer covering said ion exchange material; said composition of matter being adapted to kill at least one cell located in an environment capable of transporting H⁺ ions and in contact with said composition of matter.

In certain of these embodiments, the composition of matter comprises (a) one or more ion exchange materials, wherein said ion exchange material has a volumetric buffering capacity of greater than about 20 mM H⁺/(L.pH unit); and (b) a selectively permeable barrier layer covering said ion exchange material; said composition of matter being adapted to kill at least one cell located in an environment capable of transporting H⁺ ions and in contact with said composition of matter.

It is a further object of embodiments of the present invention to provide the aforementioned composition of matter wherein said selectively permeable barrier layer is selectively permeable to water.

It is a further object of embodiments of the present invention to provide the aforementioned composition of matter wherein said selectively permeable barrier layer is selectively permeable to a preselected target cell but not to preselected non-target cells. For example, the non-target cells are chosen from the group consisting of (a) mammalian cells, (b) plant cells, and (c) any combination of the above.

It is a further object of embodiments of the present invention to provide the aforementioned composition of matter wherein said barrier layer comprises at least one form selected from the group consisting of coating, film, and membrane.

It is a further object of embodiments of the present invention to provide the aforementioned composition of matter, wherein said barrier layer is selected from the group consisting of an open pore polymenr (e.g, one or more of polyvinyl alcohol, cellulose, ethyl cellulose, cellulose acetate, polyacrylamide and polyurethane), an open pore ceramic and an open pore gel.

It is a further object of embodiments of the present invention to provide the aforementioned composition of matter wherein said cell is a bacterial cell, a fungal cell or a yeast cell. It is a further object of embodiments of the present invention to provide the composition of matter wherein said cell is a prokaryotic cell or a eukaryotic cell. It is a further object of embodiments of the present invention to provide the composition of matter wherein said cell is a bacterium.

It is a further object of embodiments of the present invention to provide the composition of matter wherein said composition has an H⁺ concentration of greater than about 3.2×10⁻⁵ M or less than about 10⁻⁸ M.

It is a further object of embodiments of the present invention to provide the composition of matter wherein said ion exchange material has a volumetric buffering capacity of at least about 50 mM H⁺/(L.pH unit).

It is a further object of embodiments of the present invention to provide the composition of matter wherein said ion exchange material has a volumetric buffering capacity of at least about 100 mM H⁺/(L.pH unit).

It is a further object of embodiments of the present invention to provide the composition of matter wherein said ion exchange material comprises one or more functional groups selected from the group consisting of sulfonic acid, phosphonic acid, quaternary amine, tertiary amine, hydroxyl, and derivatives thereof.

It is a further object of embodiments of the present invention to provide the composition of matter wherein said ion exchange material comprises one or more functional groups selected from the group consisting of carboxylic acid and derivatives thereof, phosphinic acid and derivatives thereof, phenol and derivatives thereof, arsonic acid and derivatives thereof, selenic acid and derivatives thereof, secondary amine and derivatives thereof, and primary amine and derivatives thereof.

It is a further object of embodiments of the present invention to provide the composition of matter wherein said ion exchange material comprises at least one substance selected from the group consisting of sulfonated tetrafluoroethylene copolymer and derivatives of sulfonated tetrafluoroethylene.

It is a further object of embodiments of the present invention to provide the composition of matter wherein said ion exchange material is selected from the group consisting of polyacrylamide-immobilines, agarose-immobilines, poly(diethylaminoethyl acrylate), cationic polyurethane, cationic sub micron silica, and ion exchange beads.

It is a further object of embodiments of the present invention to provide the composition of matter wherein said ion exchange material is adapted to kill living cells without inserting any of its structure into an outer cell membrane of the cell and/or without creating a covalent bond with the outer membrane of the cell.

It is a further object of embodiments of the present invention to provide the composition of matter wherein said barrier layer is adapted to prevent ions larger than H⁺ and OH⁻ from neutralizing said ion exchange material.

It is a further object of embodiments of the present invention to provide the composition of matter wherein said cell is chosen from the group consisting of bacterial cells, fungal cells, and yeast cells. It is a further object of embodiments of the present invention to provide the composition of matter wherein said cell is a prokaryotic cell or a eukaryotic cell. It is a further object of embodiments of the present invention to provide the composition of matter wherein said cell is a bacterial cell.

It is a further object of embodiments of the present invention to provide the composition of matter wherein said ion exchange material kills cells without inserting any of its structure into the outer membrane of said cells and/or without creating a covalent bond with the outer membrane of said cells.

It is a further object of embodiments of the present invention to disclose methods of generating a change in a cellular process of a target eukaryotic cell of a multicellular organism, said methods comprising contacting said target cell with an ion exchange material so as to alter an intracellular pH value in at least a portion of said target cell, thereby generating said change in a cellular process of a target cell of a multicellular organism.

It is a further object of embodiments of the present invention to disclose the abovementioned method of generating a change in a cellular process of a eukaryotic cell, said methods comprising contacting the cell with an ion exchange material so as to alter an intracellular pH value in at least a portion of said cell, thereby generating said change in a cellular process of a cell.

It is a further object of embodiments of the present invention to disclose the abovementioned method wherein said eukaryotic cell is a yeast cell.

It is a further object of embodiments of the present invention to disclose the abovementioned method wherein said contacting is effected in vivo.

It is a further object of embodiments of the present invention to disclose the abovementioned method wherein said contacting is effected ex vivo.

It is a further object of embodiments of the present invention to disclose the abovementioned method wherein said contacting is effected in vitro.

It is a further object of embodiments of the present invention to disclose the abovementioned method wherein generating said change results in death of said cell.

It is a further object of embodiments of the present invention to disclose the abovementioned method wherein said ion exchange material comprises an anionic ion exchange material incorporated in a water permeable polymer matrix.

It is a further object of embodiments of the present invention to disclose the abovementioned method wherein said ion exchange material comprises a cationic ion exchange material incorporated in a water permeable polymer matrix.

It is a further object of embodiments of the present invention to disclose the abovementioned method wherein said ion exchange material comprises a polymer.

It is a further object of embodiments of the present invention to disclose the abovementioned method wherein said ion exchange material comprises an ionomer.

It is a further object of embodiments of the present invention to disclose the abovementioned method wherein said ion exchange material comprises a sulfonated tetrafluoroethylene copolymer or derivative thereof.

It is a further object of embodiments of the present invention to disclose the abovementioned method wherein said ion exchange material comprises an intrinsically ion conducting matrix.

It is a further object of embodiments of the present invention to disclose the abovementioned method wherein said ion exchange material is attached to an affinity moiety.

It is a further object of embodiments of the present invention to disclose the abovementioned method wherein said ion exchange material is at least partially covered by a selective barrier.

It is a further object of embodiments of the present invention to disclose the abovementioned method wherein said ion exchange material comprises a volumetric buffering capacity greater than about 20 mM H⁺/ml/pH.

It is a further object of embodiments of the present invention to disclose the abovementioned method wherein said ion exchange material comprises a pH greater than pH 8.

It is a further object of embodiments of the present invention to disclose the abovementioned method wherein said ion exchange material comprises a pH less than pH 4.5.

It is a further object of embodiments of the present invention to disclose the abovementioned method wherein said ion exchange material is attached to at least part of a surface of a support.

It is a further object of embodiments of the present invention to disclose the abovementioned method wherein said ion exchange material comprises a buffering layer and a water permeable layer disposed on an external surface of said buffering layer.

It is a further object of embodiments of the present invention to disclose the abovementioned method wherein said water permeable layer is an open pore polymer.

It is a further object of embodiments of the present invention to disclose methods of treating a medical condition associated with a pathological cell population, said methods comprising administering into a subject in need thereof a therapeutically effective amount of an ion exchange material so as to alter at least a portion of an intracellular pH value of the pathological cell population, thereby treating the medical condition associated with the pathological cell population.

It is a further object of embodiments of the present invention to disclose the abovementioned method further comprising the additional step of administering a therapeutically effective amount of said ion exchange material to a subject suffering from a medical condition characterized by a pathological cell population, wherein said methods provides a treatment for said medical condition.

It is a further object of embodiments of the present invention to disclose the abovementioned method wherein said ion exchange material is internalized by said target cell.

It is a further object of embodiments of the present invention to disclose a pharmaceutical composition comprising as active ingredient an ion exchange material and a pharmaceutically acceptable carrier or diluent.

It is a further object of embodiments of the present invention to disclose the above-mentioned pharmaceutical composition wherein said ion exchange material is formulated in particles.

It is a further object of embodiments of the present invention to disclose an article of manufacture comprising (a) a support and (b) an ion exchange material layer being attached to at least part of a surface of said support, said ion exchange material comprises a buffering layer and an ion permeable layer being disposed on an external surface of said buffering layer.

It is a further object of embodiments of the present invention to disclose an article of manufacture comprising (a) a support and (b) an ion exchange material layer being attached to at least part of a surface of said support, said ion exchange material being anionic.

It is thus one object of embodiments of the invention to disclose a zeolite biocide, characterized in that the zeolite is substantially free of heavy metals, ions or salts thereof; at least one of the following conditions holds true: substantially all cations outside of the zeolite framework have been exchanged by protons (H⁺), thereby forming an acidic zeolite; and the zeolite is a product of a reaction that imparts to it Lewis-base character, thereby forming a basic zeolite; wherein the surface of the zeolite has a surface charge with a surface charge density of at least about 1×10⁻⁹ C/cm², and further wherein substantially all of the surface charge density originates from the zeolite.

It is another object of embodiments of the invention to disclose a zeolite biocide as described above, wherein the H⁺ concentration within the acidic zeolite biocide is ≧about 10⁻³ mol L⁻¹. Another object of embodiments of the invention is to disclose a zeolite biocide as described above, wherein the H⁺ concentration within the basic zeolite biocide is ≦about 10⁻⁸ mol L⁻¹.

It is another object of embodiments of the invention to disclose a zeolite biocide as described above, wherein a mixture of a first portion of at least one acidic zeolite and a second portion of at least one basic zeolite is provided, and further wherein the ratio between the first and second portions is chosen to provide a predetermined H⁺ concentration of the mixture.

It is another object of embodiments of the invention to disclose a mixture of zeolite biocides substantially free of heavy metals, ions or salts thereof. This biocide mixture has a first portion comprising of at least one acidic zeolite and has a second portion comprising at least one basic zeolite, wherein the ratio between the first and second portions is chosen to provide a predetermined H⁺ concentration of the mixture; wherein the surface of the zeolite has by a surface charge with a surface charge density of at least about 1×10⁻⁹ C/cm², and further wherein all of the surface charge density originates from the zeolite;

It is another object of embodiments of the invention to disclose a biocide material comprising a zeolite being substantially free of heavy metals, ions or salts thereof; the zeolite is chosen from a group consisting of a zeolite in which substantially all cations outside of the zeolite framework have been exchanged by protons (H⁺), thereby forming an acidic zeolite; a zeolite being a product of a reaction that imparts to it Lewis-base character, thereby forming a basic zeolite; and a mixture of a first portion comprising of at least one acidic zeolite and a second portion comprising at least one basic zeolite, wherein the ratio between the first and second portions is chosen to provide a predetermined H⁺ concentration of the mixture; and a polymer immobilizing the zeolite; wherein the surface of the zeolite has a surface charge with a surface charge density of at least about 1×10⁻⁹ C/cm², wherein all of the surface charge density originates from the zeolite.

It is another object of embodiments of the invention to disclose a biocidic material as described above, wherein a polymer material is immobilizing the zeolite by a means chosen from the group consisting of doping, gluing, coating, immersing, ionically or covalently bonding, co-extruding, and any other means known in the art.

It is another object of embodiments of the invention to disclose a biocidic material as described above, wherein the material additionally comprising an ionomer.

It is another object of embodiments of the invention to disclose a biocidic material as described above, wherein the ionomer is chosen from a group consisting of polyvinyl alcohol, polystyrenesulfonic acid, a commercially available NAFION™ product, polypropylene polystyrene-divinylbenzene, sulfonated tetrafluoroethylene copolymer and derivatives of sulfonated tetrafluoroethylene, polyacrylamide-immobilines, agarose-immobilines, poly (diethylaminoethyl acrylate), cationic polyurethane, cationic sub micron silica, and ion exchange beads, and any polymer which contains at least one functional chemical entity chosen from the group consisting of sulfonic acid, phosphonic acid, quaternary amine, tertiary amine, hydroxyl, and derivatives thereof.

It is another object of embodiments of the invention to disclose a biocidic material as described above, wherein the polymer immobilizing the zeolite is chosen from a group consisting of ethylene vinyl acetate (EVA), low density polyethylene (LDPE), natural biobased polymers like cellulose PHP, PHA and their blends, PET, PVOH, EVOH, PEG, acrylics, polyesters, polyamides, their copolymers and blends.

It is another object of embodiments of the invention to disclose charged polymeric compound (CPC). The CPC comprising (i) at least one zeolite chosen from a group consisting of acidic zeolite, basic zeolite or a mixture of acidic/basic zeolites, and (ii) at least one polymer immobilizing the same, wherein each of the zeolites being substantially free of heavy metals, ions or salts thereof; wherein in the acidic zeolite substantially all cations outside of the zeolite framework have been exchanged by protons (H⁺); wherein the basic zeolite is a zeolite being a product of a reaction that imparts to it Lewis-base character; wherein the mixture of acidic/basic zeolites has a first portion comprising of at least one acidic zeolite and has a second portion comprising at least one basic zeolite, and wherein the ratio between the first and second portions is chosen to provide a predetermined H⁺ concentration of the mixture; and further wherein the surface of the zeolites has a surface charge with a surface charge density of at least about 1×10⁻⁹ C/cm², wherein all of the surface charge density originates from the zeolite.

It is another object of embodiments of the invention to disclose the CPC as defined above, wherein the CPC has at least one effective biocidic property.

It is another object of embodiments of the invention to disclose the CPC as defined above, wherein the CPC additionally comprising a non-zeolite ionomer.

It is another object of embodiments of the invention to disclose the CPC as defined above, wherein the ionomer is chosen from a group consisting of polyvinyl alcohol, polystyrenesulfonic acid, polypropylene polystyrene-divinylbenzene, sulfonated tetrafluoroethylene copolymer and derivatives of sulfonated tetrafluoroethylene, polyacrylamide-immobilines, agarose-immobilines, poly(diethylaminoethyl acrylate), commercially available NAFION™ product, cationic polyurethane, cationic sub micron silica, and ion exchange beads, and any polymer which contains at least one functional chemical entity chosen from the group consisting of sulfonic acid, phosphonic acid, quaternary amine, tertiary amine, hydroxyl, and derivatives thereof.

It is another object of embodiments of the invention to disclose an article of manufacture comprising at least one portion of zeolite biocide; the zeolite is substantially free of heavy metals, ions or salts thereof and at least one of the following conditions holds true: substantially all cations outside of the zeolite framework have been exchanged by protons (H⁺), thereby forming an acidic zeolite; the zeolite is a product of a reaction that imparts to it Lewis-base character, thereby forming a basic zeolite; and a mixture of a first portion comprising of at least one acidic zeolite and a second portion comprising at least one basic zeolite, wherein the ratio between the first and second portions is chosen to provide a predetermined H⁺ concentration of the mixture; wherein the surface of the zeolite has a surface charge with a surface charge density of at least about 1×10⁻⁹ C/cm², and further wherein substantially all of the surface charge density originates from the zeolite.

It is another object of embodiments of the invention to disclose the article of manufacture as defined above, wherein at least a portion of the zeolite is immobilized within a polymer.

It is another object of embodiments of the invention to disclose the article of manufacture as defined above, wherein the polymer immobilizing the zeolite is chosen from a group consisting of ethylene vinyl acetate (EVA), low density polyethylene (LDPE), natural biobased polymers like cellulose PHP, PHA and their blends, PET, PVOH, EVOH, PEG, acrylics, polyesters, polyamides, their copolymers and blends.

It is another object of embodiments of the invention to disclose the article of manufacture as defined above, wherein at least a portion of the zeolite is immobilized within an ionomer.

It is another object of embodiments of the invention to disclose the article of manufacture as defined above, wherein the ionomer is chosen from a group consisting of polyvinyl alcohol, polystyrenesulfonic acid, polypropylene polystyrene-divinylbenzene, sulfonated tetrafluoroethylene copolymer and derivatives of sulfonated tetrafluoroethylene, polyacrylamide-immobilines, agarose-immobilines, poly (diethylaminoethyl acrylate), commercially available NAFION™ product, cationic polyurethane, cationic sub-micron silica, and ion exchange beads, and any polymer which contains at least one functional chemical entity chosen from the group consisting of sulfonic acid, phosphonic acid, quaternary amine, tertiary amine, hydroxyl, and derivatives thereof.

It is another object of embodiments of the invention to disclose the article of manufacture as defined above, wherein the article of manufacture is chosen from the group consisting of wound dressings, implants, veterinary products, and medical devices; containers, bottles, cans, canisters, inserts, caps, wood, pulp and products thereof, paper, cardboards, glasses, aluminum foils, metal ware, plastics, polymeric surfaces, fibers, laminates, a spray or otherwise fluid or powder which is can be immobilized upon or within a defined substrate, wrappings, food wrapping and enveloping materials; foodstuffs, beverages, milk and dietary products, juices, concentrate; plants and organs thereof, seeds, leaves, fruits and vegetables and product thereof; filters and water purification systems; cosmetics, drugs, medicaments, pharmaceuticals; detergents, paints and coatings, pipes, and processed surfaces, and animal household materials.

It is another object of embodiments of the invention to disclose a container having at least one portion in connection with a solution contaminateable by a microorganism. This portion comprises a zeolite biocide, characterized in that the zeolite is substantially free of heavy metals, ions or salts thereof; at least one of the following conditions holds true: (i) either most or substantially all cations outside of the zeolite framework have been exchanged by protons (H⁺), thereby forming an acidic zeolite; and (ii) the zeolite is a product of a reaction that imparts to it Lewis-base character, thereby forming a basic zeolite; wherein the surface of the zeolite has a surface charge with a surface charge density of at least about 1×10⁻⁹ C/cm², and further wherein either most or substantially all of the surface charge density originates from the zeolite.

It is another object of embodiments of the invention to disclose a container having at least one portion in connection with a solution contaminateable by microorganism. This portion is either being or comprising a charged polymeric compound (CPC), the CPC comprising (i) at least one zeolite chosen from a group consisting of acidic zeolite, basic zeolite or a mixture of acidic/basic zeolites, and (ii) at least one polymer immobilizing the same, wherein each of the zeolites being substantially free of heavy metals, ions or salts thereof; wherein in the acidic zeolite either most or all substantially all cations outside of the zeolite framework have been exchanged by protons (H⁺); wherein the basic zeolite is a zeolite being a product of a reaction that imparts to it Lewis-base character; wherein the mixture of acidic/basic zeolites has a first portion comprising of at least one acidic zeolite and has a second portion comprising at least one basic zeolite, and wherein the ratio between the first and second portions is chosen to provide a predetermined H⁺ concentration of the mixture; and further wherein the surface of the zeolites has a surface charge with a surface charge density of at least about 1×10⁻⁹ C/cm², wherein all of the surface charge density originates from the zeolite.

It is another object of embodiments of the invention to disclose the container as defined in any of the above, having at least one portion in connection with a solution contaminateable by microorganism. This portion is a CPC comprising an ionomer.

It is another object of embodiments of the invention to disclose the container as defined above, wherein the ionomer is chosen from a group consisting of polyvinyl alcohol, polystyrenesulfonic acid, polypropylene polystyrene-divinylbenzene, sulfonated tetrafluoroethylene copolymer and derivatives of sulfonated tetrafluoroethylene, polyacrylamide-immobilines, agarose-immobilines, poly (diethylaminoethyl acrylate), commercially available NAFION™ product, cationic polyurethane, cationic sub-micron silica, and ion exchange beads, and any polymer which contains at least one functional chemical entity chosen from the group consisting of sulfonic acid, phosphonic acid, quaternary amine, tertiary amine, hydroxyl, and derivatives thereof.

It is another object of embodiments of the invention to disclose the container as defined in any of the above, wherein the solution is milk, water, beverage or any other foodstuff.

It is another object of embodiments of the invention to disclose the container as defined in any of the above, wherein the portion is made from a material chosen form a group of cardboards, laminated substrates, cross-woven or cross-laminate materials, laminates of polyolefin, polyester, nylon or combinations thereof, paperboard based laminated structures, at least one layer of EVOH, EVA, nylon, polypropylene, polyethylene (PE), HDPE, PET, polymer structures such as thermoplastic films, expanded and extruded biodegradable polymer foams, biodegradable polymer or its blends, and biodegradable polymer or its blends with other biodegradable polymers or commercially available non-biodegradable polymers.

It is another object of embodiments of the invention to disclose methods of producing a zeolite crystalline biocide. The methods comprising steps of providing a zeolite mineral; treating the zeolite mineral according to a protocol chosen from the group consisting of: reacting the zeolite mineral with inorganic acid of a concentration of at least 1 M at a temperature ≧29° C. until either most or substantially all extra-framework cations are exchanged with protons (H⁺), thereby producing an acidic zeolite; reacting the zeolite mineral with a solution of a metal hydroxide of OH⁻ concentration at least 1 M at a temperature ≧29° C. until either most or substantially all extra-framework anions are exchanged with er (i) hydroxide anions (OH⁻) or (ii) other Lewis-base, thereby forming a basic zeolite; and sequentially by reacting a first portion of zeolite mineral with inorganic acid of a concentration of at least 1 M at a temperature ≧29° C.; reacting a second portion of zeolite mineral with a solution of either (i) a metal hydroxide of OH⁻ or (ii) other Lewis-base, at a concentration of at least M at a temperature ≧29° C.; mixing the same, thereby providing a mixture of acidic and basic zeolites; and optionally at least partially removing water from the wet suspension until dried acidic zeolite, basic zeolite, and/or acidic-basic mixture of zeolites are obtained.

It is another object of embodiments of the invention to disclose methods of producing a charged polymeric compound biocide. The methods comprising steps of providing a zeolite mineral; treating the zeolite mineral according to a protocol chosen from the group consisting of: reacting the zeolite mineral with inorganic acid of a concentration of at least 1 M at a temperature ≧29° C. until either most or substantially all extra-framework cations are exchanged with protons (H⁺), thereby producing an acidic zeolite; reacting the zeolite mineral with a solution of a metal hydroxide of OH⁻ concentration at least 1 M at a temperature ≧29° C. until either most or all substantially all extra-framework anions are exchanged with er (i) hydroxide anions (OH⁻) or (ii) other Lewis-base, thereby forming a basic zeolite; and sequentially by reacting a first portion of zeolite mineral with inorganic acid of a concentration of at least 1 M at a temperature ≧29° C.; reacting a second portion of zeolite mineral with a solution of either (i) a metal hydroxide of OH⁻ or (ii) other Lewis-base, at a concentration of at least 1 M at a temperature ≧29° C.; mixing the same, thereby providing a mixture of acidic and basic zeolites; optionally at least partially removing water from the wet suspension until dried acidic zeolite, basic zeolite, and/or acidic-basic mixture of zeolites are obtained; and immobilizing the same in a polymer.

It is another object of embodiments of the invention to disclose the methods as defined above, wherein the methods additionally comprising a step of selecting the polymer from a group consisting of cardboards, laminated substrates, cross-woven or cross-laminate materials, laminates of polyolefin, polyester, nylon or combinations thereof, paperboard based laminated structures, at least one layer of EVOH, EVA, nylon, polypropylene, polyethylene (PE), HDPE, PET, polymer structures such as thermoplastic films, expanded and extruded biodegradable polymer foams, biodegradable polymer or its blends, and biodegradable polymer or its blends with other biodegradable polymers or commercially available non-biodegradable polymers.

It is another object of embodiments of the invention to disclose methods of producing a charged polymeric ionomer. The methods comprising steps of providing a zeolite mineral; treating the zeolite mineral according to a protocol chosen from the group consisting of: reacting the zeolite mineral with inorganic acid of a concentration of at least 1 M at a temperature ≧29° C. until substantially all extra-framework cations are exchanged with protons (H⁺), thereby producing an acidic zeolite; reacting the zeolite mineral with a solution of a metal hydroxide of OH⁻ concentration at least 1 M at a temperature ≧29° C. until either most or substantially all extra-framework anions are exchanged with er (i) hydroxide anions (OH⁻) or (ii) other Lewis-base, thereby forming a basic zeolite; and sequentially by reacting a first portion of zeolite mineral with inorganic acid of a concentration of at least 1 M at a temperature ≧29° C.; reacting a second portion of zeolite mineral with a solution of either (i) a metal hydroxide of OH⁻ or (ii) other Lewis-base, at a concentration of at least 1 M at a temperature ≧29° C.; mixing the same, thereby providing a mixture of acidic and basic zeolites; optionally at least partially removing water from the wet suspension until dried acidic zeolite, basic zeolite, and/or acidic-basic mixture of zeolites are obtained; and immobilizing the same in or with an ionomer.

It is another object of embodiments of the invention to disclose the methods as defined above, wherein the methods additionally comprising a step of selecting the ionomer from a group consisting of polyvinyl alcohol, polystyrenesulfonic acid, polypropylene polystyrene-divinylbenzene, sulfonated tetrafluoroethylene copolymer and derivatives of sulfonated tetrafluoroethylene, polyacrylamide-immobilines, agarose-immobilines, poly (diethylaminoethyl acrylate), commercially available NAFION™ product, cationic polyurethane, cationic sub-micron silica, and ion exchange beads, and any polymer which contains at least one functional chemical entity chosen from the group consisting of sulfonic acid, phosphonic acid, quaternary amine, tertiary amine, hydroxyl, and derivatives thereof.

It is another object of embodiments of the invention to disclose methods of producing an article of manufacture comprising at least one zeolite crystalline biocide. The methods comprising steps of providing a zeolite mineral; treating the zeolite mineral according to a protocol chosen from the group consisting of reacting the zeolite mineral with inorganic acid of a concentration of at least 1 M at a temperature ≧29° C. until substantially all M extra-framework cations are exchanged with protons (H⁺), thereby producing an acidic zeolite; reacting the zeolite mineral with a solution of a metal hydroxide of OH⁻ concentration at least 1 M at a temperature ≧29° C. until substantially all extra-framework anions are exchanged with er (i) hydroxide anions (OH⁻) or (ii) other Lewis-base, thereby forming a basic zeolite; and sequentially by reacting a first portion of zeolite mineral with inorganic acid of a concentration of at least 1 M at a temperature ≧29° C.; reacting a second portion of zeolite mineral with a solution of either (i) a metal hydroxide of OH⁻ or (ii) other Lewis-base, at a concentration of at least 1 M at a temperature ≧29° C.; mixing the same, thereby providing a mixture of acidic and basic zeolites; optionally at least partially removing water from the wet suspension until dried acidic zeolite, basic zeolite, and/or acidic-basic mixture of zeolites are obtained; and immobilizing the same in or on at least one portion of an article of manufacture.

It is another object of embodiments of the invention to disclose methods of producing an article of manufacture comprising at least one charged polymeric compound biocide. The methods comprising steps of providing a zeolite mineral; treating the zeolite mineral according to a protocol chosen from the group consisting of: reacting the zeolite mineral with inorganic acid of a concentration of at least 1 M at a temperature ≧29° C. until substantially all extra-framework cations are exchanged with protons (H⁺), thereby producing an acidic zeolite; reacting the zeolite mineral with a solution of a metal hydroxide of OH⁻ concentration at least 1 M at a temperature ≧29° C. until substantially all extra-framework anions are exchanged with er (i) hydroxide anions (OH⁻) or (ii) other Lewis-base, thereby forming a basic zeolite; and sequentially by reacting a first portion of zeolite mineral with inorganic acid of a concentration of at least 1 M at a temperature ≧29° C.; reacting a second portion of zeolite mineral with a solution of either (i) a metal hydroxide of OH⁻ or (ii) other Lewis-base, at a concentration of at least 1 M at a temperature ≧29° C.; mixing the same, thereby providing a mixture of acidic and basic zeolites; optionally at least partially removing water from the wet suspension until dried acidic zeolite, basic zeolite, and/or acidic-basic mixture of zeolites are obtained; immobilizing the same in a polymer; and immobilizing the same in or on at least one portion of an article of manufacture.

It is another object of embodiments of the invention to disclose the methods as defined above, wherein the methods additionally comprising a step of selecting the polymer from a group consisting of cardboards, laminated substrates, cross-woven or cross-laminate materials, laminates of polyolefin, polyester, nylon or combinations thereof, paperboard based laminated structures, at least one layer of EVOH, EVA, nylon, polypropylene, polyethylene (PE), HDPE, PET, polymer structures such as thermoplastic films, expanded and extruded biodegradable polymer foams, biodegradable polymer or its blends, and biodegradable polymer or its blends with other biodegradable polymers or commercially available non-biodegradable polymers.

It is another object of embodiments of the invention to disclose methods of producing an article of manufacture comprising at least one charged polymeric ionomer. The methods comprising steps of: providing a zeolite mineral; treating the zeolite mineral according to a protocol chosen from the group consisting of reacting the zeolite mineral with inorganic acid of a concentration of at least 1 M at a temperature ≧29° C. until substantially all extra-framework cations are exchanged with protons (H⁺), thereby producing an acidic zeolite; reacting the zeolite mineral with a solution of a metal hydroxide of OH⁻ concentration at least 1 M at a temperature ≧29° C. until substantially all extra-framework anions are exchanged with either (i) hydroxide anions (OH⁻) or (ii) other Lewis-base, thereby forming a basic zeolite; and sequentially by reacting a first portion of zeolite mineral with inorganic acid of a concentration of at least 1 M at a temperature ≧29° C.; reacting a second portion of zeolite mineral with a solution of either (i) a metal hydroxide of OH⁻ or (ii) other Lewis-base, at a concentration of at least 1 M at a temperature ≧29° C.; mixing the same, thereby providing a mixture of acidic and basic zeolites; optionally at least partially removing water from the wet suspension until dried acidic zeolite, basic zeolite, and/or acidic-basic mixture of zeolites are obtained; immobilizing the same in or with an ionomer; and immobilizing the same in or on at least one portion of an article of manufacture.

It is another object of embodiments of the invention to disclose the methods as defined above, wherein the methods additionally comprising a step of selecting the ionomer from a group consisting of polyvinyl alcohol, polystyrenesulfonic acid, polypropylene polystyrene-divinylbenzene, sulfonated tetrafluoroethylene copolymer and derivatives of sulfonated tetrafluoroethylene, polyacrylamide-immobilines, agarose-immobilines, poly (diethylaminoethyl acrylate), commercially available NAFION™ product, cationic polyurethane, cationic sub-micron silica, and ion exchange beads, and any polymer which contains at least one functional chemical entity chosen from the group consisting of sulfonic acid, phosphonic acid, quaternary amine, tertiary amine, hydroxyl, and derivatives thereof.

It is another object of embodiments of the invention to disclose the methods as defined in any of eth above, wherein the methods additionally comprising a step of immobilizing the zeolite-containing product in or on at least one portion of a container.

It is another object of the invention to disclose the methods as defined in any of eth above, wherein the methods additionally comprising a step of producing the container form a material selected from a group of cardboards, laminated substrates, cross-woven or cross-laminate materials, laminates of polyolefin, polyester, nylon or combinations thereof, paperboard based laminated structures, at least one layer of EVOH, EVA, nylon, polypropylene, polyethylene (PE), HDPE, PET, polymer structures such as thermoplastic films, expanded and extruded biodegradable polymer foams, biodegradable polymer or its blends, and biodegradable polymer or its blends with other biodegradable polymers or commercially available non-biodegradable polymers.

It is another object of the invention to disclose the methods as defined above, wherein the methods additionally comprising a step choosing the container from a group consisting of milk containers, beverages containers, and food containers.

In another aspect, method and compositions are disclosed for controlling the population of microorganisms within a predetermined volume that uses zeolites that do not contain significant amounts of leachable heavy metals or ions or salts thereof or other biocidic materials such as antibiotics. It is therefore an object of embodiments of the present invention to disclose methods for controlling the population of microorganisms within a predefined volume, said methods comprising: disposing biocidic zeolite about at least a portion of the interior of the surface enclosing said predefined volume, wherein the amount of antimicrobial material chosen from the group consisting of heavy metals, ions and salts thereof, antibiotics sequestered within said biocidic zeolite, and antibiotics bound to said biocidic zeolite that can be released into said predefined volume is insufficient to affect the population of microorganisms within said predefined volume, and further wherein said zeolite is substantially free of any material comprising a substituent that acts to kill microorganisms by disruption of the cell membrane following insertion into or binding thereto; and exposing said microorganisms to said biocidic zeolite.

It is a further object of embodiments of this invention to provide such methods, wherein said step of disposing comprises a step of disposing about at least a portion of the interior of the surface enclosing said predefined volume biocidic zeolite, wherein the concentration of antimicrobial material chosen from the group consisting of heavy metals, cations of heavy metals, salts of heavy metals, and antibiotics leached from said biocidic zeolite in said predefined volume does not exceed 1 ppm at any time during the course of said step of exposing said microorganisms to said biocidic zeolite.

It is a further object of embodiments of this invention to provide such methods, wherein said step of disposing comprises a step of disposing about at least a portion of the interior of the surface enclosing said predefined volume biocidic zeolite, wherein the concentration of antimicrobial material chosen from the group consisting of heavy metals, cations of heavy metals, salts of heavy metals, and antibiotics leached from said biocidic zeolite in said predefined volume does not exceed 1 ppb at any time during the course of said step of exposing said microorganisms to said biocidic zeolite.

It is a further object of embodiments of this invention to disclose such methods as defined in any of the above, wherein said step of disposing comprises a step of disposing about at least a portion of the interior of the surface enclosing said predefined volume an acidic zeolite.

It is a further object of embodiments of this invention to provide such methods, wherein said step of disposing about at least a portion of the interior of the surface enclosing said predefined volume an acidic zeolite comprises a step of disposing about at least a portion of the interior of the surface enclosing said predefined volume an acidic zeolite in which the H⁺ concentration is greater than about 2.5×10⁻⁴ mol L⁻¹.

It is a further object of embodiments of this invention to provide such methods, wherein said step of disposing about at least a portion of the interior of the surface enclosing said predefined volume an acidic zeolite comprises a step of disposing about at least a portion of the interior of the surface enclosing said predefined volume an acidic zeolite in which the H⁺ concentration is greater than or equal to about 1 meq/g.

It is a further object of embodiments of this invention to provide such methods, wherein said acidic zeolite is chosen from the group consisting of mordenite, clinoptilite, and acidic zeolites prepared from zeolites chosen from the group consisting of β-zeolite, ZSM-23, ZSM-5, zeolite A, and zeolite Y.

It is a further object of embodiments of this invention to provide such methods, further comprising a step of preparing said acidic zeolite by deammoniation of an NH₄⁺-form zeolite.

It is a further object of embodiments of this invention to provide such methods, wherein said step of disposing further comprises a step of disposing about at least a portion of the interior of the surface enclosing said predefined volume a biocidic zeolite in which at least 50% of the exchangeable cations are protons.

It is a further object of embodiments of this invention to disclose such methods as defined in any of the above, wherein said disposing comprises a step of disposing about at least a portion of the interior of the surface enclosing said predefined volume a basic zeolite.

It is a further object of embodiments of this invention to provide such methods, wherein said step of disposing comprises a step of disposing about at least a portion of the interior of the surface enclosing said predefined volume a zeolite in which the H⁺ concentration is less than about 10⁻⁸ mol L⁻¹.

It is a further object of embodiments of this invention to disclose such methods as defined in any of the above, wherein said step of disposing comprises a step of disposing about at least a portion of the interior of the surface enclosing said predefined volume a biocidic zeolite a mixture of acidic and basic zeolites.

It is a further object of embodiments of this invention to disclose such methods as defined in any of the above, wherein said step of disposing further comprises a step of disposing about at least a portion of the interior of the surface enclosing said predefined volume a biocidic zeolite has a surface charge density of at least about 10⁻¹⁰ C/cm².

It is a further object of embodiments of this invention to disclose such methods as defined in any of the above, wherein said step of exposing said microorganisms to said biocidic zeolite further comprises a step of exposing said microorganisms to said biocidic zeolite such that said microorganisms approach within 50 nm of the surface of said biocidic zeolite.

It is a further object of embodiments of this invention to disclose such methods as defined in any of the above, wherein said step of exposing said microorganisms to said biocidic zeolite further comprises a step of exposing said microorganisms to said biocidic zeolite such that said microorganisms approach within about 10 nm of the surface of said biocidic zeolite.

It is a further object of embodiments of this invention to disclose such methods as defined in any of the above, wherein said step of exposing said microorganisms to said biocidic zeolite comprises a step of exposing to said biocidic zeolite at least one microorganism selected from the group consisting of Saccharomyces cerevisiae, Zygosacchacomycesrouxii, Byssochalamysfulva, Aspergillusniger, E. coli, Klebsiella pneumonia, Talaromycesflavus, Lactobacillus lactis, Bacillus subtilis, and Aspergillusochraceus.

It is a further object of embodiments of this invention to disclose such methods as defined in any of the above, wherein said step of exposing comprises a step of exposing said microorganism to a biocidic zeolite, the properties of which are chosen to control the population of at least one predetermined microorganism.

It is a further object of embodiments of this invention to disclose such methods as defined in any of the above, wherein said step of exposing further comprises a step of exposing said microorganisms to said biocidic zeolite, thereby killing at least a portion of said microorganisms.

It is a further object of embodiments of this invention to disclose such methods as defined in any of the above, wherein said step of exposing said microorganisms to said biocidic zeolite further comprises a step of exposing said microorganisms to said biocidic zeolite until the population of said microorganisms is reduced by a predetermined measure relative to the population of said microorganisms present in said volume prior to the commencement of said step of disposing.

It is a further object of embodiments of this invention to provide such methods, wherein said predetermined amount is a 2 log reduction.

It is a further object of embodiments of this invention to provide such methods, wherein said predetermined amount is a 5 log reduction.

It is a further object of embodiments of this invention to disclose such methods as defined in any of the above, further including a step of maintaining the population of microorganisms within said predetermined volume to within a predetermined measure of its population prior to the commencement of said step of disposing.

It is a further object of embodiments of this invention to disclose such methods as defined in any of the above, wherein said step of disposing further includes a step of disposing about at least a portion of the interior of the surface enclosing said predetermined volume a biocidic zeolite that demonstrates antimicrobial activity as measured by a test method chosen from the group consisting of ISO 22196 and ASTM E2149.

It is a further object of embodiments of this invention to disclose such methods as defined in any of the above, wherein said step of disposing further comprises a step of disposing no more than 4 mg of zeolite per cm³ of said predetermined volume.

It is a further object of embodiments of this invention to disclose such methods as defined in any of the above, wherein said step of disposing further comprises a step of disposing about at least a portion of the interior of said surface enclosing said volume zeolite particles with an average particle diameter of between about 1 and about 3 μm.

It is a further object of embodiments of this invention to disclose such methods as defined in any of the above, wherein said step of disposing further comprises a step of disposing a zeolite with an internal BET surface area of about 200 m²/g.

It is a further object of embodiments of this invention to disclose such methods as defined in any of the above, further comprising a step of maintaining the pH within said volume to within about ±0.5 pH units for a predetermined time following the commencement of said step of exposing.

It is a further object of this invention to disclose a method as defined in any of the above, wherein said step of disposing a biocidic zeolite comprises a step of disposing a biocidic zeolite having an Si/Al ratio of between about 3 and about 50.

It is a further object of this invention to disclose a method as defined in any of the above, wherein said step of disposing a biocidic zeolite comprises a step of disposing a biocidic zeolite having an Si/Al ratio between about 5 and about 20.

It is a further object of embodiments of this invention to disclose such methods as defined in any of the above, further comprising a step of introducing an aqueous environment within said predefined volume.

It is a further object of embodiments of this invention to provide such methods, further comprising a step of buffering said aqueous environment.

It is a further object of embodiments of this invention to provide such methods, further comprising a step of buffering said aqueous environment to a pH that is within about 0.5 pH units of the pH of said aqueous environment immediately prior to said step of exposing.

It is a further object of embodiments of this invention to disclose such methods as defined in any of the above, wherein said step of exposing comprises a step of exposing said microorganisms indirectly to said biocidic zeolite.

It is a further object of embodiments of this invention to disclose such methods as defined in any of the above, wherein said step of exposing comprises at least one step chosen from the group consisting of (a) shaking said predetermined volume; (b) inverting said predetermined volume; (c) stirring the material enclosed in said predetermined volume.

It is a further object of embodiments of this invention to disclose such methods as defined in any of the above, further comprising a step of immobilizing said biocidic zeolite in a polymer matrix.

It is a further object of embodiments of this invention to provide such methods, wherein said step of immobilizing said biocidic zeolite in a polymer matrix is performed prior to said step of disposing said biocidic zeolite about at least a portion of the interior of the surface enclosing said predetermined volume.

It is a further object of embodiments of this invention to provide such methods, wherein said step of immobilizing said biocidic zeolite in a polymer matrix comprises immobilizing said biocidic zeolite in a polymer matrix made from a polymer chosen from the group consisting of ethylene vinyl acetate; low density polyethylene; polypropylene; cellulose; cellulose derivatives; polyalkanoates; polyethylene terephthalate; polyvinyl alcohol; ethylene vinyl alcohol; polyethylene glycol; acrylics; polyesters; polyamides; polyacrylates; polycarbonates; other thermoplastic polymers; and copolymers and blends of any of the above.

It is a further object of embodiments of this invention to disclose such methods as defined in any of the above, further comprising a step of disposing about at least a portion of the interior of the surface enclosing said predetermined volume an ionomer.

It is a further object of embodiments of this invention to provide such methods, wherein said ionomer is chosen from consisting of polystyrenesulfonic acid, sulfonated tetrafluoroethylene copolymer, derivatives of sulfonated tetrafluoroethylene, polyacrylamide-immobilines, agarose-immobilines, cationic polyurethane, poly(diethylaminoethyl acrylate), ion exchange beads, and any polymer containing at least one functional group chosen from the group consisting of sulfonic acid, phosphonic acid, quaternary amine, tertiary amine, hydroxyl, and derivatives thereof.

It is a further object of embodiments of this invention to provide such methods, wherein said step of immobilizing said biocidic zeolite in a polymer matrix comprises immobilizing said biocidic zeolite in a polymer matrix such that the resulting material is at least about 60% zeolite by weight.

It is a further object of embodiments of this invention to provide such methods, wherein said step of immobilizing said biocidic zeolite in a polymer matrix comprises immobilizing said biocidic zeolite in a polymer matrix such that the resulting material is at least about 75% zeolite by weight.

It is a further object of embodiments of this invention to provide such methods, wherein said step of immobilizing said biocidic zeolite in a polymer matrix comprises immobilizing said biocidic zeolite in a polymer matrix such that said matrix at least partially covers said zeolite.

It is a further object of embodiments of this invention to provide such methods, wherein said step of immobilizing said biocidic zeolite in a polymer matrix comprises a step of forming, by a method chosen from the group comprising extrusion, doping, coating, immersing, and encapsulating, a polymer matrix in which said biocidic zeolite is immobilized.

It is a further object of embodiments of this invention to provide such methods, wherein said step of immobilizing said biocidic zeolite in a polymer matrix comprises a step of forming by extrusion a polymer matrix in which said biocidic zeolite is immobilized.

It is a further object of embodiments of this invention to provide such methods, further comprising a step of providing a second layer in contact with said matrix, said second layer comprising a polymeric material.

It is a further object of embodiments of this invention to provide such methods, wherein said step of providing a second layer comprises providing a second layer comprising a polymer chosen from the group consisting of ethylene vinyl acetate, low-density polyethylene, polyethylene terephthalate, and polypropylene.

It is a further object of embodiments of this invention to provide such methods, further comprising a step of coextruding a layer comprising said zeolite and said matrix with a second layer comprising a polymeric material.

It is a further object of embodiments of this invention to provide such methods, wherein step of immobilizing said biocidic zeolite in a polymer matrix comprises immobilizing said biocidic zeolite in a polymer matrix such that the resulting product is in the form of a film of a thickness of not more than about 100 μm.

It is a further object of embodiments of this invention to disclose such methods as defined in any of the above, further comprising disposing said biocidic zeolite on a substrate.

It is a further object of embodiments of this invention to provide such methods, wherein said step of disposing said biocidic zeolite on a substrate comprises disposing on a substrate made of a material chosen from the group consisting of cardboard, wood, plastic, metal, and glass.

It is a further object of embodiments of this invention to provide such methods, further comprising disposing said biocidic zeolite immobilized in a polymer matrix on a substrate.

It is a further object of embodiments of this invention to provide such methods, wherein said step of disposing said biocidic zeolite immobilized in a polymer matrix on a substrate comprises disposing said biocidic zeolite immobilized in a polymer matrix on a substrate made of a material chosen from the group consisting of cardboard, wood, plastic, metal, and glass.

It is a further object of embodiments of this invention to provide such methods, wherein said layer comprising either said biocidic zeolite or said boicidic zeolite immobilized in said polymer is disposed upon said substrate by a method chosen from the group consisting of doping, gluing, spraying, coating, immersing, and co-extruding.

It is a further object of embodiments of this invention to provide such methods, wherein said step of disposing biocidic zeolite immobilized in a polymer matrix about at least a portion of the interior of the surface enclosing said predetermined volume comprises a step of incorporating said biocidic zeolite into the material enclosing said predetermined volume.

It is a further object of embodiments of this invention to disclose such methods as defined in any of the above, wherein said step of disposing biocidic zeolite about at least a portion of the interior of the surface enclosing said predetermined volume comprises a step of disposing biocidic zeolite about at least a portion of the surface of an insert placed within said volume.

It is a further object of embodiments of this invention to provide such methods, wherein said step of disposing biocidic zeolite immobilized in a polymer matrix about at least a portion of the interior of the surface enclosing said predetermined volume comprises a step of disposing biocidic zeolite about at least a portion of the surface of an insert placed within said volume.

It is a further object of embodiments of this invention to provide such methods, wherein said step of disposing biocidic zeolite immobilized in a polymer matrix about at least a portion of the interior of the surface enclosing said predetermined volume comprises a step of disposing biocidic zeolite within an insert placed within said volume such that at least a portion of said biocidic zeolite is within a predetermined distance of said predetermined volume.

It is a further object of embodiments of this invention to provide such methods, wherein said predetermined distance is about 50 nm.

It is a further object of embodiments of this invention to provide such methods, wherein said predetermined distance is about 10 nm.

It is a further object of this invention to disclose a method as defined in any of the above, wherein said step of exposing comprises a step of exposing said microorganisms indirectly to said biocidic zeolite.

It is a further object of this invention to disclose the use of a zeolite for the control of the population of microorganisms within a predetermined volume, wherein the amount of antimicrobial material chosen from the group consisting of heavy metals, ions and salts thereof, antibiotics sequestered within said biocidic zeolite, and antibiotics bound to said biocidic zeolite that can be released into said predefined volume is insufficient to affect the population of microorganisms within said predefined volume, and further wherein said zeolite is substantially free of any material comprising a substituent that can kill microorganisms by insertion into the cell membrane.

It is hence one object of the invention to disclose an insoluble proton sink or source (PSS), useful for killing living target cells (LTCs), or otherwise disrupting vital intracellular processes and/or intercellular interactions of the LTC upon contact. The PSS comprising (i) proton source or sink providing a buffering capacity; and (ii) means providing proton conductivity and/or electrical potential; wherein said PSS is effectively disrupting the pH homeostasis and/or electrical balance within the confined volume of the LTC and/or disrupting vital intercellular interactions of the LTCs while efficiently preserving the pH of the LTCs' environment.

It is in the scope of the invention wherein the PSS is an insoluble hydrophobic, either anionic, cationic or zwitterionic charged polymer, useful for killing living target cells (LTCs), or otherwise disrupting vital intracellular processes and/or intercellular interactions of the LTC upon contact. It is additionally or alternatively in the scope of the invention, wherein the PSS is an insoluble hydrophilic, anionic, cationic or zwitterionic charged polymer, combined with water-immiscible polymers useful for killing living target cells (LTCs), or otherwise disrupting vital intracellular processes and/or intercellular interactions of the LTC upon contact. It is further in the scope of the invention, wherein the PSS is an insoluble hydrophilic, either anionic, cationic or zwitterionic charged polymer, combined with water-immiscible either anionic, cationic of zwitterionic charged polymer useful for killing living target cells (LTCs), or otherwise disrupting vital intracellular processes and/or intercellular interactions of the LTC upon contact.

It is also in the scope of the invention wherein the PSS is adapted in a non-limiting manner, to contact the living target cell either in a bulk or in a surface; e.g., at the outermost boundaries of an organism or inanimate object that are capable of being contacted by the PSS of embodiments of the present invention; at the inner membranes and surfaces of microorganisms, animals and plants, capable of being contacted by the PSS by any of a number of transdermal delivery routes etc; at the bulk, either a bulk provisioned with stifling or nor etc.

It is further in the scope of the invention wherein either (i) a PSS or (ii) an article of manufacture comprising the PSS also comprises an effective measure of at least one additive.

It is another object of the invention to disclose the PSS as defined in any of the above, wherein the proton conductivity is provided by water permeability and/or by wetting, especially wherein the wetting is provided by hydrophilic additives.

It is another object of the invention to disclose the PSS as defined in any of the above, wherein the proton conductivity or wetting is provided by inherently proton conductive materials (IPCMs) and/or inherently hydrophilic polymers (IHPs), especially by IPCMs and/or IHPs selected from a group consisting of sulfonated tetrafluortheylene copolymers; sulfonated materials selected from a group consisting of silica, polythion-ether sulfone (SPTES), styrene-ethylene-butylene-styrene (S-SEBS), polyether-ether-ketone (PEEK), poly (arylene-ether-sulfone) (PSU), Polyvinylidene Fluoride (PVDF)-grafted styrene, polybenzimidazole (PBI) and polyphosphazene; proton-exchange membrane made by casting a polystyrene sulfonate (PSSnate) solution with suspended micron-sized particles of cross-linked PSSnate ion exchange resin; commercially available NAFION™ and derivatives thereof.

It is another object of the invention to disclose the PSS as defined in any of the above, wherein the PSS is constructed as a conjugate, comprising two or more, either two-dimensional (2D) or three-dimensional (3D) PSSs, each of which of the PSSs consisting of materials containing highly dissociating cationic and/or anionic groups (HDCAs) spatially organized in a manner which efficiently minimizes the change of the pH of the LTC's environment. Each of the HDCAs is optionally spatially organized in specific either 2D, topologically folded 2D surfaces, or 3D manner efficiently which minimizes the change of the pH of the LTC's environment; further optionally, at least a portion of the spatially organized HDCAs are either 2D or 3D positioned in a manner selected from a group consisting of (i) interlacing; (ii) overlapping; (iii) conjugating; (iv) either homogeneously or heterogeneously mixing; and (iv) tiling the same.

It is acknowledged in this respect to underline that the term HDCAs refers, according to one specific embodiment of the invention, and in a non-limiting manner, to ion-exchangers, e.g., water immiscible ionic hydrophobic materials.

It is another object of the invention to disclose the PSS as defined in any of the above, wherein the PSS is effectively disrupting the pH homeostasis within a confined volume while efficiently preserving the entirety of the LTC's environment; and further wherein the environment's entirety has parameters selected from a group consisting of the environment functionality, chemistry; soluble's concentration, possibly other then proton or hydroxyl concentration; biological related parameters; ecological related parameters; physical parameters, especially particles size distribution, rehology and consistency; safety parameters, especially toxicity, otherwise LD₅₀ or ICT₅₀ affecting parameters; olphactory or organoleptic parameters (e.g., color, taste, smell, texture, conceptual appearance etc); or any combination of the same.

It is another object of the invention to disclose the PSS as defined in any of the above, wherein the PSS is provided useful for disrupting vital intracellular processes and/or intercellular interactions of the LTC, while both (i) effectively preserving the pH of the LTC's environment and (ii) minimally affecting the entirety of the LTC's environment such that a leaching from the PSS of either ionized or neutral atoms, molecules or particles (AMP) to the LTC's environment is minimized.

It is well in the scope of the invention wherein the aforesaid leaching minimized such that the concentration of leached ionized or neutral atoms is less than 1 ppm. Alternatively, the aforesaid leaching is minimized such that the concentration of leached ionized or neutral atoms is less than less than 50 ppb. Alternatively, the aforesaid leaching is minimized such that the concentration of leached ionized or neutral atoms is less than less than 50 ppb and more than 10 ppb. Alternatively, the aforesaid leaching is minimized such that the concentration of leached ionized or neutral atoms is less than less than 10 but more than 0.5 ppb. Alternatively, the aforesaid leaching is minimized such that the concentration of leached ionized or neutral atoms is less than less than 0.5 ppb.

It is another object of the invention to disclose the PSS as defined in any of the above, wherein the PSS is provided useful for disrupting vital intracellular processes and/or intercellular interactions of the LTC, while less disrupting pH homeostasis and/or electrical balance within at least one second confined volume (e.g., non-target cells, NTC).

It is another object of the invention to disclose the differentiating PSS as defined in any of the above, wherein differentiation between the LTC and NTC is obtained by one or more of the following means: (i) providing differential ion capacity; (ii) providing differential pH values; and, (iii) optimizing PSS to target cell size ratio; (iv) providing a differential spatial, either 2D, topologically folded 2D surfaces, or 3D configuration of the PSS; (v) providing a critical number of PSS' particles (or applicable surface) with a defined capacity per a given volume; and (vi) providing size exclusion means.

It is another object of the invention to disclose an article of manufacture, comprising at least one insoluble non-leaching PSS as defined in any of the above. The PSS, located on the internal and/or external surface of the article, is provided useful, upon contact, for disrupting pH homeostasis and/or electrical balance within at least a portion of an LTC while effectively preserving pH & functionality of the surface.

It is another object of the invention to disclose an article of manufacture, comprising at least one insoluble non-leaching PSS as defined in any of the above adapted for killing at least one target cell. The PSS is having at least one external proton-permeable surface with a given functionality (e.g., electrical current conductivity, affinity, selectivity etc), the surface is at least partially composed of, or topically and/or underneath layered with a PSS, such that disruption of vital intracellular processes and/or intercellular interactions of the LTC is provided, while the LTC's environment's pH & the functionality is effectively preserved.

It is another object of the invention to disclose an article of manufacture, comprising at least one insoluble non-leaching PSS as defined in any of the above, comprising a surface with a given functionality, and one or more external proton-permeable layers, each of which of the layers is disposed on at least a portion of the surface; wherein the layer is at least partially composed of or layered with a PSS such that vital intracellular processes and/or intercellular interactions of the LTC are disrupted, while the LTC's environment's pH & the functionality is effectively preserved.

It is another object of the invention to disclose an article of manufacture, comprising at least one insoluble non-leaching PSS as defined in any of the above. The PSS-based system comprising (i) at least one PSS; and (ii) one or more preventive barriers, providing the PSS with a sustained long activity; preferably wherein at least one barrier is a polymeric preventive barrier adapted to avoid heavy ion diffusion; further preferably wherein the polymer is an ionomeric barrier, and particularly a commercially available NAFION™).

It is acknowledged in this respect that the presence or incorporation of barriers that can selectively allow transport of protons and hydroxyls but not of other competing ions to and/or from the SIEx surface eliminates or substantially reduces the ion-exchange saturation by counter-ions, resulting in sustained and long acting cell killing activity of the materials and compositions of the current invention.

It is in the scope of the invention, wherein the proton and/or hydroxyl-exchange between the cell and strong acids and/or strong basic materials and compositions may lead to disruption of the cell pH-homeostasis and consequently to cell death. The proton conductivity property, the volume buffer capacity and the bulk activity are pivotal and crucial to the present invention.

It is further in the scope of the invention, wherein the pH derived cytotoxicity can be modulated by impregnation and coating of acidic and basic ion exchange materials with polymeric and/or ionomeric barrier materials.

It is another object of the invention to disclose an article of manufacture, comprising at least one insoluble non-leaching PSS as defined in any of the above, adapted to avoid development of LTC's resistance and selection over resistant mutations.

It is another object of the invention to disclose an article of manufacture as defined in any of the above, designed and constructed as a member of a group consisting of barriers; membranes; filers; pads; meshes; nets; inserts; particulate matter; powders, nano-powders and the like; vehicles, carriers or vesicles consisting a PSS (e.g., liposomes with PSSs); doped, coated, immersed, contained, soaked, immobilized, entrapped, affixed, set in a column, solubilized, or otherwise bonded PSS-containing matter.

It is another object of the invention to disclose an article of manufacture, having at least one of the following (i) regeneratable proton source or sink; (ii) regeneratable buffering capacity; and (iii) regeneratable proton conductivity.

It is another object of the invention to disclose methods for killing living target cells (LTCs), or otherwise disrupting vital intracellular processes and/or intercellular interactions of the LTC upon contact. The methods comprising steps of providing at least one PSS having (i) proton source or sink providing a buffering capacity; and (ii) means providing proton conductivity and/or electrical potential; contacting the LTCs with the PSS; and, by means of the PSS, effectively disrupting the pH homeostasis and/or electrical balance within the LTC while efficiently preserving the pH of the LTC's environment.

It is another object of the invention to disclose methods as defined above, wherein the aforthee first step further comprising a step of providing the PSS with water permeability and/or wetting characteristics, in particular wherein the proton conductivity and wetting is at least partially obtained by providing the PSS with hydrophilic additives.

It is another object of the invention to disclose methods as defined above, wherein the methods further comprising a step of providing the PSS with inherently proton conductive materials (IPCMs) and/or inherently hydrophilic polymers (1HPs), especially by selecting the IPCMs and/or IHPs from a group consisting of sulfonated tetrafluoroetheylene copolymers; commercially available NAFION™ and derivatives thereof.

It is another object of the invention to disclose methods as defined above, wherein the methods further comprising steps of providing two or more, either two-dimensional (2D), topologically folded 2D surfaces, or three-dimensional (3D) PSSs, each of which of the PSSs consisting of materials containing highly dissociating cationic and/or anionic groups (HDCAs); and, spatially organizing the HDCAs in a manner which minimizes the change of the pH of the LTC's environment.

It is another object of the invention to disclose methods as defined above, wherein the methods further comprising a step of spatially organizing each of the HDCAs in a specific, either 2D or 3D manner, such that the change of the pH of the LTC's environment is minimized.

It is another object of the invention to disclose methods as defined above, wherein the step of organizing is provided by a manner selected for a group consisting of (i) interlacing the HDCAs; (ii) overlapping the HDCAs; (iii) conjugating the HDCAs; (iv) either homogeneously or heterogeneously mixing the HDCAs; and (v) tiling of the same.

It is another object of the invention to disclose methods as defined above, wherein the methods further comprising a step of disrupting pH homeostasis and/or electrical potential within at least a portion of an LTC by a PSS, while both (i) effectively preserving the pH of the LTC's environment; and (ii) minimally affecting the entirety of the LTC's environment; the method is especially provided by minimizing the leaching of either ionized or electrically neutral atoms, molecules or particles from the PSS to the LTC's environment.

It is another object of the invention to disclose methods as defined above, wherein the methods further comprising steps of preferentially disrupting pH homeostasis and/or electrical balance within at least one first confined volume (e.g., target living cells, LTC), while less disrupting pH homeostasis within at least one second confined volume (e.g., non-target cells, NTC).

It is another object of embodiments of the invention to disclose the differentiating method as defined above, wherein the differentiation between the LTC and NTC is obtained by one or more of the following steps: (i) providing differential ion capacity; (ii) providing differential pH value; (iii) optimizing the PSS to LTC size ratio; and, (iv) designing a differential spatial configuration of the PSS boundaries on top of the PSS bulk; and (v) providing a critical number of PSS' particles (or applicable surface) with a defined capacity per a given volume; and (vi) providing size exclusion means, e.g., mesh, grids etc.

It is another object of embodiments of the invention to disclose methods for the production of an article of manufacture, comprising steps of providing an PSS as defined above; locating the PSS on top or underneath the surface of the article; and upon contacting the PSS with an LTC, disrupting the pH homeostasis and/or electrical balance within at least a portion of the LTC while effectively preserving pH & functionality of the surface.

It is another object of embodiments of the invention to disclose methods as defined above, wherein the methods further comprising steps of providing at least one external proton-permeable surface with a given functionality; providing at least a portion of the surface with at least one PSS, and/or layering at least one PSS on top of, or underneath the surface; hence killing LTCs or otherwise disrupting vital intracellular processes and/or intercellular interactions of the LTC, while effectively preserving the LTC's environment's pH & functionality.

It is another object of embodiments of the invention to disclose methods as defined above, wherein the methods further comprising steps of providing at least one external proton-permeable providing a surface with a given functionality; disposing one or more external proton-permeable layers topically and/or underneath at least a portion of the surface; the one or more layers are at least partially composed of or layered with at least one PSS; and, killing LTCs, or otherwise disrupting vital intracellular processes and/or intercellular interactions of the LTC, while effectively preserving the LTC's environment's pH & functionality.

It is another object of embodiments of the invention to disclose methods as defined above, wherein the methods comprising steps of providing at least one PSS; and, providing the PSS with at least one preventive barrier such that a sustained long acting is obtained.

It is another object of embodiments of the invention to disclose methods as defined above, wherein the step of providing the barrier is obtained by utilizing a polymeric preventive barrier adapted to avoid heavy ion diffusion; preferably by providing the polymer as an ionomeric barrier, and particularly by utilizing a commercially available NAFION™ product.

It is hence in the scope of the invention wherein one or more of the following materials are provided: encapsulated strong acidic and strong basic buffers in solid or semi-solid envelopes, solid ion-exchangers (SIEx), ionomers, coated-SIEx, high-cross-linked small-pores SIEx, Filled-pores SIEx, matrix-embedded SIEx, ionomeric particles embedded in matrices, mixture of anionic (acidic) and cationic (basic) SIEx etc.

It is another object of embodiments of the invention to disclose the PSS as defined in any of the above, wherein the PSS are naturally occurring organic acids compositions containing a variety of carbocsylic and/or sulfonic acid groups of the family, abietic acid (C₂₀H₃₀O₂) such as colophony/rosin, pine resin and alike, acidic and basic terpenes.

It is another object of embodiments of the invention to disclose methods for inducing apoptosis in at least a portion of LTCs population. The methods comprising steps of obtaining at least one PSS as defined in any of the above; contacting the PSS with an LTC; and, effectively disrupting the pH homeostasis and/or electrical balance within the LTC such that the LTC's apoptosis is obtained, while efficiently preserving the pH of the LTC's environment.

It is another object of embodiments of the invention to disclose methods for avoiding development of LTC's resistance and selecting over resistant mutations. The methods comprising steps of obtaining at least one PSS as defined above; contacting the PSS with an LTC; and, effectively disrupting the pH homeostasis and/or electrical balance within the LTC such that development of LTC's resistance and selecting over resistant mutations is avoided, while efficiently preserving the pH of the LTC's environment and patient's safety.

It is another object of embodiments of the invention to disclose methods of treating a patient, comprising steps of obtaining a non-naturally occurring medical implant; providing the implant with at least one PSS as defined as defined above, adapted for disrupting pH homeostasis and/or electrical balance within an LTC; implanting the implant within a patient, or applying the same to a surface of the patient such that the implant is contacting at least one LTC; and, disrupting vital intracellular processes and/or intercellular interactions of the LTC, while effectively preserving the pH of the LTC's environment and patient's safety.

It is another object of embodiments of the invention to disclose methods of treating a patient, comprising steps of administrating to a patient an effective measure of PSSs as defined above, in a manner the PSSs contacts at least one LTC; and, disrupting vital intracellular processes and/or intercellular interactions of the LTC, while effectively preserving the pH of the LTC's environment. It is in the scope of the invention wherein the PSS is administrated e.g., orally, rectally, endoscopally, brachytherapy, topically or intravenously, systemically, as a particulate matter, provided as is or by a pharmaceutically accepted carrier.

It is another object of embodiments of the invention to disclose methods of regenerating a PSS as defined above; comprising at least one step selected from a group consisting of (i) regenerating the PSS; (ii) regenerating its buffering capacity; and (iii) regenerating its proton conductivity.

It is contemplated that whenever appropriate, any embodiment of the present invention can be combined with one or more other embodiments of the present invention, even though the embodiments are described under different aspects of the present invention.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-B are graphs illustrating the spatial distribution of the native and urea denatured forms of the protein phycocyanin in strips containing polyacrylamide based gels having a pH gradient. The graph of FIG. 1A represents the results of the scan for native (non-denatured) phycocyanin. The graph of FIG. 1B represents the results of the scan for 8M Urea denatured phycocyanin. The vertical axes represent the Absorbance in O.D. units and the horizontal axes represent the position on the scanned gel strip expressed in pH units.

FIGS. 2A-B are graphs illustrating the spatial distribution of the native and urea denatured forms of the protein myoglobin in strips containing polyacrylamide based gels having a pH gradient. The graph of FIG. 2A represents the results of the scan for native (non-denatured) myoglobin. The graph of FIG. 2B represents the results of the scan for 8M Urea denatured myoglobin. The vertical axes represent the Absorbance in O.D. units and the horizontal axes represent the position on the scanned gel strip expressed in pH units.

FIGS. 3A-B are photographs representing two different stages of the results of an experiment demonstrating pH dependent separation and redistribution of the two different proteins myoglobin and phycocyanin. FIG. 3A is a top view of the experimental chamber immediately after the mixture of myoglobin and phycocyanin was placed in the middle compartment 2. FIG. 3B is a top view of the same experimental chamber photographed seven days following disposition of the mixture of myoglobin and phycocyanin in the middle compartment 2.

FIGS. 4A-C are composite photomicrographs illustrating the temporal variation of GFP distribution in a cell following attachment of the cell to a pH modifying bead. FIG. 4A represents a cell (8) attached to a bead (6) at time zero (defined as the time of attachment of the cell to the bead). FIG. 4B represents the cell (8) attached to the bead (6), as photographed ten minutes after the leftmost photograph was taken. FIG. 4C represents the cell (8) attached to the bead (6), as photographed thirty (30) minutes after the leftmost photograph was taken. The fluorescing point labeled by the thick white arrows, represents the fluorescence of GFP that migrated and accumulated at the point of contact between the bead 6 and the cell 8.

FIG. 5 is a graph illustrating the spatial distribution of Yellow fluorescent protein (YFP) on strips of immobiline containing polyacrylamide based gels having a pH gradient. The vertical axis represents optical density, and the horizontal axis represents the position along the IPG strip expressed in pH units.

FIGS. 6A-B are photomicrographs illustrating the cytotoxic effect of NAFION™ film on Jurkat cells. FIG. 6A illustrates Jurkat cells on a non-NAFION™ surface. FIG. 6B illustrates Jurkat cells on a NAFION™ surface.

FIG. 7 is a line graph showing the percent of dead (red) Jurkat cells following exposure to the MVC/HT/56 A, B, C and D films of embodiments of the present invention.

FIGS. 8A-D are photomicrographs illustrating the cytotoxic effect of BIOACT 13, 15, 16 and 110 films on Jurkat cells using LIVE/DEAD® BacLight™ Bacterial Viability Kit (Molecular probes) in which dead cells appear red and live cells appear green under a fluorescent microscope. FIG. 8A illustrates control Jurkat cells (with no exposure to bioactive film) after 1 minute. FIG. 8B illustrates Jurkat cells with BIOACT 13 film added after 1 minute. FIG. 8C illustrates control Jurkat cells (with no exposure to bioactive film) after 10 minutes. FIG. 8D illustrates Jurkat cells with BIOACT 13 film added after 10 minutes.

FIGS. 9A-C are photographs illustrating the anti-necrotic effect of ion exchange resin beads. FIG. 9A is a photograph of a necrotic tissue prior to the administration of the ion exchange resin beads. FIG. 9B is a photograph of the same tissue following a two day application of the ion exchange beads. FIG. 9C is a photograph of the fabric to which the ion exchange beads were applied.

FIG. 10 is a graph illustrating the cytotoxic effect of the PAAG-coated silica beads against Jurkat cells as a pH and time dependent phenomena. Jurkat cells were exposed for 0, 10, 20 and 30 min to PAAG-coated silica beads. Cell viability was evaluated by LIVE/DEAD® Viability Kit;

FIG. 11 is a graph illustrating the cytotoxic effect of PAAG-coated silica beads bearing different pH as a function of the beads concentration. Jurkat cells were exposed for 0, 10, 20 and 30 min to PAAG-coated silica beads. Cell viability was evaluated by LIVE/DEAD® Viability Kit;

FIG. 12 is a graph illustrating the cytotoxic effect of PAAG beads against Jurkat cells as a function of beads pH and incubation time. Jurkat cells were exposed for 0, 10, 20 and 30 min to PAAG-coated silica beads. Cell viability was evaluated by LIVE/DEAD® Viability Kit;

FIG. 13 is a graph illustrating the cytotoxic effect of PAAG-coated silica beads on HT-29 cells as a function of the beads pH and incubation time. HT-29 cells were exposed for 50 hrs to PAAG-coated silica beads. Cell viability was evaluated by sulforhodamine assay;

FIG. 14 is a graph illustrating the concentration-dependent cytotoxic effect of PAAG-coated silica beads on HT-29 cells. HT-29 cells were exposed for 50 hrs to different concentrations of PAAG-coated silica beads. Cell viability was evaluated by sulforhodamine assay;

FIG. 15 is a graph illustrating the cytotoxic effect of PAAG beads on HT-29 cells as a function of beads pH. HT-29 cells were exposed for 50 hrs to PAAG-coated silica beads. Cell viability was evaluated by sulforhodamine assay;

FIG. 16 is a graph illustrating the concentration-dependent cytotoxic effect of PAAG beads bearing different pH between 2 to 6, on HT-29 cells. HT-29 cells were exposed for 50 hrs to different concentrations of PAAG-coated silica beads. Cell viability was evaluated by sulforhodamine assay;

FIG. 17 is a graph illustrating the concentration-dependent cytotoxic effect of PAAG beads bearing different pH between 7 to 11, on HT-29 cells. HT-29 cells were exposed for 50 hrs to different concentrations of PAAG-coated silica beads. Cell viability was evaluated by sulforhodamine assay;

FIG. 18 is a graph illustrating a hemolytic activity of PAAG-coated silica beads. Red blood cells were exposed for 4 hrs to PAAG-coated silica beads. Hemolytic activity of the beads was detected spectrophotometrically;

FIG. 19 is a graph illustrating the cytotoxicity of PAAG-beads on Jurkat cells. Jurkat cells were exposed for 20 min to PAAG beads. Percent of live cells was evaluated by LIVE/DEAD® Viability Kit;

FIG. 20 is a graph illustrating the cytotoxicity of PAAG-beads on Jurkat cells. Jurkat cells were exposed for 20 min to PAAG beads. Percent of dead cells was evaluated by LIVE/DEAD® Viability Kit;

FIG. 21 is a graph illustrating PAAG-beads induce apoptosis of Jurkat cells. Jurkat cells were exposed for 20 min to PAAG beads. For detection of apoptosis, Annexin V Apoptosis Detection Kit was used;

FIG. 22 is a graph illustrating the cytotoxicity of PAAG-coated silica beads on Jurkat cells. Jurkat cells were exposed for 20 min to PAAG-coated silica beads. Percent of live cells was evaluated by LIVE/DEAD® Viability Kit;

FIG. 23 is a graph illustrating the cytotoxicity of PAAG-coated silica beads on Jurkat cells. Jurkat cells were exposed for 20 min to PAAG-coated silica beads. Percent of dead cells was evaluated by LIVE/DEAD® Viability Kit;

FIG. 24 is a graph illustrating PAAG-coated-silica-beads-induced apoptosis of Jurkat cells. Jurkat cells were exposed for 20 min to PAAG-coated silica beads. For detection of apoptosis, Annexin V Apoptosis Detection Kit was used;

FIG. 25 is photomicrograph illustrating morphology of control and PAAG-coated silica beads treated Jurkat cells. Cells were exposed to PAAG-coated silica beads #48 and then examined for chromatin condensation with Hoechst 33342;

FIG. 26 is photomicrograph illustrating morphology of control and PAAG-coated silica beads treated Jurkat cells. Cells were exposed to PAAG-coated silica beads #48. Morphological examination showed swollen cells with cellular blebbing, characteristic of apoptosis;

FIG. 27 is photomicrograph illustrating morphology of control and PAAG-coated silica beads treated Jurkat cells. Cells were exposed to PAAG-coated silica beads #48. Morphological examination showed swollen cells with cellular blebbing, characteristic of apoptosis;

FIG. 28 shows a concentration dependent toxicity of G1 phase cells;

FIG. 29 shows concentration dependent toxicity of G1 phase cells, and mitotic phase cells;

FIGS. 30 & 31 present activity tests on compositions A & B, respectively;

FIG. 32 presents tests made by PSS on Candida albicans (ATCC 10231); and

FIG. 33 presents a histogram showing the relative efficacies of untreated and treated LDPE bottles in controlling the microbial concentration in a sample of milk as described in Example 37.

### DETAILED DESCRIPTION OF THE INVENTION

Provided herein are biocidic compositions including an ion exchange material, wherein when said material is in an environment capable of transporting H⁺, said ion exchange material is adapted to cause the death of at least one cell within or in contact with said environment. A selectively permeable barrier layer may be provided covering the ion exchange material. Also provided herein are methods of making the foregoing biocidic compositions. In addition, provided herein are methods of using the foregoing biocidic compositions to cause the death of at least one cell.

Embodiments of the present invention provide methods of affecting cellular processes using ion exchange materials. Specifically, embodiments of the present invention may be exploited for a myriad of applications ranging from the killing of diseased cells in the body such as cancerous cells, to the killing of harmful prokaryotic cells in the environment.

The principles and operation of embodiments of the present invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

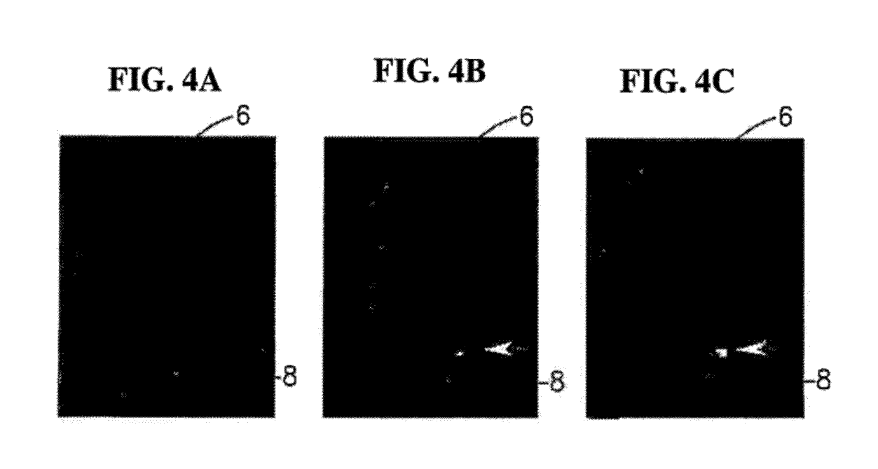

Embodiments of this invention is the result of serendipitous and unexpected findings by the present inventors. They demonstrated that biomolecules (e.g. proteins) typically comprise a pH characteristic which determines their spatial distribution along a pH gradient (See, e.g., Example 1). Further experimentation provided evidence that this redistribution can also occur across a biological membrane (See, e.g., Example 3, FIGS. 4A-C).

Whilst conceiving of embodiments of the present invention, the present inventors uncovered that processes inside the cell may be manipulated by changing the extracellular pH of an ion exchange material in contact therewith. Accordingly, the present inventors have shown that disruption of cellular pH homeostasis may be effected by contacting cells with an ion exchange material comprising a pH which is different from the pH of the intracellular components. The contact results in the titration of the intracellular pH in the cytoplasm and generally leads to an alteration in a cellular process. Cell death may be effected when the pH of the buffering material is beyond the viability range of pH for a specific cell.

U.S. Pat. Appl. Nos. 20050271780, 20050249695 and 20050003163 teach bactericidal polymers. The polymers as taught therein rely on the direct contact of the polymer with the cellular membrane since the bactericidal activity originates from inclusion of cationic molecules, either immobilized on surfaces of, or incorporated in polymeric structures. The level of toxicity is strongly dependent on the surface concentration of the bactericidal entities. This requirement presents a strong limitation since the exposed cationic materials can be saturated very fast in ion exchange reactions.

The ion exchange materials taught within are not restricted to cationic polymers, but anionic buffers as well, since the novel mechanism of embodiments of the present invention does not rely on the penetration of cationic groups to disrupt the cell membrane, but relies on an overall bulk buffering effect. The ion exchange materials taught herein are not restricted by the surface concentration of a bactericidal entity, since the cytotoxic activity thereof originates from their bulk properties and not just surface properties.

Whilst reducing the present invention to practice, the present inventors showed that ion exchange materials may exert a cytotoxic effect on many cell types, such as for example yeast cells (Example 4, Table 2), mammalian Jurkat cells (Example 5, Table 3) bacterial cells (Example 11, Table 5) and fungal cells (Example 12).

The present inventors further demonstrated that the rate of cell mortality may be controlled by the choice of the pH value of an ion exchange material in contact with the cells, such that the rate of cell death can be fine tuned by suitably modifying the pH values of the ion exchange material contacting the cells (See e.g., Example 4, Table 2).

In addition, the present inventors showed that pH-induced cytotoxicity requires direct contact of the cell with the ion exchange material. Accordingly, physical barriers of a particular pore size may be attached to the ion exchange material, such that pH homeostasis is disrupted (altered) for cells of a particular size only. In this fashion, cells of particular dimensions may be targeted leaving other cells unaltered (See Example 8).

Furthermore, the present inventors showed that a water permeable layer being disposed on an external surface of the buffering layer still allows the ion exchange material to exert its cellular affects since the water permeable layer allows the redistribution of ions and therefore does not decrease the overall bulk effect of the ion exchange material. Thus as illustrated in Example 14, ion exchange materials may be overlayed with open pore polymers and still exert cytotoxic effects.

Thus, according to one aspect of embodiments of the present invention there is provided methods of generating a change in a cellular process of a target cell of a multicellular organism, the methods comprising contacting the target cell with an ion exchange material, so as to alter an intracellular pH value in at least a portion of said cell, thereby generating the change in a cellular process of a target cell of a multicellular organism.

The cells of embodiments of the present invention may be in any cellular environment e.g. isolated cells, a cell suspension, a cell culture, in a tissue, or in an organism. The cells may be healthy or diseased (e.g. tumor cells) or a combination thereof.

As used herein, the phrase “change in a cellular process” refers to either an up-regulation of down-regulation in a cellular process. Exemplary cellular processes which may be changed according to this aspect of embodiments of the present invention, include but are not limited to rate of cell death (apoptosis or necrotic cell death), cell differentiation, cell signaling cell growth, cell division, cell differentiation, cell proliferation, tumor growth, tumor vascularization, tumor metastases, tumor metastases migration and/or mobility, cellular mobility, organelle function (including but not limited to, pseudopod formation, flagellar motility, and the like) and molecular transport across various cellular and intracellular membranes and compartments.

According to a particularly preferred embodiment of this aspect of embodiments of the present invention, the change in a cellular process results in cell killing. Calibrating the ion exchange material so that it is able to affect a cytotoxic action is described hereinbelow.

As used herein, the phrase “multicellular organism” refers to any organism containing more than one cell. Exemplary multicellular organisms include eukaryotes (e.g. mammals), and higher plants.

It will be appreciated that the ion exchange materials of embodiments of the present invention may also be used to affect cellular processes in prokaryotic cells as well—for example, fungi and gram positive and gram negative bacteria.

The term “Gram-positive bacteria” as used herein refers to bacteria characterized by having as part of their cell wall structure peptidoglycan as well as polysaccharides and/or teichoic acids and are characterized by their blue-violet color reaction in the Gram-staining procedure. Representative Gram-positive bacteria include: Actinomyces spp., Bacillus anthracis, Bifidobacterium spp., Clostridium botulinum, Clostridium perfringens, Clostridium spp., Clostridium tetani, Corynebacterium diphtheriae, Corynebacterium jeikeium, Enterococcus faecalis, Enterococcus faecium, Erysipelothrix rhusiopathiae, Eubacterium spp., Gardnerella vaginalis, Gemella morbillorum, Leuconostoc spp., Mycobacterium abcessus, Mycobacterium avium complex, Mycobacterium chelonae, Mycobacterium fortuitum, Mycobacterium haemophilium, Mycobacterium kansasii, Mycobacterium leprae, Mycobacterium marinum, Mycobacterium scrofulaceum, Mycobacterium smegmatis, Mycobacterium terrae, Mycobacterium tuberculosis, Mycobacterium ulcerans, Nocardia spp., Peptococcus niger, Peptostreptococcus spp., Proprionibacterium spp., Staphylococcus aureus, Staphylococcus auricularis, Staphylococcus capitis, Staphylococcus cohnii, Staphylococcus epidermidis, Staphylococcus haemolyticus, Staphylococcus hominis, Staphylococcus lugdanensis, Staphylococcus saccharolyticus, Staphylococcus saprophyticus, Staphylococcus schleiferi, Staphylococcus similans, Staphylococcus warneri, Staphylococcus xylosus, Streptococcus agalactiae (group B streptococcus), Streptococcus anginosus, Streptococcus bovis, Streptococcus canis, Streptococcus equi, Streptococcus milleri, Streptococcus mitior, Streptococcus mutans, Streptococcus pneumoniae, Streptococcus pyogenes (group A streptococcus), Streptococcus salivarius, Streptococcus sanguis.

The term “Gram-negative bacteria” as used herein refer to bacteria characterized by the presence of a double membrane surrounding each bacterial cell. Representative Gram-negative bacteria include Acinetobacter calcoaceticus, Actinobacillus actinomycetemcomitans, Aeromonas hydrophila, Alcaligenes xylosoxidans, Bacteroides, Bacteroides fragilis, Bartonella bacilliformis, Bordetella spp., Borrelia burgdorferi, Branhamella catarrhalis, Brucella spp., Campylobacter spp., Chalmydia pneumoniae, Chlamydia psittaci, Chlamydia trachomatis, Chromobacterium violaceum, Citrobacter spp., Eikenella corrodens, Enterobacter aerogenes, Escherichia coli, Flavobacterium meningosepticum, Fusobacterium spp., Haemophilus influenzae, Haemophilus spp., Helicobacter pylori, Klebsiella spp., Legionella spp., Leptospira spp., Moraxella catarrhalis, Morganella morganii, Mycoplasma pneumoniae, Neisseria gonorrhoeae, Neisseria meningitidis, Pasteurella multocida, Plesiomonas shigelloides, Prevotella spp., Proteus spp., Providencia rettgeri, Pseudomonas aeruginosa, Pseudomonas spp., Rickettsia prowazekii, Rickettsia rickettsii, Rochalimaea spp., Salmonella spp., Salmonella typhi, Serratia marcescens, Shigella spp., Treponema carateum, Treponema pallidum, Treponema pallidum endemicum, Treponema pertenue, Veillonella spp., Vibrio cholerae, Vibrio vulnificus, Yersinia enterocolitica, Yersinia pestis.

As used herein, the phrase “buffer” refers to any solid material which comprises a buffering capacity. A buffer capacity is defined as the capacity of the buffer to resist changes in its pH when acids or bases are added to the buffer (titration) and is determined by the concentration of H⁺ ions added per unit volume that may affect a change of 1 pH unit in the buffer system. The buffer capacity of a system is typically derived from the coexistence in the system of dissociated and non dissociated compounds capable of maintaining a constant supply of H⁺ ions. Accordingly, any acidic or basic substance (i.e. ion exchange material) incorporated in an ion conductive or water/ion permeable matrix may be classified as a buffer. The buffer capacity of solid substances is typically derived from the presence of a plurality of functional groups that can release or bind H⁺ and is determined by the degree of saturation of these substances, namely, the H⁺ concentration at which all of these functional groups interact.

Exemplary cationic ion exchange materials include, but are not limited to, sulfonic acids and derivatives thereof, sulfonated polystyrene and derivatives thereof, carboxylic acids and derivatives thereof, phosphonic acids and derivatives thereof, phosphinic acids and derivatives thereof, phenols and derivatives thereof, arsenic acids and derivatives thereof, and selenic acids and derivatives thereof.

Exemplary anionic exchange materials include, but are not limited to, compounds comprising quaternary, tertiary, secondary, and primary amines.

Exemplary water permeable matrices include, but are not limited to, open pore polymers, open pore ceramics, and gels.

Exemplary open pore polymers include, but are not limited to, PVOH, cellulose, and polyurethane.

Alternatively, the ion exchange material may comprise a matrix which is intrinsically ion conductive. Examples of intrinsically ion conducting ion exchange materials include, but are not limited to, ionomers and polycationic materials.

Some examples of ionomers that have been commercialized are NAFION™ perfluorinated sulfonic acid membranes and SURLYNT™ thermoplastic resin, both of which are available from available from E.I. du Pont de Nemours & Co., Inc. (Wilmington, Del.).

In preferred embodiments of the invention, the zeolites used are those in which channels within the zeolite structure are large enough to allow the passage of guest species. In preferred embodiments of the invention, the channels within the zeolite must have a minimum width greater than that of 6-membered rings (i.e., rings consisting of six tetrahedra) in order to allow zeolitic behavior at normal temperatures and pressures. The zeolite forms with properties most appropriate to the present invention include moredenite; ZSM-5; zeolite beta; zeolite X; zeolite Y; zeolite A; clinoptolite; Li-A, Afghanite, Analcime, BETA, Bikitaite, Boggsite, Brewsterite, Dachiardite, Edingtonite, Epistilbite, EUO-EU-1, Erionite, Faujasite, Ferrierite, Gismondine, Gmelinite, Goosecreekite, Heulandite, NaJ, ZK-5, Laumontite, Levyne, Losod, Linde Type A, Linde Type L, Linde Type N, Mazzite, ZSM-18, ZSM-11, Merlinoite, ZSM-57, Montesommaite, ZSM-12, ZSM-23, Natrolite, Offretite, Partheite, Paulingite, Phillipsite, Roggianite, Sodalite, Stilbite, Thomsonite, Theta-1 and Yugawaralite. In preferred embodiments of the invention, the zeolite used is chosen from these forms.

In some embodiments, the ion exchange material is a polymer. It will be appreciated that there is a very wide variety of polymers that may be used as ion exchange materials according to this aspect of embodiments of the present invention. Non-limiting examples of such polymers that are useful to the present invention include poly(4-vinyl-N-alkylpyridinium bromide), poly(methacryloyloxydodecyl-pyridinium bromide), poly(vinyl-N-hexylpyridinium), N-alkylated poly(4-vinylpyridine), poly(4-vinyl-N-alkylpyridine), poly(4-vinyl-N-alkylpyridinium bromide), poly(4-vinyl-N-alkylpyridine), poly(N-alkylvinylpyridine), sulfonated polystyrene divinylbenzene (acid form), sulfonated polystyrene, poly(N-alkyl-ethyleneimine), poly(1-chloromethyl-4-vinylbenzene), poly(dimethyloctyl[4-vinylphenyl]methylammonium chloride), poly(di-methyldodecyl[4-vinylphenyl]methylammonium chloride), poly(dimethyltetradecyl[4-vinylphenyl]methylammonium chloride, 50:50 poly(1-chloromethyl)-4-vinylbenzene: poly (dimethyldodecyl[4-vinylphenyl]methylammonium chloride), 50:50 poly(1-chloromethyl)-4-vinylbenzene: poly(dimethyl-octyl[4-vinylphenyl]methylammonium chloride), 50:50 poly (dimethyldodecyl[4-vinylphenyl]methylammonium chloride): poly(dimethyloctyl[4-vinyl-phenyl]methylammonium chloride), poly(tributyl[4-vinylphenyl]methylphosphonium chloride), and poly(trioctyl[4-vinylphenyl]methylphosphonium chloride).

It will be appreciated that the ion exchange material of embodiments of the present invention may also comprise gel matrices such as polyacrylamide and agarose gel matrices which have been suitably prepared with appropriate buffers (e.g. with IMMOBILINE™ acrylamido buffers). Amounts of immobilines pK buffers used that produce gels of a particular pH are set forth in Table 1 of the Example section below. The ion exchange materials of embodiments of the present invention may also be ion exchange beads, polymer coated ion exchange beads or ion exchange beads incorporated in an ion permeable matrix.

The term “contacting” as used herein refers to the positioning of the cell with respect to the ion exchange material and is confined by the necessity of ions from the ion exchange material to be conducted to the cell and vice versa. It is further understood that the term “contact” refers hereinafter to any direct or indirect contact of a volume or surface (e.g., an ion exchange material) with a confined volume (e.g., living target cell or virus—LTC), wherein the volume or surface and the confined volume are located adjacently, e.g., wherein a biocidic composition approaches either the internal or external portions of the LTC; further wherein the biocidic composition and the LTC are within a proximity which enables (i) an effective disruption of the pH homeostasis and/or electrical balance, or (ii) otherwise disrupting vital intracellular processes and/or intercellular interactions of the LTC.

The terms “effectively” and “effectively” refer hereinafter to an effectiveness of over 10%, additionally or alternatively, the term refers to an effectiveness of over 50%; additionally or alternatively, the term refers to an effectiveness of over 80%. It is in the scope of the invention, wherein for purposes of killing LTCs, the term refers to killing of more than 50% of the LTC population in a predetermined time, e.g., 10 min.

The term ‘additives’ refers hereinafter to one or more members of a group consisting of biocides e.g., organic biocides such as tea tree oil, rosin, abietic acid, terpens, rosemary oil etc, and inorganic biocides, such as zinc oxides, cupper and mercury, silver salts etc, markers, biomarkers, dyes, pigments, radio-labeled materials, glues, adhesives, lubricants, medicaments, sustained release drugs, nutrients, peptides, amino acids, polysaccharides, enzymes, hormones, chelators, multivalent ions, emulsifying or de-emulsifying agents, binders, fillers, thickfiers, factors, co-factors, enzymatic-inhibitors, organoleptic agents, carrying means, such as liposomes, multilayered vesicles or other vesicles, magnetic or paramagnetic materials, ferromagnetic and non-ferromagnetic materials, biocompatibility-enhancing materials and/or biodegradating materials, such as polylactic acids and polyglutaminc acids, anticorrosive pigments, anti-fouling pigments, UV absorbers, UV enhancers, blood coagulators, inhibitors of blood coagulation, e.g., heparin and the like, or any combination thereof.

The term “particulate matter” refers hereinafter to one or more members of a group consisting of nano-powders, micrometer-scale powders, fine powders, free-flowing powders, dusts, aggregates, particles having an average diameter ranging from about 1 nm to about 1000 nm, or from about 1 mm to about 25 mm.

The term “about” refers hereinafter to ±20% of the defined measure.

The term “surface” refers hereinafter in its broadest sense. In one sense, the term refers to the outermost boundaries of an organism or inanimate object (e.g., vehicles, buildings, and food processing equipment, etc.) that are capable of being contacted by the compositions of embodiments of the present invention (e.g., for animals: the skin, hair, and fur, etc., and for plants: the leaves, stems, flowering parts, seeds, roots and fruiting bodies, etc.). In another sense, the term also refers to the inner membranes and surfaces of animals and plants (e.g., for animals: the digestive tract, vascular tissues, and the like, and for plants: the vascular tissues, etc.) capable of being contacted by compositions by any of a number of transdermal delivery routes (e.g., injection, ingestion, transdermal delivery, inhalation, and the like).

As used herein, with reference to the approach of a microorganism to the materials disclosed in the present invention, the term “surface” refers to any part of the material to which the microorganism can approach sufficiently closely (in preferred embodiments, within about 50 nm; in the most preferred embodiments, within about 10 nm) that the biocidic effect of the material is observed. In this context, the term does not necessarily refer to the internal surface of a zeolite, since in most embodiments of the invention, the pores and interior channels of the material are too small to allow microorganisms to enter within.

As used herein, with reference to an interaction between a microorganism and one of the compositions of the present invention, the terms “contact” and “exposure” refer to any interaction by which the microorganism is affected by the surface charge of the composition. The contact may be direct physical contact, but it can also be indirect. As a non-limiting example of an indirect contact, a zeolite may be enclosed within a polymer, but as long as the microorganism can approach sufficiently closely such that its intracellular processes are affected by the electric field created by the surface charge, it is considered to have “contacted” or “been exposed to” the zeolite in this sense. Typically, a microorganism is affected by the surface electric field at distances on the order of tens of nanometers. Indirect contact may also be made by ion exchange or proton transfer to or from the surface.

The term “microorganism” refers herein to any organism of microscopic size. While preferred embodiments of the invention are directed specifically to means for killing pathogenic microorganisms, the term as used herein is not limited to any particular type of microorganism. Non-limiting examples of microorganisms as the term is used herein include both prokaryotic and eukaryotic microorganisms, such as bacteria, protozoan, fungi, virus, molds, yeasts, etc., as well as to viruses.

The term “biocidic property” refers hereinafter to the ability of a defined biocidic composition to deter, render harmless, or exert a controlling effect on any microorganism by physical (e.g., electrical or other charge-induced effect), chemical or biological means. The defined biocidic composition is optionally chosen from the biocides' group defined in Biocidal Products Directive 98/8/EC (BPD). As used herein, with reference to zeolites used in embodiments of the invention herein disclosed, the term “biocidic zeolite” refers to a zeolite that exhibit biocidic properties but that do not incorporate substances other than protons that can act to kill or slow the reproduction of microorganisms. Non-limiting examples of such substances (i.e. examples of substances not found in the “biocidic zeolites” used in the present invention) include heavy metals, ions or salts thereof, charged substituents that act to disrupt the cellular membrane, and antibiotics.

The term “substantially free of” a particular substance is used herein to define the substance as being present in a concentration of less than 1 ppm. Similarly, the term “substantially all” refers to a form is 99.99999% pure, i.e., comprises less than 1 ppm impurities.

The term “heavy metal” refers hereinafter to any toxic metal, such as a metal chosen from a group of transition metals, metalloids, lanthanides, actinides etc. Silver, zinc, tin, titanium, and cupper are provided herein in a non-limiting manner as an example of heavy metal.

As used herein, the term “heavy metal” refers hereinafter to any metallic or semi-metallic element not located in Group 1 or 2 of the periodic table, i.e. all metallic and semi-metallic elements other than the alkalis and alkaline earths. The term also refers to mixtures, compounds, and alloys of such metals. Silver, zinc, tin, and copper are non-limiting examples of “heavy metals” as the term is used herein that are typically used in biocidic compositions.

Unless the form is specifically described otherwise, the term “metal” refers hereafter to a metal in any form, including but not limited to metal atoms, particles of any size comprising a metal, macroscopic pieces of metal, metal ions, metal complexes, organometallic compounds, and metal salts.

The term “Lewis base” refers hereinafter to a molecular entity and the corresponding chemical species that is an electron-pair donor and therefore able to react with a Lewis acid to form a Lewis adduct. In other words, a Lewis base is any species that donates ion pair electrons. Various entities such OW; amines of the formula NH₃₋ₓRₓ where R=alkyl or aryl. phosphines of the formula PR₃ₓArₓ, where R=alkyl, Ar=aryl; compounds of O, S, Se and Te in oxidation state 2, including water, ethers, ketones; and hypochlorite are provided herein in a non-limiting manner as an example of Lewis bases.

The term “a polymer immobilizing” refers hereinafter to any polymer which immobilize zeolite, ionomer or polymer ioniomer, wherein the term “immobilizing” widely refers hereinafter to binding, adhering, coating, gluing, embedding, immobilizing, entrapping, melting, etc.

The terms “acidic zeolite” and “basic zeolite” refer hereinafter to zeolites where substantially all cations outside of the zeolite framework have been exchanged by protons (H⁺), thereby forming an acidic zeolite; and to zeolite is a product of a reaction that imparts to it Lewis-base character, thereby forming a basic zeolite, respectively, wherein the surface of the zeolite has a surface charge with a surface charge density of at least about 1×10⁻⁹ C/cm², and further wherein substantially all of the surface charge density originates from the zeolite. It is also in the scope of the invention wherein the terms “acidic zeolite” and “basic zeolite” refer to zeolites with an H⁺ concentration ≧10⁻³ mol L⁻¹ and ≧10⁻⁸ mol L⁻¹, respectively. It is also in the scope of the invention wherein the terms “acidic zeolite” and “basic zeolite” refer to zeolites with an H⁺ concentration ≧10^{-4.4} mol L⁻¹ and ≧10^{-7.5} mol L⁻¹, respectively.

The term “ionomer” refers hereinafter to a polymer that comprises repeat units of both electrically neutral repeating units and a fraction of ionized units. Sulfonated tetrafluoroethylene based fluoropolymer-copolymer, commercially available Nafion™ product, poly(ethylene-co-methacrylic acid) and various thermoplastic elastomers characterized by covalent bonds between the elements of the chain, and ionic bonds between the chains, are examples of ionomer.

Ion exchange materials are herein disclosed. The ion exchange material typically has a volumetric buffering capacity greater than about 20 mM H⁺/(L.pH unit). When the ion exchange material material is in an environment capable of transporting H⁺ ions, the ion exchange material is adapted to cause the death of at least one cell within or in contact with the environment.

The ion exchange material herein disclosed is adapted to cause the death of at least one cell within or in contact with the environment. The cell is a bacterial cell, a fungal cell or a yeast cell. The cell may be a prokaryotic cell or a eukaryotic cell.

Thus, according to one embodiment of this aspect of embodiments of the present invention, the cell and the ion exchange material are in direct physical contact with one another. For example, the ion exchange material may contact the exterior of the cell or adhere to the exterior of the cell. Alternatively, the ion exchange material may be internalized by the cell by known processes of internalization of exracellular substances, such as, but not limited to, phagocytosis, endocytosis, receptor mediated endocytosis, clathrin-coated pit or vesicle associated internalization processes, transferrinfection, and the like.

According to another embodiment of this aspect of embodiments of the present invention, the ion exchange material is separated from the cell by a water permeable layer. Such a water permeable layer would allow the flow of ions from the ion exchange material to the cell and vice versa and therefore would not impede the buffering capacity of the ion exchange material. Exemplary water permeable layers comprise PVOH, ethylcellulose, cellulose acetate, polyacrylamide, any microporous matrix with or without a hydrophilic additive, etc.

An embodiment of the ion exchange material herein disclosed is adapted to kill the cell without inserting any of its structure into the membrane of said cell and/or without creating a covalent bond with the membrane of said cell.

An embodiment of the ion exchange material herein disclosed, wherein the ion exchange material comprises one or more functional groups selected from the group consisting of sulfonic acid, phosphonic acid, quaternary amine, tertiary amine, hydroxyl, and derivatives thereof.

An embodiment of the ion exchange material herein disclosed, wherein the ion exchange material comprises one or more functional groups selected from the group consisting of carboxylic acid and derivatives thereof, phosphinic acid and derivatives thereof, phenol and derivatives thereof, arsonic acid and derivatives thereof, selenic acid and derivatives thereof, secondary amine and derivatives thereof, and primary amine and derivatives thereof.

An embodiment of the ion exchange material herein disclosed comprises sulfonated tetrafluoroethylene copolymer and/or derivatives thereof.

An embodiment of the ion exchange material herein disclosed is selected from the group consisting of polyacrylamide-immobilines, agarose-immobilines, poly(diethylaminoethyl acrylate), cationic polyurethane, cationic sub micron silica, and ion exchange beads.

An embodiment of the ion exchange material herein disclosed has a volumetric buffering capacity of at least about 50 mM H⁺/(L.pH unit).

An embodiment of the ion exchange material herein disclosed has a volumetric buffering capacity of at least about 100 mM H⁺/(L.pH unit).

An embodiment of the biocide composition herein disclosed comprises the composition having an H⁺ concentration of greater than about 3.2×10⁻⁵ M or less than about 10⁻⁸ M.

An embodiment of the biocide composition herein disclosed comprises a pH gradient along at least a portion thereof.

An embodiment of the biocide composition herein disclosed comprises a plurality of regions of differing pH.

An embodiment of the ion exchange material herein disclosed comprises ion exchange material is a polymer.

An embodiment of the ion exchange material is herein disclosed wherein the ion exchange material comprises cationic silica.

An embodiment of the ion exchange material is herein disclosed wherein the ion exchange material comprises one or more of an ion exchange bead, a polymer-coated ion exchange bead, and an ion exchange material incorporated in a matrix.

An embodiment of the ion exchange material is herein disclosed wherein the ion exchange material comprises one or more of a water soluble polymer, a water permeable polymer, an intrinsically ion-conducting polymer, an ion permeable polymer, and a water-permeable ceramic.

An embodiment of the ion exchange material is herein disclosed wherein the ion exchange material comprises at least a portion of a coating or a component of a medical device, a wound dressing, sutures, cloth, fabric and a wound ointment.

An embodiment of the ion exchange material is herein disclosed wherein the ion exchange material is in the form of a shaped article, a coating, a spray, a film, a laminate on a film, a film in a laminate, sheets, beads, beads incorporated in fabric, particles, microparticles, microcapsules, microemulsions or nanoparticles.

An embodiment of the ion exchange material is herein disclosed wherein the ion exchange material is covered by a barrier layer, the barrier layer characterized as being selectively permeable to water.

An embodiment of the ion exchange material is herein disclosed wherein the ion exchange material is covered by a barrier layer, the barrier layer characterized as being permeable to a preselected target cell but not to preselected non-target cells.

It is a mode of embodiments of the present invention to provide a composition of matter comprising (a) an ion exchange material, having a volumetric buffering capacity of greater than about 20 mM H⁺/(L.pH unit); and (b) a selectively permeable barrier layer covering the ion exchange material; the composition of matter being adapted to kill at least one target cell located in an environment capable of transporting H⁺ ions and in contact with the composition of matter.

It is a mode of embodiments of the present invention to provide the composition of matter wherein the selectively permeable barrier layer is selectively permeable to water.

It is a mode of embodiments of the present invention to provide the composition of matter wherein the selectively permeable barrier layer is selectively permeable to a preselected target cell but not to preselected non-target cells.

It is a mode of embodiments of the present invention to provide the barrier layer comprising at least one form selected from the group consisting of coating, film, and membrane.

It is a mode of embodiments of the present invention wherein the barrier layer is selected from the group consisting of an open pore polymer, an open pore ceramic and an open pore gel.

It is a mode of embodiments of the present invention to provide the barrier layer in an open pore polymer selected from the group consisting of one or more of polyvinyl alcohol, cellulose, ethyl cellulose, cellulose acetate, polyacrylamide and polyurethane.

It is a mode of embodiments of the present invention to provide the composition of matter wherein the target cell is a prokaryotic cell or a eukaryotic cell, such as a bacterial cell, a fungal cell or a yeast cell. It is a mode of embodiments of the present invention to provide the composition of matter wherein the target cell is a bacterial cell

It is a mode of embodiments of the present invention wherein the non-target cells are chosen from the group consisting of (a) mammalian cells, (b) plant cells, and (c) any combination of the above.

It is a mode of embodiments of the present invention to provide the target cell is a bacterium.

It is a mode of embodiments of the present invention to provide the biocide composition having an H⁺ concentration of greater than about 3.2×10⁻⁵ M or less than about 10⁻⁸ M.

It is a mode of embodiments of the present invention wherein the ion exchange material has a volumetric buffering capacity of at least about 50 mM H⁺/(L.pH unit).

It is a mode of embodiments of the present invention to provide the composition of matter wherein the ion exchange material has a volumetric buffering capacity of at least about 100 mM H⁺/(L.pH unit).

It is a mode of embodiments of the present invention to provide the composition of matter wherein the ion exchange material comprises one or more functional groups selected from the group consisting of sulfonic acid, phosphonic acid, quaternary amine, tertiary amine, hydroxyl, and derivatives thereof.

The aforementioned composition of matter is provided wherein the ion exchange material comprises one or more functional groups selected from the group consisting of carboxylic acid and derivatives thereof, phosphinic acid and derivatives thereof, phenol and derivatives thereof, arsonic acid and derivatives thereof, selenic acid and derivatives thereof, secondary amine and derivatives thereof, and primary amine and derivatives thereof.

The aforementioned composition of matter is provided wherein the ion exchange material comprises at least one substance selected from the group consisting of sulfonated tetrafluoroethylene copolymer and derivatives of sulfonated tetrafluoroethylene.

The aforementioned composition of matter is provided wherein the ion exchange material is selected from the group consisting of polyacrylamide-immobilines, agarose-immobilines, poly(diethylaminoethyl acrylate), cationic polyurethane, cationic sub micron silica, and ion exchange beads.

The aforementioned composition of matter is provided wherein the ion exchange material is adapted to kill living target cells without inserting any of its structure into an outer cell membrane of the cell and/or without creating a covalent bond with the outer membrane of the cell.

The aforementioned composition of matter is provided wherein the barrier layer is adapted to prevent ions larger than H⁺ and OH⁻ from neutralizing the ion exchange material.

The aforementioned composition of matter is provided wherein the wherein the cell is chosen from the group consisting of prokaryotic cells (e.g., bacterial cells) and eukaryotic cells. The aforementioned composition of matter is provided wherein the wherein the cell is chosen from the group consisting of bacterial cells, fungal cells, and yeast cells.

The aforementioned composition of matter is provided wherein the cell is a bacterial cell.

The aforementioned composition of matter is provided wherein the ion exchange material kills cells without inserting any of its structure into the outer membrane of the cells and/or without creating a covalent bond with the outer membrane of the cells.

Reference is now made to methods of generating a change in a cellular process of a target eukaryotic cell of a multicellular organism, the methods comprising contacting the target cell with an ion exchange material so as to alter an intracellular pH value in at least a portion of the target cell, thereby generating the change in a cellular process of a target cell of a multicellular organism.

Reference is now made to methods of generating a change in a cellular process of a eukaryotic cell, the methods comprising contacting the cell with an ion exchange material so as to alter an intracellular pH value in at least a portion of the cell, thereby generating the change in a cellular process of a cell.

Reference is now made to the aforemention methods wherein the eukaryotic cell is a yeast cell.

Reference is now made to the aforementioned methods wherein the contacting is effected in vivo.

Reference is now made to the aforementioned methods wherein the contacting is effected ex vivo.

Reference is now made to the aforementioned methods wherein the contacting is effected in vitro.

Reference is now made to the aforementioned methods wherein generating the change results in death of the cell.

Reference is now made to the aforementioned methods wherein the ion exchange material comprises an anionic ion exchange material incorporated in a water permeable polymer matrix.

Reference is now made to the aforementioned methods wherein the ion exchange material comprises a cationic ion exchange material incorporated in a water permeable polymer matrix.

Reference is now made to the aforementioned methods wherein the ion exchange material comprises a polymer.

Reference is now made to the aforementioned methods wherein the ion exchange material comprises an ionomer.

Reference is now made to the aforementioned methods wherein the ion exchange material comprises a sulfonated tetrafluoroethylene copolymer or derivative thereof.

Reference is now made to the aforementioned methods wherein the ion exchange material comprises an intrinsically ion conducting matrix.

Reference is now made to the aforementioned methods wherein the ion exchange material is attached to an affinity moiety.

Reference is now made to the aforementioned methods wherein the ion exchange material is at least partially covered by a selective barrier.

Reference is now made to the aforementioned methods wherein the ion exchange material comprises a volumetric buffering capacity greater than about 20 mM H⁺/ml/pH.

Reference is now made to the aforementioned methods wherein the ion exchange material comprises a pH greater than pH 8.

Reference is now made to the aforementioned methods wherein the ion exchange material comprises a pH less than pH 4.5.

Reference is now made to the aforementioned methods wherein the ion exchange material is attached to at least part of a surface of a support.

Reference is now made to the aforementioned methods wherein the ion exchange material comprises a buffering layer and a water permeable layer disposed on an external surface of the buffering layer.

Reference is now made to the aforementioned methods wherein the water permeable layer is an open pore polymer.

Reference is now made to methods of treating a medical condition associated with a pathological cell population, the methods comprising administering into a subject in need thereof a therapeutically effective amount of an ion exchange material so as to alter at least a portion of an intracellular pH value of the pathological cell population, thereby treating the medical condition associated with the pathological cell population.

Reference is now made to the aforementioned method further comprising the additional step of administering a therapeutically effective amount of the ion exchange material to a subject suffering from a medical condition characterized by a pathological cell population, wherein the methods provides a treatment for the medical condition.

Reference is now made to the aforementioned method wherein the ion exchange material is internalized by the cell.

Reference is now made to a pharmaceutical composition comprising as active ingredient an ion exchange material and a pharmaceutically acceptable carrier or diluent.

Reference is now made to the pharmaceutical composition wherein the ion exchange material is formulated in particles.

Reference is now made to an article of manufacture comprising (i) a support; and (ii) an ion exchange material layer being attached to at least part of a surface of the support, the ion exchange material comprises a buffering layer and an ion permeable layer being disposed on an external surface of the buffering layer.

Reference is now made to an article of manufacture comprising (i) a support; and (ii) an ion exchange material layer being attached to at least part of a surface of the support, the ion exchange material being anionic.

As mentioned hereinabove, the ion exchange materials of embodiments of the present invention may be formulated for generating a change in a particular cellular process. Typically, three properties of the ion exchange material may be manipulated so as to allow the ion exchange material to affect a cellular process -pH, buffer capacity, and ion conductivity.

The following is an example of how an ion exchange material may be selected in order to affect (e.g. increase) the process of cell death:

1. The pH of the ion exchange material should be out of range of the viability of the cell. The range is specific for each type of cell and bacterium. Typically, a pH of less than 4 or greater than 8 of the ion exchange material will affect the pH stability of the cell.

It will be appreciated that the biocide composition may be formulated so that it comprises a pH gradient. The gradient may be useful in providing a gradual change in the biological effect of the ion exchange material on the cells. For example, using such gradients on ion exchange materials may result in part of the ion exchange material having cytostatic effects on cells while other regions of the ion exchange material having cytotoxic effects.

It will be appreciated by those skilled in the art that variations in the form, strength, position and overall pattern of such gradients may be effected by suitably controlling ion exchange materials incorporated in the matrix of the biocide composition, all of which are contemplated to be included within the scope of embodiments of the present invention. Gradient buffers may be synthesized using IMMOBILINE™ as described in the Examples section hereinbelow.

Furthermore, it will be appreciated that the ion exchange material of embodiments of the present invention may also comprise a combination of cationic ion exchange materials and anionic ion exchange materials arranged in a pattern suitable for effective killing. Thus the ion exchange material may for example comprise a mixture of anionic and cationic beads. The beads may be of the same size or different size depending on the positioning of the target cells.

2. Since the generally accepted values for buffer capacity of the cytosol and most other cellular components is between 20-100 mM H⁺/liter.pH, therefore to cause titration of the cytosol, the buffer capacity of the ion exchange material should be higher than this value. A typical buffering capacity of the ion exchange material that may be used to kill most cell types is about 100 mM H+/liter.pH or higher. 3. A change in the ion conductivity (proton conductivity) of an ion exchange material will affect the speed with which the ion exchange material is able to kill a cell. Typically, the ion mobility in a water permeable ion exchange material will be determined by the diffusional movement of protons in water and will be of the order of about 10⁻⁸ m²/sec for the diffusion constant, this corresponding to a drift velocity of 0.1 mm/sec. Such ion exchange materials will induce cell death in a cell in contact in a matter of seconds.

Thus, an exemplary method for killing a cell is by contacting the cell with an ion exchange material comprising a buffer capacity of about 50 mM H+/liter.pH and a pH capable of titrating the cell, thereby inducing cell death, the pH being generally greater than pH 8, or less than pH 4.5.

Methods of measuring pH and determining buffering capacity are well known in the art.

It will be appreciated the plasma buffering capacity of cells and pH is cell-type specific and therefore manipulation of these parameters may allow targeting to a particular cell type. For example, it is generally accepted that tumor cells are more alkaline than normal cells and thus in order to exert an optimal cytotoxic activity in tumor cells, the ion exchange material may have less (or no) effect on other cell types. In addition, each cell type has a particular membrane permeability and therefore may inherently be more (or less) susceptible to the ion exchange materials of embodiments of the present invention.

As a further example, it is known that the buffer capacity of bacteria is higher than in mammalian cells but the vulnerability of bacteria to titration by buffers is higher since the mass of the buffering medium in bacteria is about three orders of magnitude smaller than in mammalian cells. This makes possible to use low buffer capacity ion exchange materials to kill bacteria without killing mammalian cells

One method of altering the pH and buffering capacity of biocide compositions is by changing the concentration of an ion exchange material in a water soluble (ion permeable) matrix. Alternatively, the concentration of the ion exchange material may remain constant and the ion exchange material may be altered. An optimal ion exchange material and/or biocide composition may be selected for killing a cell of interest by testing a plurality of ion exchange materials and/or biocide compositions comprising differing pHs and buffering capacities on a mixture of cells including the cell of interest. The cell of interest may then be analyzed to determine the optimal biocide composition and/or ion exchange material. Methods of analyzing the cell of interest may include microscopy, immunohistochemistry or other biological assaying techniques known in the art.

In one aspect, biocompatible and highly effective zeolite biocides are provided. Those zeolite biocides are substantially free of zinc and silver cations or salts thereof. The biocidic zeolites of one preferred embodiment of the invention are in the “H⁺ form,” wherein substantially all cations outside of the zeolite framework have been exchanged by protons. According to another preferred embodiment of the invention, the biocidic zeolites are in the “OH⁻ form,” wherein substantially all anions outside of the zeolite framework have been exchanged by hydroxide anions. In a most preferred embodiments of the invention, the zeolite biocide comprises a mixture of domains, each of the domains being in a form chosen from the group consisting of H⁺ form and OH⁻ form. Such a form is referred to herein as being a “mixed H⁺/OH⁻ form.” In this embodiment, the ratio of H⁺ form to OH⁻ form domains (and hence the pH of the material) may be set to any predetermined value, including neutral pH.

Zeolite is a crystalline mineral substance with a structure characterized by a framework of linked tetrahedra, each consisting of four O atoms surrounding a cation. This framework contains open cavities in the form of channels and cages. These are usually occupied by H₂O molecules and extra-framework cations that are exchangeable by protons, hydroxide ions, or mixtures thereof. In preferred embodiments of the invention, the zeolites used are those in which channels within the zeolite structure are large enough to allow the passage of guest species. In preferred embodiments of the invention, the channels within the zeolite must have a minimum width greater than that of 6-membered rings (i.e., rings consisting of six tetrahedra) in order to allow zeolitic behavior at normal temperatures and pressures. The zeolite forms with properties most appropriate to the present invention include, but are not limited to, mordenite, clinoptilite, and acidic zeolites prepared by means well-known in the art from β-zeolite, ZSM-23, ZSM-5, zeolite A, and zeolite Y. In preferred embodiments of the invention, the zeolite used is chosen from these forms.

The zeolite framework of the zeolites used in the present invention may be interrupted by (OH, F) groups; these occupy a tetrahedron apex that is not shared with adjacent tetrahedra.

In preferred embodiments of the invention, the channels within the zeolites used are large enough to allow the passage of guest species. Dehydration of hydrated phases of the biocidic zeolites disclosed herein is achieved by heating; generally, heating to a temperature below about 400° C. is sufficient. Dehydration of the biocidic zeolites disclosed herein is largely reversible.

It is also well within the scope of the invention wherein the term zeolites refers to the aforethe crystalline substance and further wherein a relatively easy exchange of extra-framework cations at relatively low temperature is a characteristic feature of zeolites and zeolitic behavior, but varies greatly from species to species. Its extent does not provide a convenient basis for the definition of zeolites.

In various alternative embodiments of the invention, the H⁺ form, OH⁻ form, and mixed H⁺/OH⁻ form zeolites are selected, in a non-limiting manner, from among the following (the zeolites are listed by their both trivial (academic) and commercial names): analcidite=analcime; analcite=analcime; analzim=analcime; andreasbergolite=harmotome; andreolite, andréolithe=harmotome; antiëdrite=edingtonite; apoanalcite=natrolite; arduinite=mordenite; aricite=gismondine; ashtonite=strontian mordenite; bagotite=thomsonite; barium-heulandite=barian heulandite (unless Ba is the most abundant cation); barytkreuzstein=harmotome; beaumontite=heulandite; bergmannite=natrolite; blatterzeolith=heulandite, stilbite; brevicite=natrolite; cabasite=chabazite; caporcianite=laumontite; carphostilbite=thomsonite; chabasie, chabasite=chabazite; christianite (of des Cloizeaux)=phillipsite; cluthalite=analcime; comptonite=thomsonite; crocalite=natrolite; cubicite, cubizit=analcime; cubic zeolite=analcime?, chabazite; cuboite=analcime; cuboizite=chabazite; desmine=stilbite; diagonite=brewsterite; dollanite=analcime; doranite=analcime with thomsonite, natrolite, and Mg-rich clay minerals; echellite=natrolite; efflorescing zeolite=laumontite; eisennatrolith=natrolite with other mineral inclusions; ellagite=a ferriferous natrolite or scolecite; epidesmine=stellerite; epinatrolite=natrolite; ercinite=harmotome; eudnophite=analcime; euthalite, euthallite=analcime; euzeolith=heulandite; falkenstenite=probably plagioclase (Raade 1996); fargite=natrolite; faroelite=thomsonite; fassaite (of Dolomieu)=probably stilbite; feugasite=faujasite; flokite, flockit=mordenite; foliated zeolite=heulandite, stilbite; foresite=stilbite +cookeite; galactite=natrolite; gibsonite=thomsonite; ginzburgite (of Voloshin et al.)=roggianite; gismondite=gismondine; glottalite=chabazite; granatite=leucite; grenatite (of Daubenton)=leucite; groddeckite=gmelinite?; hairzeolite (group name)=natrolite, thomsonite, mordenite; harmotomite=harmotome; harringtonite=thomsonite, mesolite mixture; haydenite=chabazite; hegauit (hogauite)=natrolite; hercynite (of Zappe)=harmotome; herschelite=chabazite-Na; hogauite=natrolite; hsiang-hua-shih=hsianghualite; hydrocastorite=stilbite, mica, petalite mixture; hydrolite (of Leman)=gmelinite; hydronatrolite=natrolite; hydronephelite=a mixture, probably containing natrolite; hypodesmine=stilbite; hypostilbite=stilbite or laumontite; idrocastorite (hydrocastorite)=stilbite, mica, petalite mixture; kali-harmotome, kalkharmotome=phillipsite; kalithomsonite=ashcroftine (not a zeolite); kalkkreuzstein=phillipsite; karphostilbite=thomsonite; kehoeite=a mixture including quartz, sphalerite, gypsum, and ?woodhouseite; koodilite=thomsonite; krokalith=natrolite; kubizit=analcime; kuboite=analcime; laubanite=natrolite; laumonite=laumontite; ledererite, lederite (of Jackson)=gmelinite; lehuntite=natrolite; leonhardite=H2O-poor laumontite; leuzit=leucite; levyine, levynite, levyite=levyne; lime-harmotome=phillipsite; lime-soda mesotype=mesolite; lincolnine, lincoInite=heulandite; lintonite=thomsonite; lomonite=laumontite; marburgite=phillipsite; mesole=thomsonite; mesoline=levyne? chabazite?; mesolitine=thomsonite; mesotype=natrolite, mesolite, scolecite; metachabazite=partially dehydrated chabazite; metadesmine=partially dehydrated stilbite; metaepistilbite=partially dehydrated epistilbite; metaheulandite=partially dehydrated heulandite; metalaumontite=partially dehydrated laumontite; metaleonhardite=dehydrated “leonhardite” (laumontite); metaleucite=leucite; metamesolite=mesolite; metanatrolite=partially dehydrated natrolite; metascolecite, metaskolecit, metaskolezit=partially; dehydrated scolecite; metathomsonite=partially; dehydrated thomsonite; monophane=epistilbite; mooraboolite=natrolite; morvenite=harmotome; natrochabazite=gmelinite; natron-chabasit, natronchabazit (of Naumann)=gmelinite; natronite (in part)=natrolite; needle zeolite, needle stone=natrolite, mesolite, scolecite; normalin=phillipsite; orizite, oryzite=epistilbite; ozarkite=thomsonite; parastilbite=epistilbite; phacolite, phakolit(e)=chabazite; picranalcime=analcime; picrothomsonite=thomsonite; pollux=pollucite; poonahlite, poonalite=mesolite; portite=natrolite; potassium clinoptilolite=clinoptilolite-K; pseudolaumontite=pseudomorphs after laumontite; pseudomesolite=mesolite; pseudonatrolite=mordenite; pseudophillipsite=phillipsite; ptilolite=mordenite; puflerite, pufflerite=stilbite; punahlite=mesolite; radiolite (of Esmark)=natrolite; ranite=gonnardite (Mason 1957); reissite (of Fritsch)=epistilbite; retzite=stilbite?, laumontite?; sarcolite (of Vauquelin)=gmelinite; sasbachite, saspachite=phillipsite?; savite=natrolite; schabasit=chabazite; schneiderite=laumontite; schorl blanc=leucite; scolesite, scolezit=scolecite; scoulerite=thomsonite; seebachite=chabazite; skolezit=scolecite; sloanite=laumontite?; snaiderite (schneiderite)=laumontite; soda-chabazite=gmelinite; soda mesotype=natrolite; sodium dachiardite=dachiardite-Na; sommaite=leucite; spangite=phillipsite; sphaerodesmine, sphaerostilbite=thomsonite; spreustein=natrolite (mostly); staurobaryte=harmotome; steeleite, steelit=mordenite; stellerycie=stellerite; stilbite anamorphique=heulandite; stilbite (of many German authors)=heulandite; strontium-heulandite=strontian heulandite and heulandite-Sr; svetlozarite=dachiardite-Ca; syanhualite, syankhualite=hsianghualite; syhadrite, syhedrite=impure stilbite?; tetraedingtonite=edingtonite; tonsonite=thomsonite; triploclase, triploklase=thomsonite; vanadio-laumontite=vanadian laumontite; verrucite=mesolite; Vesuvian garnet=leucite; Vesuvian (of Kirwan)=leucite; viséite=disordered crandallite and other phases; weissian=scolecite; wellsite=barian; phillipsite-Ca and calcian harmotome; white garnet=leucite; winchellite=thomsonite; Würfelzeolith=analcime, chabazite; zeagonite=gismondine, phillipsite; zeolite mimetica=dachiardite; and zeolithe efflorescente=laumontite.

In one aspect, methods are provided where the methods comprise disposing a biocidic zeolite about at least part of the interior of the surface containing the volume in which the microbial population is to be controlled. Non-limiting examples of methods for performing this step include disposing the zeolite on the surface or a part thereof, incorporating the zeolite into a polymer matrix and attaching the matrix to the interior surface, incorporating a zeolite/polymer matrix into the surface itself (e.g. the wall of the container is constructed at least in part of the zeolite/polymer matrix), incorporating the zeolite or zeolite/polymer matrix into or onto an insert that is then placed in the predetermined volume, etc.

The microorganisms are then exposed to the biocidic zeolite. In general, “exposure” consists of the microorganism closely approaching the surface of zeolite, at which point the microorganism is killed by interaction with the charged surface of the zeolite. In typical embodiments, exposure consists of the microorganism approaching to within about 50 nm of the surface. In preferred embodiments, exposure consists of the microorganism approaching to within about 10 nm of the surface. This step may be performed by allowing the natural motions of the microorganisms to carry them into proximity of the surface. Alternatively, in order to lessen the time needed to expose a significant fraction of the microbial population to the zeolite, it is possible to speed up the time necessary to achieve the desired level of control of the microbial population by physical manipulation of the container enclosing volume (by shaking, inverting, etc.) or of the material within the volume (e.g. by stirring), thus increasing the likelihood that a microorganism within any given sub-volume will be brought sufficiently near to the biocidic zeolite to be affected by it.

Since the activity of the zeolite does not depend on its liberating antimicrobial substances (e.g. Ag⁺) into the volume, nor does it depend on an interaction between a cell and a substance found within the zeolite or bound to its surface (e.g. charged substituents bound to the surface that can disrupt a cellular membrane upon insertion), the exposure can consist of indirect contact. That is, as long as the cell approaches the charged surface of the zeolite to within a certain necessary distance (typically on the order of tens of nm), the zeolite will act to kill the cell. Thus, in some embodiments of the invention, rather than exposing the microorganisms to the zeolite directly, the zeolite is immobilized in a polymer matrix such that at least a portion of the zeolite is within this distance of the surface of the matrix. A microorganism that approaches the surface of the matrix will thus experience the charged surface of the zeolite and is thus killed by this indirect exposure. Non-limiting examples of microorganisms that can be treated in this manner include Saccharomyces cerevisiae, Zygosacchacomycesrouxii, Byssochalamysfulva, Aspergillusniger, E. coli, Klebsiella pneumonia, Talaromycesflavus, Lactobacillus lactis, Bacillus subtilis, and Aspergillusochraceus.

In some preferred embodiments of the invention, the biocidic zeolites disposed about the surface are in the “acid form,” in which at least some of the cations outside the zeolite framework have been exchanged by protons. “Acid form” zeolites include such naturally-occurring zeolites as mordenite. Acid form zeolites are also readily commercially available, and means for preparing them (e.g. by ion exchange of Na⁺ in Na⁺-form zeolites with NH₄⁺ followed by heating to drive off NH₃) are well-known in the art. In preferred embodiments in which the biocidic zeolite is in the acid form, the H⁺ concentration within the zeolite is outside the range of viability of most pathogenic microorganisms. In more preferred embodiments in which the biocidic zeolite is in acid form, the H⁺ concentration within the zeolite is at least about 2.5×10⁻⁴ mol L⁻¹ (pH≦˜3.6); in yet more preferred embodiments in which the biocidic zeolite is in acid form, the H⁺ concentration is at least about 10⁻³ mol L⁻¹ (pH≦˜3). In the most preferred embodiments in which the biocidic zeolite is in the acid form, the H⁺ concentration is equal to or greater than about 1 meq/g.

In other preferred embodiments of the invention, the biocidic zeolites are in the “base form,” in which the zeolite is a Lewis base. Base form zeolites are also readily commercially available. Means for preparing base form zeolites are also well-known in the art, e.g. via reaction of a zeolite with a Lewis base that acts to remove surface-bound protons (i.e. protons bound to the oxygen atom of a surface Si—O—Si linkage). In preferred embodiments, the base form zeolites are prepared by reaction with an alkali or alkaline earth hydroxide, and typically comprise Cs⁺-substituted zeolites. Reaction with other Lewis bases such as alkali or alkaline-earth oxides, hypochlorite, etc., can also be used to produce base-form zeolites. In the most preferred embodiments that include base-form zeolites, the H⁺ concentration is less than about 10⁻⁸ mol L⁻¹ (pH≧˜8), i.e. outside the range of viability of most pathogenic microorganisms.

In other preferred embodiments of the invention, the biocidic zeolite disposed about the interior surface enclosing the predetermined volume has a mixture of domains, each of the domains being in a form chosen from the group consisting of acid form and base form. Such a form is referred to herein as being a “mixed acid/base form.” In these embodiments, the ratio of acid form to base form domains (and hence the pH of the material) may be set to any predetermined value, including neutral pH.

In preferred embodiments of the invention, it comprises a zeolite that is in the acid form, a zeolite that is in the base form, or a mixture of acid form and base form domains. In most preferred embodiments, the surface charge density is at least 1×10⁻¹⁰ C/cm², which is sufficient to produce a surface electric field gradient strong enough to kill a microorganism that approaches sufficiently closely (typically to within about 50 nm; in preferred embodiments, to within about 10 nm) to the surface.

Acid form zeolites are generally produced by ion exchange between cations located within the pores of the zeolite and H. In preferred embodiments of the invention, the acid-form zeolites are produced from zeolites that have a Si/Al ratio of between 3 and 50. In most preferred embodiments, the Si/Al ratio is between 5 and 20. In some embodiments of the invention, the biocidic zeolite comprises a mixture of acid-form and base-form domains. By appropriate preparation of the domains and of the proper mixing ratio between them, a biocidic zeolite of any desired pH can be prepared. This specially prepared biocidic zeolite can be chosen to be effective against a particular microorganism of interest, as shown in the examples given below.

The method herein disclosed uses biocidic zeolites to control the population of microorganisms within a given volume. In some embodiments, rather than eliminating the microorganisms entirely, the zeolites prevent the population from increasing above a predetermined amount, e.g. the population of microorganisms present in the volume prior to contact with the biocidic zeolite. That is, in these embodiments, the rate of killing of microorganisms is in a predetermined ratio to the rate of reproduction of the microorganisms. In some embodiments, controlling the population of microorganisms comprises preventing its increase from its initial value (i.e. the material is bacteriostatic). The population regulation is essentially a balance between the rate of reproduction of the microorganisms and the rate at which they are killed by contact with the biocidic material. The rate of killing of the microorganisms can be regulated by the amount of surface upon which the biocidic material is disposed, the specific material chosen, the H⁺ concentration in the biocidic material, etc.

In preferred embodiments of the invention, the step of exposing microorganisms to the biocidic zeolite kills those microorganisms exposed. If the rate of exposure is greater than the rate of reproduction, the population of microorganisms will thus decrease with time. In some embodiments of the invention, the step of exposing the microorganisms to the zeolite is performed until a 2-log decrease in the population of microorganisms is observed. In some embodiments of the invention, the step of exposing the microorganisms to the zeolite is performed until a 5-log decrease in the population of microorganisms is observed. In some preferred embodiments of the invention, the step of exposing the microorganisms to the zeolite is performed until the population of microorganisms is observed to have been eliminated entirely. In some embodiments, the volume may be exposed to the external environment, and the step of exposing microorganisms to the biocidic zeolite will thus include exposure to the zeolite of microorganisms introduced into the predetermined volume from the external environment. In these embodiments, the net observed effect of the method disclosed herein will be to control or prevent entirely the growth of the microbial population following exposure to, and contamination from, the external environment.

In another embodiment of the invention, the biocidic zeolite is at least partially enclosed in a polymer matrix such that the contact with the microorganism of interest is only indirect. The enclosure of the zeolite within the polymer matrix may be performed by any method known in the art. Non-limiting examples of such methods include doping, gluing, coating, immersing, ionically bonding, covalently bonding, and co-extruding. Any technique known in the art may be used. Non-limiting examples of polymers suitable for use in these embodiments include ethylene vinyl acetate (EVA); low density polyethylene (LDPE); polypropylene (PP); cellulose; cellulose derivatives; polyalkanoates; polyethylene terephthalate (PET); polyvinyl alcohol; ethylene vinyl alcohol; polyethylene glycol; acrylics; polyesters; polyamides; polyacrylates; polycarbonates; other thermoplastic polymers; and copolymers and blends of any of the above. In these embodiments, the surface charge on surface of the biocidic material (i.e. the material that comprises both a zeolite and a polymer) is produced substantially entirely by the zeolite.

In another embodiment of the invention, the step of disposing the zeolite about at least a part of the interior of the surface enclosing the predetermined volume further includes disposing an ionomer about at least a part of the interior of the surface enclosing the predetermined volume. As ionomers comprise charged monomers, they too have a surface charge that imparts to them biocidic properties. Thus, exposing the microorganisms to at least one ionomeric species in addition to the zeolite further allows fine-tuning of the population control, e.g. by preparing a biocidic material with a predetermined desired H⁺ concentration and/or surface charge density. This fine-tuning can enable, for example, design of a system that provides biocidic activity against specifically chosen microorganisms. Non-limiting examples of ionomers that can be used in the present invention include polyvinyl alcohol, polystyrenesulfonic acid, sulfonated tetrafluoroethylene copolymer, derivatives of sulfonated tetrafluoroethylene, polyacrylamide-immobilines, agarose-immobilines, cationic polyurethane, poly(diethylaminoethyl acrylate), ion exchange beads, and any polymer containing at least one functional group chosen from the group consisting of sulfonic acid, phosphonic acid, quaternary amine, tertiary amine, hydroxyl, and derivatives thereof.

In some embodiments of the invention, the zeolite/polymer material is provided in contact with a second, not necessarily biocidic, polymer layer. Non-limiting examples of polymers appropriate for production of this second layer include EVA, LDPE, and PET. This second layer is primarily used to support the biocidic zeolite/polymer layer, and in practice will be placed external to the biocidic layer relative to the volume being treated by the method. In preferred embodiments, the two layers are produced by coextrusion, but any method known in the art may be used.

Similarly, in some embodiments of the invention, the biocidic zeolite or zeolite/polymer material is disposed onto a not necessarily biocidic substrate. Non-limiting examples of suitable substrate materials include cardboard, wood, plastic, metal, and glass. In preferred embodiments, the zeolite or zeolite/polymer material is disposed on the substrate by a method chosen from the group consisting of doping, gluing, spraying, coating, immersing, and co-extruding. Any method known in the art for disposing the biocidic material on the substrate may be used. The primary purpose of the substrate is structural; that is, the predetermined volume is actually contained by the substrate. In some embodiments of the invention, disposing the biocidic material on the substrate provides a means for fixing the total amount of biocidic material used in a particular volume.

It is well-known that many pathogenic microorganisms produce foul-smelling gases and vapors (e.g. mercaptans) as by-products of their metabolism or as by-products of chemical breakdown of the substances on which the microorganisms feed. Likewise, as is well-known, the large internal surface area of zeolites makes them excellent high-capacity absorbents for gases and vapors. Thus, in some embodiments of the present invention, the absorbent properties of the zeolites are used in addition to their biocidic properties by including a step in which at least some products of microbial metabolism are adsorbed or absorbed by the zeolite. Upon contact with a volume in which the microorganisms are enclosed, the foul-smelling products either diffuse (in embodiments in which there is no mass fluid flow) or are carried with a mass fluid flow (in embodiments in which there is such a flow) to the zeolite, in which they are entrapped.

In some embodiments of the invention, the step of exposing the microorganisms to the biocidic zeolite comprises a step of indirectly exposing the microorganisms within the volume to the biocidic zeolite. Such embodiments are produced, for example, in cases in which the zeolite is enclosed in a polymer, or in which a layer of material is placed between the zeolite or biocidic material and the volume in which the microorganisms are found. A non-limiting example of such an embodiment would be the placement of a membrane or other ion-selective barrier through which only selected ions (e.g. H⁺ or OH⁻) can pass between the biocidic material and the volume in which the microorganisms are found.

In some embodiments, the material is chosen to kill one or more specific species of microorganisms. These embodiments are created by careful regulation of the relevant properties of the biocidic material, such as the H⁺ concentration, the surface charge density, the pore size, etc.

In one aspect, an insoluble PSS in the form of a polymer, zeolite, ceramic, gel, resin or metal oxide is disclosed. The PSS is carrying strongly acidic or strongly basic functional groups (or both) adjusted to a pH of about <4.5 or about >8.0. It is in the scope of the invention, wherein the insoluble PSS is an ion exchange material.

It is also in the scope of the invention wherein material's composition is provided such that the groups are accessible to water whether they are on the surface or in the interior of the PSS. Contacting a living cell (e.g., bacteria, fungi, animal or plant cell) with the PSS kills the cell in a time period and with an effectiveness depending on the pH of the PSS, the mass of PSS contacting the cell, the specific functional group(s) carried by the PSS, and the cell type. The cell is killed by a titration process where the PSS causes a pH change within the cell. The cell is often effectively killed before membrane disruption or cell lysis occurs. The PSS kills cells without directly contacting the cells if contact is made through a coating or membrane which is permeable to water, H+ and OH− ions, but not other ions or molecules. Such a coating also serves to prevent changing the pH of the PSS or of the solution surrounding the target cell by diffusion of counterions to the PSS's functional groups. It is acknowledged in those respect that prior art discloses cell killing by strongly cationic (basic) molecules or polymers where killing probably occurs by membrane disruption and requires contact with the strongly cationic material or insertion of at least part of the material into the outer cell membrane.

It is also in the scope of the invention wherein an insoluble polymer, ceramic, gel, resin or metal oxide carrying strongly acid (e.g. sulfonic acid or phosphoric acid) or strongly basic (e.g. quaternary or tertiary amines) functional groups (or both) of a pH of about <4.5 or about >8.0 is disclosed. The functional groups throughout the PSS are accessible to water, with a volumetric buffering capacity of about 20 to about 100 mM H⁺/l/pH unit, which gives a neutral pH when placed in unbuffered water (e.g., about 5 <pH>about 7.5) but which kills living cells upon contact.

It is also in the scope of the invention wherein the insoluble polymer, ceramic, gel, resin or metal oxide as defined above is coated with a barrier layer permeable to water, H⁺ and OH⁻ ions, but not to larger ions or molecules, which kills living cells upon contact with the barrier layer.

It is also in the scope of the invention wherein the insoluble polymer, ceramic, gel, resin or metal oxide as defined above is provided useful for killing living cells by inducing a pH change in the cells upon contact.

It is also in the scope of the invention wherein the insoluble polymer, ceramic, gel, resin or metal oxide as defined above is provided useful for killing living cells without necessarily inserting any of its structure into or binding to the cell membrane.

It is also in the scope of the invention wherein the insoluble polymer, ceramic, gel, resin or metal oxide as defined above is provided useful for killing living cells without necessarily prior disruption of the cell membrane and lysis.

It is also in the scope of the invention wherein the insoluble polymer, ceramic, gel, resin or metal oxide as defined above is provided useful for causing a change of about <0.2 pH units of a physiological solution or body fluid surrounding a living cell while killing the living cell upon contact.

It is also in the scope of the invention wherein the insoluble polymer, ceramic, gel, resin or metal oxide as defined above is provided in the form of shapes, a coating, a film, sheets, beads, particles, microparticles or nanoparticles, fibers, threads, powders and a suspension of these particles.

Since the present invention contemplates using ion exchange materials to treat medical conditions (e.g. one associated with a pathological cell population), the ion exchange material is typically administered to the body, either in vivo or ex vivo, and it is therefore particularly important that the ion exchange materials are able to selectively target specific cell types.

Thus, according to an embodiment of this aspect of embodiments of the present invention, the ion exchange material may be attached to an affinity moiety, such as an antibody, a receptor ligand or a carbohydrate. Examples of antibodies which may be used according to this aspect of embodiments of the present invention include but are not limited to tumor antibodies, anti CD20 antibodies and anti-IL 2R alpha antibodies. Exemplary receptors include, but are not limited to folate receptors and EGF receptors. An exemplary carbohydrate which may be used according to this aspect of embodiments of the present invention is lectin.

The affinity moiety may be covalently or non-covalently linked to or adsorbed onto to the ion exchange material using any linking or binding method and/or any suitable chemical linker known in the art. The exact type and chemical nature of such cross-linkers and cross linking methods is preferably adapted to the type of affinity group used and the nature of the ion exchange material. Methods for binding or adsorbing or linking such affinity labels and groups are also well known in the art.

In accordance with one preferred embodiment of the present invention, the target cells may be metastasized cancer cells expressing identifiable surface markers. If the pH and buffer capacity of the ion exchange material are selected to kill such cells upon contact, the affinity moieties may be one or more antibodies directed against specific markers expressed by such malignant cells.

Another method of targeting specific cell types (e.g. targeting prokaryotic cells and not eukaryotic cells) contemplated by the present inventors is based on selectively preventing the physical contact between the ion exchange material and particular cell types. Thus, according to another embodiment of this aspect of the present invention, the ion exchange material is at least partially covered by a selective barrier. For example, if the surface of the ion exchange material is covered or protected with a mechanical barrier having a controlled pore size (such as but not limited to a filter e.g. nylon filter, having a selected pore size, or a mesh with a selected opening size, or the like), it is possible to exclude cells above a certain size from attaching to or forming contact with the ion exchange material, while still allowing cells having a smaller size to enter the pores or to pass the mechanical barrier and to make contact with the ion exchange material.

Targeting the ion exchange materials of embodiments of the present invention can also be achieved by using “passive” targeting. This exploits the enhanced permeability of and retention of particles in tumor tissue due to leaky vasculature and lack of lymphatic drainage. It is known in the art that the selectivity for tumor for particles of size 200-600 nanometer is between 10 to 100 fold relative to healthy tissue. This particular type of passive targeting may make use of particles which are not functionalized by recognition groups or moieties.

The ion exchange material of embodiments of the present invention can be administered to an organism per se, or in a pharmaceutical composition where it is mixed with suitable carriers or excipients.

As used herein, a “pharmaceutical composition” refers to a preparation of one or more of the active ingredients described herein with other chemical components such as physiologically suitable carriers and excipients. The purpose of a pharmaceutical composition is to facilitate administration of a compound to an organism.

As used herein, the term “active ingredient” refers to the ion exchange material accountable for the intended biological effect.

Hereinafter, the phrases “physiologically acceptable carrier” and “pharmaceutically acceptable carrier,” which may be used interchangeably, refer to a carrier or a diluent that does not cause significant irritation to an organism and does not abrogate the biological activity and properties of the administered compound. An adjuvant is included under these phrases.

Herein, the term “excipient” refers to an inert substance added to a pharmaceutical composition to further facilitate administration of an active ingredient. Examples, without limitation, of excipients include calcium carbonate, calcium phosphate, various sugars and types of starch, cellulose derivatives, gelatin, vegetable oils, and polyethylene glycols.

Techniques for formulation and administration of drugs may be found in the latest edition of “Remington's Pharmaceutical Sciences,” Mack Publishing Co., Easton, Pa., which is herein fully incorporated by reference.

The ion exchange material of embodiments of the present invention may be formulated as particles or beads and may be manufactured in mean sizes within the range of several nanometers to few millimeters and larger.

The ion exchange material may be attached on the particle surface or encapsulated within the particles. It will be appreciated that if the ion exchange material is held within the particle, the encapsulating particle must be made of an ion conducting material to allow the flow of ions between the ion exchange material and the cell. Exemplary particles include, but are not limited to polymeric particles, microcapsules liposomes, microspheres, microemulsions, nanoparticles, nanocapsules and nanospheres.

The ion exchange materials of embodiments of the present invention may also be coated by biodegradable coatings in order to improve selectivity and prevent activity while in circulation. Exemplary biodegradable coatings include Polyethylenimine (PEI) coatings, polyethylene glycol (PEG) coatings modified gelatin coating or any other suitable coating material.

Suitable routes of administration may, for example, include oral, rectal, transmucosal, especially transnasal, intestinal, or parenteral delivery, including intramuscular, subcutaneous, and intramedullary injections, as well as intrathecal, direct intraventricular, intravenous, inrtaperitoneal, intranasal, or intraocular injections.

Alternately, one may administer the pharmaceutical composition in a local rather than systemic manner, for example, via injection of the pharmaceutical composition directly into a tissue region of a patient.

Pharmaceutical compositions of embodiments of the present invention may be manufactured by processes well known in the art, e.g., by means of conventional mixing, dissolving, granulating, dragee-making, levigating, emulsifying, encapsulating, entrapping, or lyophilizing processes.

Pharmaceutical compositions for use in accordance with the present invention thus may be formulated in conventional manner using one or more physiologically acceptable carriers comprising excipients and auxiliaries, which facilitate processing of the active ingredients into preparations that can be used pharmaceutically. Proper formulation is dependent upon the route of administration chosen.

For injection, the active ingredients of the pharmaceutical composition may be formulated in aqueous solutions, preferably in physiologically compatible buffers such as Hank's solution, Ringer's solution, or physiological salt buffer. For transmucosal administration, penetrants appropriate to the barrier to be permeated are used in the formulation. Such penetrants are generally known in the art.

For topical administration, the ion exchange material of embodiments of the present invention may be formulated as a gel, a cream, a wash, a rinse or a spray. This may be applied when the ion exchange material is administered topically to a subject or onto any solid surface.

For oral administration, the pharmaceutical composition can be formulated readily by combining the active compounds with pharmaceutically acceptable carriers well known in the art. Such carriers enable the pharmaceutical composition to be formulated as tablets, pills, dragees, capsules, liquids, gels, syrups, slurries, suspensions, and the like, for oral ingestion by a patient. Pharmacological preparations for oral use can be made using a solid excipient, optionally grinding the resulting mixture, and processing the mixture of granules, after adding suitable auxiliaries as desired, to obtain tablets or dragee cores. Suitable excipients are, in particular, fillers such as sugars, including lactose, sucrose, mannitol, or sorbitol; cellulose preparations such as, for example, maize starch, wheat starch, rice starch, potato starch, gelatin, gum tragacanth, methyl cellulose, hydroxypropylmethyl-cellulose, and sodium carbomethylcellulose; and/or physiologically acceptable polymers such as polyvinylpyrrolidone (PVP). If desired, disintegrating agents, such as cross-linked polyvinyl pyrrolidone, agar, or alginic acid or a salt thereof, such as sodium alginate, may be added.

Dragee cores are provided with suitable coatings. For this purpose, concentrated sugar solutions may be used which may optionally contain gum arabic, talc, polyvinyl pyrrolidone, carbopol gel, polyethylene glycol, titanium dioxide, lacquer solutions, and suitable organic solvents or solvent mixtures. Dyestuffs or pigments may be added to the tablets or dragee coatings for identification or to characterize different combinations of active compound doses.

Pharmaceutical compositions that can be used orally include push-fit capsules made of gelatin, as well as soft, sealed capsules made of gelatin and a plasticizer, such as glycerol or sorbitol. The push-fit capsules may contain the active ingredients in admixture with filler such as lactose, binders such as starches, lubricants such as talc or magnesium stearate, and, optionally, stabilizers. In soft capsules, the active ingredients may be dissolved or suspended in suitable liquids, such as fatty oils, liquid paraffin, or liquid polyethylene glycols. In addition, stabilizers may be added. All formulations for oral administration should be in dosages suitable for the chosen route of administration.

For buccal administration, the compositions may take the form of tablets or lozenges formulated in conventional manner.

For administration by nasal inhalation, the active ingredients for use according to the present invention are conveniently delivered in the form of an aerosol spray presentation from a pressurized pack or a nebulizer with the use of a suitable propellant, e.g., dichlorodifluoromethane, trichlorofluoromethane, dichloro-tetrafluoroethane, or carbon dioxide. In the case of a pressurized aerosol, the dosage may be determined by providing a valve to deliver a metered amount. Capsules and cartridges of, for example, gelatin for use in a dispenser may be formulated containing a powder mix of the compound and a suitable powder base, such as lactose or starch.

The pharmaceutical composition described herein may be formulated for parenteral administration, e.g., by bolus injection or continuous infusion. Formulations for injection may be presented in unit dosage form, e.g., in ampoules or in multidose containers with, optionally, an added preservative. The compositions may be suspensions, solutions, or emulsions in oily or aqueous vehicles, and may contain formulatory agents such as suspending, stabilizing, and/or dispersing agents.

Pharmaceutical compositions for parenteral administration include aqueous solutions of the active preparation in water-soluble form. Additionally, suspensions of the active ingredients may be prepared as appropriate oily or water-based injection suspensions. Suitable lipophilic solvents or vehicles include fatty oils such as sesame oil, or synthetic fatty acid esters such as ethyl oleate, triglycerides, or liposomes. Aqueous injection suspensions may contain substances that increase the viscosity of the suspension, such as sodium carboxymethyl cellulose, sorbitol, or dextran. Optionally, the suspension may also contain suitable stabilizers or agents that increase the solubility of the active ingredients, to allow for the preparation of highly concentrated solutions.

The pharmaceutical composition of embodiments of the present invention may also be formulated in rectal compositions such as suppositories or retention enemas, using, for example, conventional suppository bases such as cocoa butter or other glycerides.

Pharmaceutical compositions suitable for use in the context of embodiments of the present invention include compositions wherein the active ingredients are contained in an amount effective to achieve the intended purpose. More specifically, a “therapeutically effective amount” means an amount of active ingredients (e.g., a nucleic acid construct) effective to prevent, alleviate, or ameliorate symptoms of a disorder (e.g., ischemia) or prolong the survival of the subject being treated.

Determination of a therapeutically effective amount is well within the capability of those skilled in the art, especially in light of the detailed disclosure provided herein.

For any preparation used in the methods of embodiments of the invention, the dosage or the therapeutically effective amount can be estimated initially from in vitro and cell culture assays. For example, a dose can be formulated in animal models to achieve a desired concentration or titer. Such information can be used to more accurately determine useful doses in humans.

Toxicity and therapeutic efficacy of the active ingredients described herein can be determined by standard pharmaceutical procedures in vitro, in cell cultures or experimental animals. The data obtained from these in vitro and cell culture assays and animal studies can be used in formulating a range of dosage for use in human. The dosage may vary depending upon the dosage form employed and the route of administration utilized. The exact formulation, route of administration, and dosage can be chosen by the individual physician in view of the patient's condition. (See, e.g., Fingl, E. et al. (1975), “The Pharmacological Basis of Therapeutics,” Ch. 1, p. 1.)

Dosage amount and administration intervals may be adjusted individually to provide sufficient plasma or brain levels of the active ingredient to induce or suppress the biological effect (i.e., minimally effective concentration, MEC). The MEC will vary for each preparation, but can be estimated from in vitro data. Dosages necessary to achieve the MEC will depend on individual characteristics and route of administration. Detection assays can be used to determine plasma concentrations.

Depending on the severity and responsiveness of the condition to be treated, dosing can be of a single or a plurality of administrations, with course of treatment lasting from several days to several weeks, or until cure is effected or diminution of the disease state is achieved.

The amount of a composition to be administered will, of course, be dependent on the subject being treated, the severity of the affliction, the manner of administration, the judgment of the prescribing physician, etc.

Compositions of embodiments of the present invention may, if desired, be presented in a pack or dispenser device, such as an FDA-approved kit, which may contain one or more unit dosage forms containing the active ingredient. The pack may, for example, comprise metal or plastic foil, such as a blister pack. The pack or dispenser device may be accompanied by instructions for administration. The pack or dispenser device may also be accompanied by a notice in a form prescribed by a governmental agency regulating the manufacture, use, or sale of pharmaceuticals, which notice is reflective of approval by the agency of the form of the compositions for human or veterinary administration. Such notice, for example, may include labeling approved by the U.S. Food and Drug Administration for prescription drugs or of an approved product insert. Compositions comprising a preparation of the invention formulated in a pharmaceutically acceptable carrier may also be prepared, placed in an appropriate container, and labeled for treatment of an indicated condition, as further detailed above.

It will be appreciated that the present invention also contemplates coating a solid surface or material with the ion exchange material of embodiments of the present invention. The term “surface” as used herein refers to any surface of any material, including glass, plastics, metals, polymers, and like. It can include surfaces constructed out of more than one material, including coated surfaces.

The ion exchange material may be attached to a surface using any method known in the art including spraying, wetting, immersing, dipping, painting, ultrasonic welding, welding, bonding or adhering or otherwise providing a surface with the ion exchange material of embodiments of the present invention. The ion exchange materials of embodiments of the present invention may be attached as monolayers or multiple layers.

An exemplary solid surface that may be coated with the ion exchange materials of embodiments of the present invention is an intracorporial or extra-corporial medical device or implant.

An “implant” as used herein refers to any object intended for placement in a human body that is not a living tissue. The implant may be temporary or permanent. Implants include naturally derived objects that have been processed so that their living tissues have been devitalized. As an example, bone grafts can be processed so that their living cells are removed (acellularized), but so that their shape is retained to serve as a template for ingrowth of bone from a host. As another example, naturally occurring coral can be processed to yield hydroxyapatite preparations that can be applied to the body for certain orthopedic and dental therapies. An implant can also be an article comprising artificial components.

Thus, for example, the present invention therefore envisions coating vascular stents with the ion exchange materials of embodiments of the present invention. The ion exchange materials may repel or attract specific type of proteins in cells which may affect the cell cycle of endothelial cells in contact with the surface to reduce or prevent restenosis, or general type of implants coated by the methods of embodiments of the present invention to achieve beneficial effect in the integration of the implant with tissue.

Another possible application of the ion exchange materials of embodiments of the present invention is the coating of surfaces found in the medical and dental environment.

Surfaces found in medical environments include the inner and outer aspects of various instruments and devices, whether disposable or intended for repeated uses. Examples include the entire spectrum of articles adapted for medical use, including scalpels, needles, scissors and other devices used in invasive surgical, therapeutic or diagnostic procedures; blood filters, implantable medical devices, including artificial blood vessels, catheters and other devices for the removal or delivery of fluids to patients, artificial hearts, artificial kidneys, orthopedic pins, plates and implants; catheters and other tubes (including urological and biliary tubes, endotracheal tubes, peripherably insertable central venous catheters, dialysis catheters, long term tunneled central venous catheters peripheral venous catheters, short term central venous catheters, arterial catheters, pulmonary catheters, Swan-Ganz catheters, urinary catheters, peritoneal catheters), urinary devices (including long term urinary devices, tissue bonding urinary devices, artificial urinary sphincters, urinary dilators), shunts (including ventricular or arterio-venous shunts); prostheses (including breast implants, penile prostheses, vascular grafting prostheses, aneurysm repair devices, heart valves, artificial joints, artificial larynxes, otological implants), anastomotic devices, vascular catheter ports, clamps, embolic devices, wound drain tubes, hydrocephalus shunts, pacemakers and implantable defibrillators, and the like. Other examples will be readily apparent to practitioners in these arts.

Surfaces found in the medical environment include also the inner and outer aspects of pieces of medical equipment, medical gear worn or carried by personnel in the health care setting. Such surfaces can include counter tops and fixtures in areas used for medical procedures or for preparing medical apparatus, tubes and canisters used in respiratory treatments, including the administration of oxygen, of solubilized drugs in nebulizers and of anesthetic agents. Also included are those surfaces intended as biological barriers to infectious organisms in medical settings, such as gloves, aprons and faceshields. Commonly used materials for biological barriers may be latex-based or non-latex based. Vinyl is commonly used as a material for non-latex surgical gloves. Other such surfaces can include handles and cables for medical or dental equipment not intended to be sterile. Additionally, such surfaces can include those non-sterile external surfaces of tubes and other apparatus found in areas where blood or body fluids or other hazardous biomaterials are commonly encountered.

Other surfaces related to health include the inner and outer aspects of those articles involved in water purification, water storage and water delivery, and those articles involved in food processing. Thus the present invention envisions coating a solid surface of a food or beverage container to extend the shelf life of its contents.

Surfaces related to health can also include the inner and outer aspects of those household articles involved in providing for nutrition, sanitation or disease prevention. Examples can include food processing equipment for home use, materials for infant care, tampons and toilet bowls.

As illustrated in Example 15, the ion exchange materials of embodiments of the present invention may be used to enhance the antibacterial activity of a wound dressing. Similarly, the ion exchange materials of embodiments of the present invention may be used to enhance the antibacterial activity in sutures, cloth, fabrics and wound ointments.

In accordance other embodiments of the present invention, the solid surface may be a microscopic slide, a culturing hood, a Petri dish or any other suitable type of tissue culture vessel or container known in the art.

All publications and patent documents cited herein are incorporated herein by reference as if each such publication or document was specifically and individually indicated to be incorporated herein by reference. Citation of publications and patent documents is not intended as an admission that any is pertinent prior art, nor does it constitute any admission as to the contents or date of the same. The invention having now been described by way of written description, those of skill in the art will recognize that the invention can be practiced in a variety of embodiments and that the foregoing description and examples below are for purposes of illustration.

### EXAMPLES

Reference is now made to the following examples, which together with the above descriptions, illustrate the invention in a non limiting fashion.

Generally, the nomenclature used herein and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Md. (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells—A Manual of Basic Technique” by Freshney, Wiley-Liss, N.Y. (1994), Third Edition; “Current Protocols in Immunology” Volumes I-III Coligan J. E., ed. (1994); Stites et al. (eds), “Basic and Clinical Immunology” (8th Edition), Appleton & Lange, Norwalk, Conn. (1994); Mishell and Shiigi (eds), “Selected Methods in Cellular Immunology”, W.H. Freeman and Co., New York (1980); available immunoassays are extensively described in the patent and scientific literature, see, for example, U.S. Pat. Nos. 3,791,932; 3,839,153; 3,850,752; 3,850,578; 3,853,987; 3,867,517; 3,879,262; 3,901,654; 3,935,074; 3,984,533; 3,996,345; 4,034,074; 4,098,876; 4,879,219; 5,011,771 and 5,281,521; “Oligonucleotide Synthesis” Gait, M. J., ed. (1984); “Nucleic Acid Hybridization” Hames, B. D., and Higgins S. J., eds. (1985); “Transcription and Translation” Hames, B. D., and Higgins S. J., eds. (1984); “Animal Cell Culture” Freshney, R. I., ed. (1986); “Immobilized Cells and Enzymes” IRL Press, (1986); “A Practical Guide to Molecular Cloning” Perbal, B., (1984) and “Methods in Enzymology” Vol. 1-317, Academic Press; “PCR Protocols: A Guide To Methods And Applications”, Academic Press, San Diego, Calif. (1990); Marshak et al., “Strategies for Protein Purification and Characterization—A Laboratory Course Manual” CSHL Press (1996); all of which are incorporated by reference as if fully set forth herein. Other general references are provided throughout this document. The procedures therein are believed to be well known in the art and are provided for the convenience of the reader. All the information contained therein is incorporated herein by reference.

### Example 1

### Distribution of Proteins in a pH Gradient

The following experiment was carried out in order to ascertain whether proteins comprise specific pH characteristics.

Materials and Methods

Gel preparation: Four immobiline gel strips measuring approximately seven centimeters were used. Each strip was cut from an ampholine containing polyacrylamide based gel having a pH gradient from 4-9 prepared as is known in the art (the gel contained 4% polycacrylamide and 5% bisacrylamide cross linker).

Protein solution preparation: Four different protein solutions were prepared. The first solution contained 1.0 mg/mL myoglobin (commercially available from Sigma, USA—catalogue number M-0630) in DDW. The second solution contained 1.0 mg/mL myoglobin in DDW including a final concentration of 8M Urea for protein denaturation. The third solution contained 1.0 mg/mL phycocyanin (commercially available from Sigma, USA as Catalogue Number P-2172) in DDW. The fourth solution contained 1.0 mg/mL phycocyanin in DDW including a final concentration of 8 M Urea for protein denaturation. All protein solutions had a pH of about 7.0.

Experimental Procedure: Ten ml of each of the above described protein solutions were placed in a Petri dish and a strip of gel was immersed into each one. The Petri dishes were covered and the gels were incubated for 3-5 days at room temperature. At the end of the incubation period, the gel strips were removed from the Petri dishes, carefully blotted from excess liquid and scanned in an Epson flatbed office scanner.

### Results

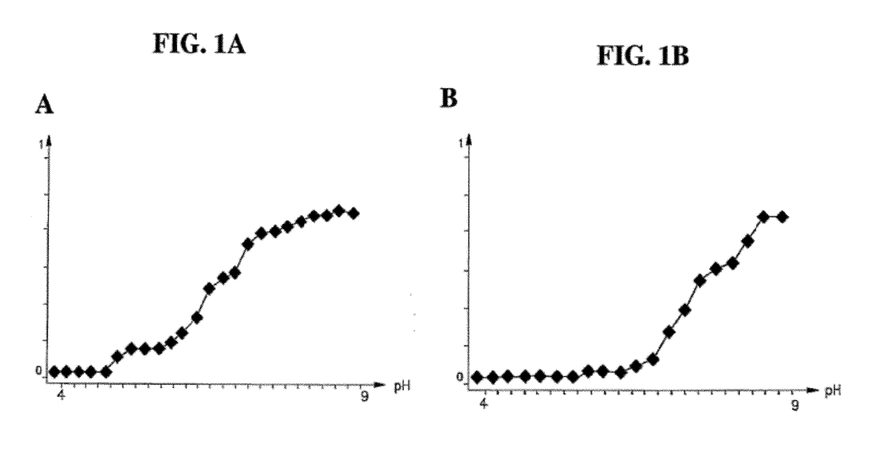

As illustrated in FIGS. 1A-B and 2A-B, the proteins were adsorbed differently into different regions of the gel strips according to the pH at the different regions of the strip.

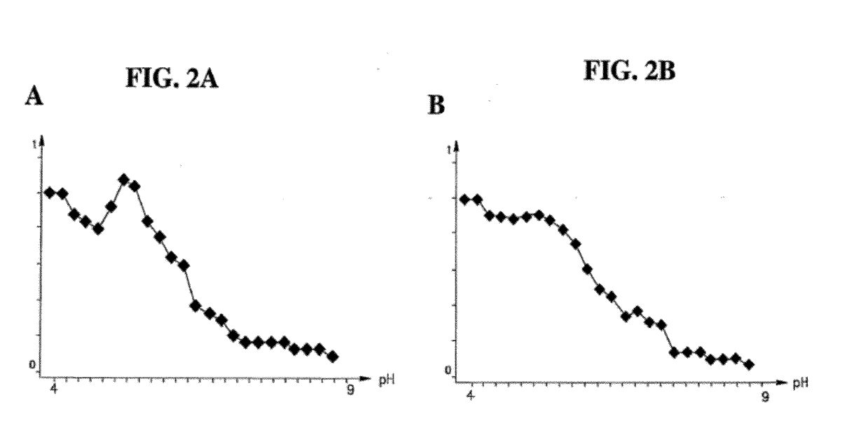

Myoglobin has a pI≈6 and Phycocyanin has a pI≈4.2. While the shift of the spatial (and pH dependent) distribution curve for myoglobin between native and denatured protein is rather small (FIGS. 2A-2B), a very strong shift (difference in spatial distribution of absorbance as a function of pH along the gel strip) is observed for the much larger protein Phycocyanin (FIGS. 1A-1B).

Conclusion

The distribution of a protein in a pH gradient presents a property which is specific for each tested protein and may be presented as a pH characteristic of the protein.

### Example 2

### Redistribution of Proteins Across a Gel Membrane According to their pH Characteristics

Materials and Methods

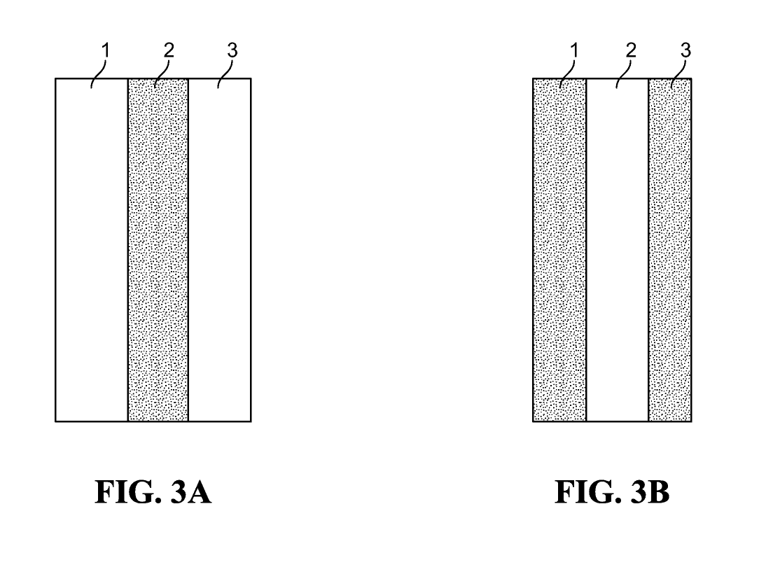

Gel preparation: A rectangular chamber was divided into three compartments by placing two gel membranes, formed as 2 mm thick polyacrylamide-based gel slabs, as illustrated in FIGS. 3A-B. The gels were prepared by addition of 10 μL of Imobiline™ (Amersham), 0.5 μL ammonium persulfate (APS), 0.25 μL TEMED (1:10), 10% polycarylamide and 5% bisacrylamide. One gel membrane was prepared for pH 4 (acidic, Polyacrylamide with Immobilines) and the other gel membrane was prepared for pH 6 (basic, Polyacrylamide with Immobilines).

Protein solution preparation: Myoglobin and Phycocyanin were dissolved in doubly deionized water (DDW) each at a concentration of 0.1 gram/Liter (g/L).

Experimental Procedure: 300 μL of each protein solution was placed into the central chamber bordered by the two membranes. The chamber on the acidic side was filled by a buffer solution of 1 mM of glutamic acid (pH=3.8) and the chamber at the basic side was filled with 1 mM solution of TRIS (pH=8.3). The chamber was left undisturbed at room temperature. After several days, the chamber was visually observed and also photographed (top view) using a digital camera.

### Results

At the beginning of the experiment the solution in the middle compartment 2 of the multi compartment chamber described above has a dark color resulting from the combined absorbance of the myoglobin and phycocyanin present in the middle compartment 2, while there was hardly any color observed in the compartments labeled 1 and 3 which contained the acidic (1 mM of glutamic acid; pH=3.8) buffer and the basic buffer (1 mM solution of TRIS; pH=8.3), respectively, as illustrated in FIG. 3A.

As illustrated in FIG. 3B, by the end of the experiment, the solution in the middle compartment 2 of the multi compartment chamber described above had a much fainter magenta-like color resulting from the combined absorbance of a much lower concentration of myoglobin and phycocyanin left therein. A strong reddish color was observed in the compartment labeled 1 which contained the acidic (1 mM of glutamic acid; pH=3.8) buffer into which a large portion of the myoglobin migrated. A strong bluish color was observed in the compartment labeled 3 which contained the basic buffer (1 mM solution of TRIS; pH=8.3), into which a large portion of the phycocyanin migrated.

Conclusion

An almost complete redistribution and separation of the two colored proteins occurred governed by the different pH values in the compartments separated by the Imobiline™ membranes.

### Example 3

The following experiment was carried out to demonstrate the feasibility of affecting intracellular distribution of a cytoplasmic protein within a living functioning cell.

Materials and Methods

HeLa cells were transfected to express GFP in their cytosol. Following lysis, the extracted proteins were tested to determine the pH region of maximum accumulation of the GFP protein as described in Example 1 above. The region of maximum accumulation of the GFP protein (as determined by locating the peak fluorescence on the scanned gel strip) was found to be at about pH=9.

Commercial polyacrylamide beads having a mean diameter of approximately 50 microns (Biogel P10, Cat. No. 1504140, Biorad, USA) were soaked in a solution of a copolymer of polyacrylamide and immobilines at pH=9 (prepared as detailed in Example 2 hereinabove). The Imobiline™ polyacrylamide solution was allowed to chemically polymerize following which an aqueous suspension of the resulting beads was added to a cell culture of the HeLa cells expressing GFP. Some of the cells attached themselves to the beads. The mixture of cells and beads was then immobilized by casting an agarose solution (Low melt agarose, catalogue Number 1620019 Biorad, USA and having a melting point of about 36° C.) on the cells and the beads, and allowing the agarose to cool to about 25° C. A cell in contact with a bead was observed under a fluorescence microscope (Axioscope 2 Fluorescence Microscope, Zeiss, Germany) and the change of distribution of the GFP was visually and photographically monitored over a period of 30 minutes.

### Results

As may be seen in FIGS. 4A-C, the fluorescence intensity at the point of attachment of the cell to the bead was about fifty times higher 30 minutes following initial attachment than the initial intensity in the cell as measured at time zero. This measured intensity accounts for a major fraction of the GFP in the cell. A similar phenomenon was observed in several cells which were attached to the beads.

Control experiments with similar beads having coating with pH=7 (not shown) did not show any change in the distribution pattern of GFP in cells attached to the beads and similarly observed.

Conclusion

The above experimental observations clearly demonstrate that a localized protein (GFP) accumulation or redistribution mechanism based on pH partitioning may be induced in a living cell and that it is possible to generate a concentration gradient or a localized concentration of an intracellular protein using contact with a material or object which has a controlled pH at it's surface. The experiment also demonstrates that this property can be utilized to cause redistribution of one or more proteins in a living cell.

### Example 4

### Effect of pH on Cytotoxicity of Yeast Cells

This experiment was performed to test the cytoxicity of pH modified surfaces on yeast cells.

Materials and Methods

The bottom of nine plastic Petri dishes were coated with a 0.5 mm thick polyacrylamide gel with immobilines (acrylamido buffers), each gel having a different pH from the preceding gel by about 1 pH unit. The coating of the first dish was a pH 3 acrylamido Imobiline™ buffer gel, the coating of the second dish was a pH 4 acrylamido Imobiline™ buffer gel, the coating of the third dish was a pH 5 acrylamido Imobiline™ buffer gel etc, . . . , and the coating of the ninth dish was a pH 11 acrylamido Imobiline™ buffer gel.

The coating was prepared by standard polymerization methods as is known in art. The composition of imobilines is set forth in Table 1 hereinbelow:

TABLE 1

IMMOBILINE ™ pK
BUFFERS USED (μL)

| pH | 3.6 | 4.6 | 6.2 | 7.0 | 8.5 | 9.3 |
|---|---|---|---|---|---|---|
| 3.00 | 256 | 0 | 4 | 0 | 0 | 0 |
| 4.00 | 276 | 103 | 59 | 0 | 0 | 170 |
| 5.00 | 295 | 200 | 111 | 0 | 0 | 331 |
| 6.00 | 295 | 200 | 111 | 0 | 0 | 331 |
| 7.00 | 130 | 532 | 90 | 188 | 0 | 551 |
| 8.00 | 0 | 605 | 0 | 273 | 147 | 476 |
| 9.00 | 219 | 0 | 212 | 231 | 72 | 284 |
| 10.0 | 0 | 40 | 0 | 1138 | 85 | 237 |
| 11.0 | 0 | 1 | 0 | 1345 | 99 | 335 |

The numbers in table 1 are given as μL of starting material (having a concentration of 100 mM) used to prepare 10 mL of pH solution by addition of DDW.

1-2 Million yeast cells Sacharomices (commercially available baker's yeast), suspended in tissue culture medium (Roswell Park Memorial Tissue Culture Media, RPMI-1640 Dutch Mod. 01-1-7-1) were placed in each of the Petri dishes. The cells sedimented to the bottom of the dish and came in contact with the polyacrylamide surface and were left in the dish for a preset time as indicated Table 2 hereinbelow. Following the indicated contact time, the cells were stained using Trypan Blue and the number of dead cells was estimated for each dish.

### Results

Table 2 below lists the cell mortality data (as % of total cells) at the indicated pH and exposure time.

TABLE 2

| | Time (hours) | | | | | | |
|---|---|---|---|---|---|---|---|
| pH | 0.25 | 0.5 | 1 | 2 | 4 | 6 | 12 |
| 3 | 50 | 100 | 100 | 100 | 100 | 100 | 100 |
| 4 | 25 | 25 | 50 | 55 | 80 | 100 | 100 |
| 5 | 2.5 | 15 | 25 | 45 | 65 | 95 | 975 |
| 6 | 1.5 | 15 | 25 | 35 | 50 | 55 | 60 |
| 7 | 1.5 | 2.5 | 5 | 3 | 1.5 | 5 | 1 |
| 8 | 2.5 | 2.5 | 5 | 3.5 | 1.5 | 4 | 2.5 |
| 9 | 5 | 55 | 45 | 55 | 70 | 80 | 85 |
| 10 | 25 | 50 | 50 | 60 | 85 | 95 | 99 |
| 11 | 50 | 100 | 100 | 100 | 100 | 100 | 100 |
| Control | 1.5 | 2.5 | 3.5 | 2.5 | 1.5 | 4 | 3.5 |
| (Pure PA) | | | | | | | |

As may be seen from Table 2, at extreme pH values (pH 3, pH 4, pH10, and pH 11) the cells die within a relatively short time of contact with the pH controlling substrate. At pH 7 and pH 8, no significant cell toxicity is observed even after a prolonged time. At intermediate pH values (in the range of pH 5-9), a time dependent toxicity is observed.

Conclusion

The only parameter that was changed in the gels was the composition of the acrylamido buffers. Since the gel is very stable under aqueous soaking, no release of any kind of toxic agent into the cell culture media can be envisioned. Therefore, the cell toxicity as observed is most probably due to the redistribution of ions (charged proteins, hydrogen ions, potassium ions, and other intracellular ions) in the cell on contact with the surface of the pH controlling acrylamide gels used in the experiment. This assumption is further supported by the fact that if one compares the compositions and toxicity as observed at pH 3, 4, 5 and 6 the concentration of the highly acidic component is almost constant while the toxicity changes are very significant. The same can be observed on the basic side where the concentration of the most basic component changes only slightly for pH 11, 10, 9 and 8 whereas the toxicity changes significantly.

This observation proves that the toxicity is not the result of incorporation of the highly anionic or cationic species as claimed in prior art but the result of the bulk pH property.

The results of this experiment further demonstrate that the rate of cell mortality (delayed cytotoxicity effect) can be controlled by the choice of the pH value in the pH controlling substance or substrate in contact with the cells, and that such effects (the rate of cell death) can be fine tuned by suitably modifying the pH values of the surface or substrate contacting the cells.

### Example 5

### Effect of pH Induced Cytotoxicity in Jurkat Cells

Materials and Methods

Jurkat cells, Clone E6-1 were grown in RPMI 1640 supplemented with 2 mM L-glutamine, 10 mM HEPES, 10 mM sodium pyruvate and 10% PBS. The cells were exposed to varying pH surfaces as described for yeast cells hereinabove (Example 4).

### Results

Table 3 below lists the cell mortality data (as % of total cells) at the indicated pH and exposure time. The results demonstrate high cell toxicity of the surfaces having low and high pH.

TABLE 3

| | TIME (hours) | | |
|---|---|---|---|
| pH | 1 hour | 2 hours | 3 hours |
| 3 | 15 | 90 | 90 |
| 4 | 8 | 20 | 80 |
| 5 | 11 | 5 | 3 |
| 6 | 0 | 0 | 0 |
| 7 | 0 | 3 | 3 |
| 8 | 5 | 10 | 7 |
| 9 | 9 | 9 | 6 |
| 10 | — | — | — |
| 11 | 3 | 12 | 80 |
| Control, Pure PA | 0 | 0 | 0 |

### Example 6

### Absorption Characteristics of Yellow Fluorescent Protein (YFP)

Materials and Methods

1 μg of H1299 lung cancer cells expressing a yellow fluorescent protein (Source—Phialadium sp. SL-2003) were lysed. The extracted proteins were tested to determine the pH region of maximum accumulation of the YFP on an IPG strip (Amersham Biosciences, Immobiline™ Dry Strip pH 3-10). The strip was immersed in the solution for 22 hours, following which it was scanned with a UV scanner of a Zeiss Axiscope 2 Plus, UV microscope.

### Results

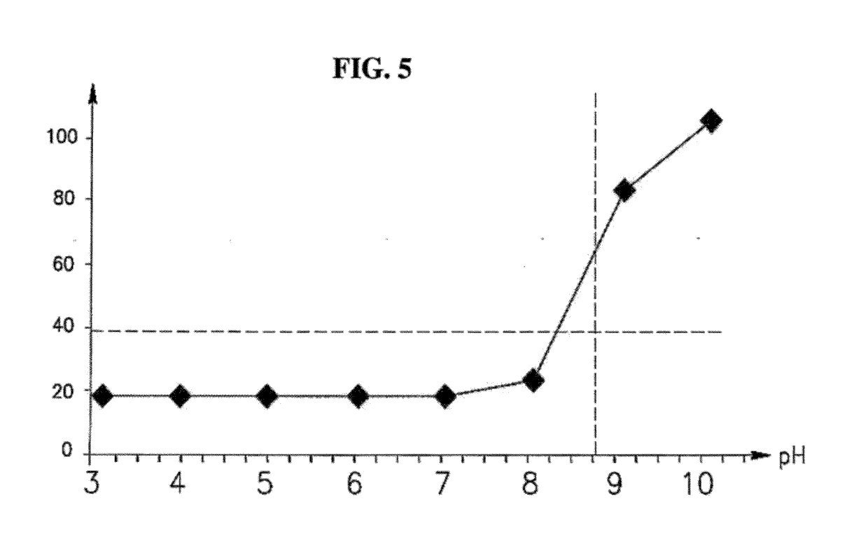

As can be seen in FIG. 5, a pH range of 9.5-10 showed the strongest accumulation of the YFP.

### Example 7

### Physical or Mechanical Barriers Prevent pH Induced Cytotoxicity

The following experiment was designed in order to ascertain whether pH-induced cytotoxicity requires direct contact of the cell with the surface of the pH controlling substrate.

Materials and Methods

A 0.5 mm thick layer of pH 3 immobiline Polyacrylamide gel (IPG) was cast on the bottom of a Petri dish. A 10 μM thick nylon filter with a 2 μM mean pore size (commercially available from Nalgene, USA) was placed in close contact with the surface of the IPG layer.

A suspension of 0.2 million yeast cells in tissue culture medium (Roswell Park Memorial Tissue Culture Media, RPMI-1640 Dutch Mod. 01-1-7-1), was placed in the Petri dish and the cells were left to sediment for six hours. At the end of the six hour sedimentation period, the cells were stained with Tryptan Blue.

### Results

The number of dead cells counted was approximately 5% of the total number of cells counted.

Conclusion

The nylon filter interposed between the cells and the surface of the pH controlling substrate, prevented the pH-induced cytotoxicity.

### Example 8

### Differential Cell Toxicity Device

In order to further establish that direct contact between a cell and the pH controlling substrate is required for pH-induced cytotoxicity, a filter allowing bacteria cells to be in contact with the substrate, while not allowing yeast cells to be in contact with the substrate was used as follows:

Materials and Methods

A 0.5 mm thick layer of pH 3 immobiline Polyacrylamide gel (IPG) was cast on the bottom of a Petri dish. A 10 μm thick nylon filter with a 2 μm mean pore size, as described in Example 6 above, was placed in close contact with the surface of the IPG layer. A mixture of E. Coli (100 units/microliter) and Yeast cells (1 million/ml) suspended in 0.5 mls of cell culture medium was placed in the Petri dish on top of the nylon filter and the dish was incubated for a period of 12 hours at 37° C. Following the incubation period, the culture medium was sampled for bacterial colonies on McConkey Agar. The yeast cells were then stained with Tryptan Blue for performing dead cell count.

### Results

No bacterial colonies were detected and no significant yeast cell mortality was observed.

Conclusion

The results of this experiment demonstrate that bacterial cells which were in contact with the cytotoxic agent were killed, whereas the yeast cells which were not in contact with the cytotoxic agent remained alive. The results of this experiment further demonstrate the bacterio-toxic property of the pH controlling substrate.

### Example 9

### pH Induced Cytotoxicity in Jurkat Cells

In order to establish whether pH-induced cytotoxicity occurs in Jurkat cells, the following experiment was performed.

Materials and Methods

A suspension of Polyacrylamide based beads having an approximate mean bead size of about one micron was prepared from a polyacrylamide+Immobiline™ mixture having a pH of 9.0. The beads were added to one million Jurkat cells suspended in 1 ml of tissue culture medium such that the ratio of beads to cells was approximately 20 beads per Jurkat cell. Aliquots were drawn out at 0.5, 1.0 and 2.0 hours following addition of the beads to the cell suspension. The cells were stained with Tryptan Blue dye and the number of dead cells and total cells was counted.

### Results

At 0.5 hours following bead addition, the fraction of dead cells in the sample was 5%. At 1.0 hour following addition of the beads to the cells, the fraction of dead cells in the sample was 10%. At 2.0 hours following addition of the beads to the cells, the fraction of dead cells in the sample was 27%.

### Example 10

### Cytotoxic Effect of NAFION™

Sulfonated tetrafluorethylene copolymers (e.g. NAFION™) are acidic (anionic charged) bioactive polymers with strong buffering properties and high buffering capacities. These types of films consist of a substrate (e.g. polymethylacrylate, nylon or polyester) and a sulfonated polymer as an active layer. NAFION™ is not recognized as cytotoxic or bactericidal and is generally used as an ion conductive electrode in fuel cell applications. The following toxicity tests were performed to ascertain whether NAFION™ is toxic to cells.

Materials and Methods

1 million Jurkat cells in PBS buffer were deposited on a 1 cm square of a NAFION™ commercial membrane (NAFION™ 117, Perfluorinated membrane, Sigma, 274674-1EA). In order to differentiate between live and dead cells, the membrane was stained with 1 μL of 1 μg/μL of Propidium iodide or trypan Blue.

### Results

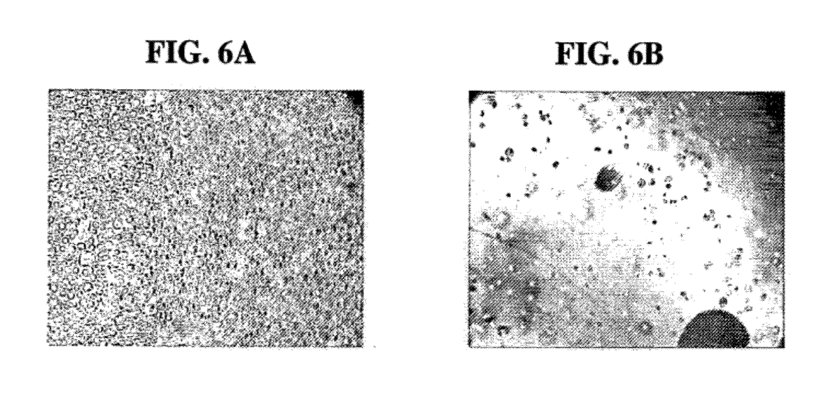

Following a 10 minute exposure to the nafion, more than 95% of cells were dead as seen in FIGS. 6A-B.

### Example 11

### Bacteriotoxicity and Cytotoxicity of Laminates

Materials and Methods

Laminate samples: laminate samples consisted of films coated on a 110 μm polyester base.

Series BIOACT 13, 15 and 16:

BIOACT 16: 110 μm polyester base+a primer layer of acrylic modified polyurethane.

BIOACT 13: 110 μm polyester base+a primer layer of acrylic modified polyurethane+“active” cationic submicron silica in PVOH binder (w/w ratio 4:1); total coating weight of 0.97 g/m², coating pH 4.06.

BIOACT 15: 110 μm polyester base+a primer layer of acrylic modified polyurethane+“active” cationic polyurethane polymer in PVOH binder (w/w ratio 4:1); total coating weight of 0.76 g/m², coating pH 4.

Uncoated sample was provided as control.

Series MVC/HT/56 A, B and C: This set of laminates was based on the incorporation of p-Toluenesulphonic acid salt (pH 3) of poly(diethylaminoethylmethacrylate) as the active component of the coatings.

MVC/HT/56 A: 110 μm polyester base+PVOH+p-Toluenesulphonic acid salt. The total dry coating weight 0.9 gsm (.about.0.9 microns) of which the dry coat weight of the active component is 0.6 gsm.

MVC/HT/56 B: Identical to MVC/HT/56 A, but a different batch.

MVC/HT/56 C: 110 μm polyester base+PVOH+p-Toluenesulphonic acid salt. The total dry coating weight 0.58 gsm (−0.5 microns) of which the dry coat weight of the active component is 0.24 gsm.

MVC/HT/56 D Identical to MVC/HT/56 A, but a different batch.

Preparation of live and dead Bacterial Suspensions: 10 ml of E. coli DH5 were grown to late log phase in LB broth. 1 ml of the culture was concentrated by centrifugation at 5000 rpm for 5 minutes. The pellet was resuspended in 100 μL of 0.85% NaCl. 50 μL of this suspension was added to 950 μL of 0.85% NaCl (for live bacteria) or 850 μL of 70% 2-propanol (for dead bacteria). Both samples were incubated at RT for 1 hour, following which they were pelleted by centrifugation at 5000 rpm for 5 minutes. The obtained pellets were resuspended in 500 μL of 0.85% NaCl and re-centrifuged. Finally, both pellets were resuspended in 50 μL 0.85% NaCl.

Staining of Live and Dead bacterial suspensions: Staining was performed with LIVE/DEAD® BacLight™ Bacterial Viability Kit (Molecular probes). With a mixture of SYTO9 and propidium iodide stains, bacteria with intact cell membranes stain fluorescent green, whereas bacteria with damaged membranes stain fluorescent red. Essentially, 2 μL of SYTO 9 dye, 1.67 mM/Propidium iodide and 1.67 mM Component A was mixed with 2 μL of 1.67 mM/Propidium iodide, 18.3 mM Component B. 0.15 μL of the dye mixture was added to 50 p. 1 of the bacterial suspensions. 2.5 p. 1 of the stained bacteria was trapped between a slide and coverslip. Live and killed cells were observed under a fluorescence microscope.

Antibacterial activity testing of films: Two series of tests were performed using non activated (from the shelf) films and films treated for 20 minutes in a 1M NaCl solution. In both of them the antibacterial activity was estimated by counting under a fluorescent microscope the numbers of dead and live stained bacteria in the sample deposited on the bioactive film.

Cytotoxic activity testing of films: Live and dead Jurkat cells were counted following exposure to the bioactive films by the following procedure: 0.15 μL of the dye mixture was added to 1 million Jurkat cells in 50 μL PBS. 2.5 μL of the stained cells were trapped between an activated film and coverslip. Live and dead cells were observed under a fluorescence microscope.

### Results

Antibacterial activity testing of MVC HT 56A, B, C and D: Following a 30 minute incubation of Jurkat cells with the laminates described hereinabove, live (moving) cells were observed in control, MVC/HT/56/B film and MVC/HT/56/D film, which under a green filter (5-2) were green or reddish. In comparison, after 1 minute of incubation on MVC/HT/56/A and /56C laminates all cells were attached and under a green filter were observed as red.

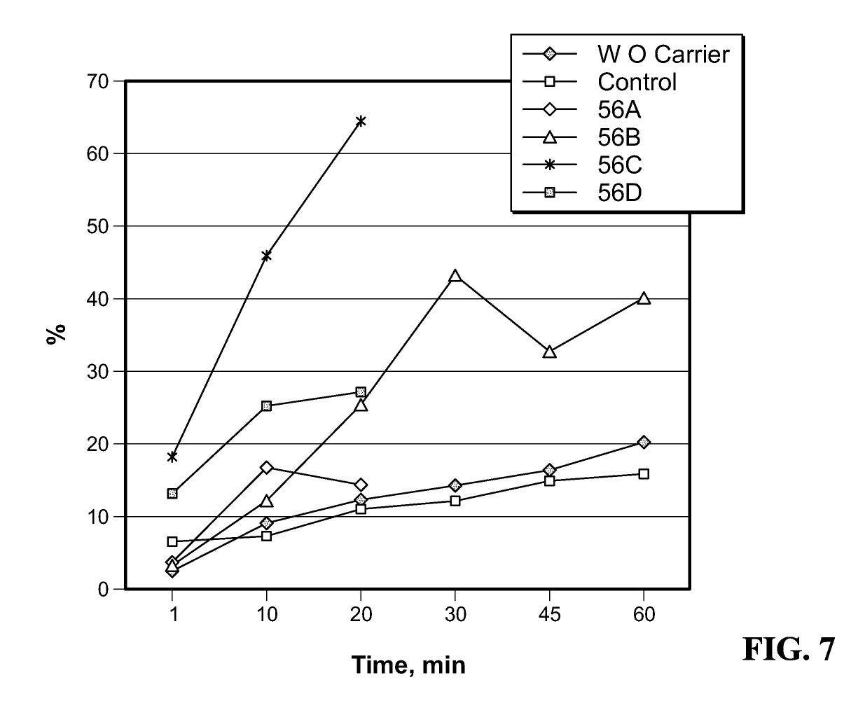

Cytotoxic activity testing of MVC HT 56A, B, C and D: As can be seen from FIG. 7 and Table 4 herein below interaction of Jurkat cells with 56/A and 56/C films differs from 56/B and 56/D.

TABLE 4

Time, min.
% of dead Jurkat cells

| | 1 | 10 | 20 | 30 | 45 | 60 |
|---|---|---|---|---|---|---|
| wo carrier | 2.3 | 8.9 | 12.6 | 14.4 | 16.3 | 20.2 |
| control | 6.3 | 7.1 | 11 | 12 | 15 | 15.7 |
| 56A | 3.2 | 12 | 25.4 | 43.1 | 32.8 | 40 |
| 56B | 3.5 | 17 | 14.4 | | | |
| 56C | 18.5 | 46.1 | 64.6 | | | |
| 56D | 13 | 25.3 | 27 | | | |

Antibacterial activity testing of BIOACT 13, 15 and 16: Following 45 minutes of incubation on BIOACT 13, 50-70% of E. coli cells were dead. At the same time, 20-40% of E. coli were dead following incubation on BIOACT 15. E. coli cells were not attached to BIOACT 16. Following 20-30 minutes of incubation on BIOACT 15, almost all E. coli cells were dead. Evaluation of the attachment of these cells was difficult due to a high background noise level.

Cytotoxic activity testing of BIOACT 13, 15 and 16: The results from 3 separate experiments are illustrated below in Table 5 and are presented as the number of green:red Jurkat cells and percentage of green overall.

TABLE 5

| | | | | | | Ex. 3 |
|---|---|---|---|---|---|---|
| | Ex. 1 | Ex. 2 | Ex. 3 | Ex. 1 | Ex. 2 | (10 |
| | (1 minute) | (1 minute) | (1 minute) | (10 minutes) | (10 minutes) | minutes) |
| wo | 81/13 (13.8) | 288/8 (2.7) | 308/9 (2.8) | 120/20 (14.3) | 300/29 (8.8) | 260/21 (7.5) |
| carrier | | | | | | |
| 13 | 250/15 (5.7) | 400/26 (6.1) | 360/26 (6.7) | 28/14 (33.3) | 80% | 60% |
| 15 | 160/14 (8.1) | 280/12 (4.1) | 280/8 (2.8) | 200/160 (44.4) | 81/5 (6.2) | 160/40 (20) |
| 16 | 120/13 (9.8) | 320/7 (2.1) | 376/29 (7.2) | 144/25 (14.8) | 100/6 (5.7) | 364/30 (7.6) |
| 110 | 100/5 (4.8) | 250/6 (2.3) | 320/13 (3.9) | 23/58 (71.6) | 216/15 (6.5) | 66/28 (29.5) |

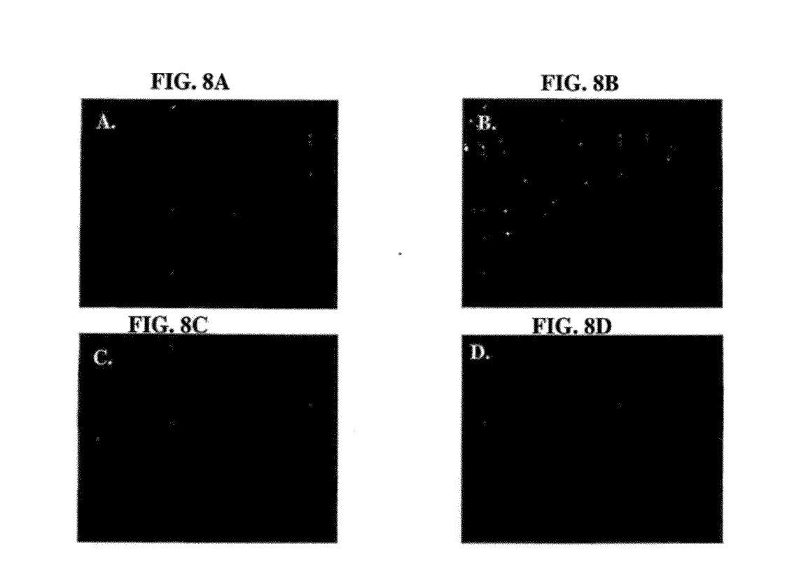

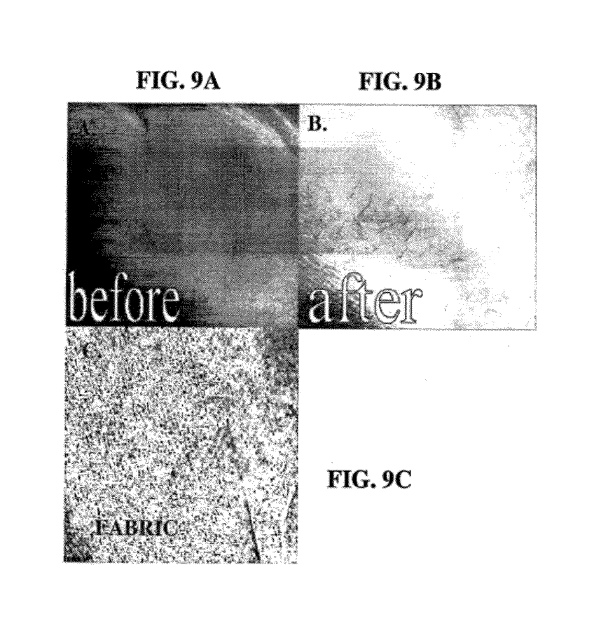

Table 6 hereinbelow summarizes the results from the three experiments as the percentage of red cells. FIGS. 8A-D illustrate a typical experiment following exposure of Jurkat cells to Bioact 13.

TABLE 6

| | 1 minute | 10 minute |
|---|---|---|
| wo carrier | 6.4 | 10.2 |
| 13 | 6.2 | 57.8 |
| 15 | 5 | 23.5 |
| 16 | 6.4 | 9.4 |
| 110 | 3.7 | 35.9 |

Conclusion

Interaction of E. coli cells and Jurkat cells with 56/A and 56/C films differs from 56/B and 56/D. In the BIOACT 13, 15 and 16 series, BIOACT 13 showed the highest cytotoxic and anti-bacterial activity.

### Example 12

### Bactericidal Activity of NAFION™ and Polyacrylamide pH Gels

The following toxicity tests were performed to ascertain whether NAFION™ and other films are toxic to bacteria.

Materials and Methods

Six types of plastic films were tested for bactericidal effects: 1. NAFION™ (commercial, Dupont); 2. NAFION™ (commercial, Dupont); 3. 500 micron thick polyacrylamide with immobilines on polyester base pH 10; 4. Same as 3 at pH 9; 5. Polyuretane film (commercial); 6. 500 micron poyacrylamide on polyester pH 5; Control-polyester film

Testing Staph. Aureus, Staph. Spp, Strept. Beta-hemolitgr.A and Strept. Beta-hemolitgr.G: The viability of these bacteria was tested on blood agar using the “sow” method. Essentially, 0.01 ml of microbial liquid culture was spread on blood agar using a special bacterial loop. Each of the six plastic films (10 mm×10 mm) was placed on the testing plate with active side down. Following overnight incubation at 37° C., the number of colonies was evaluated. The test and control groups were compared.

Testing total microbial and fungal agents: The total anti-microbial and anti-fungal effect of the above films was tested on Saburo agar using the “sedimentation” method. Uncovered plates with Saburo agar were placed for 8 hours in the open. Each of the six plastic films (10 mm×10 mm) was placed on the testing plate with active side down. Following overnight incubation at 37° C., the number of colonies was evaluated. The test and control groups were compared.

### Results

The effects of the sheets of embodiments of the present invention on Staphaureus growth are summarized in Table 7. The effects of the sheets of embodiments of the present invention on Staph. Spp growth are summarized in Table 8. The effects of the sheets of embodiments of the present invention on Strept. Beta-hemolit.gr.A growth are summarized in Table 9. The effects of the sheets of embodiments of the present invention on Strept. Beta-hemolit.gr.G growth are summarized in Table 10. The effects of the sheets of embodiments of the present invention on total microbial and fungi agents are summarized in Table 11.

TABLE 7

| | Staph. Aureus growth | Control |
|---|---|---|
| sheet | (agents/mL) | (agents/mL) |
| 1 | 2 × 10³ | >10⁶ |
| 2 | <10³ | >10⁶ |
| 3 | <10³ | >10⁶ |
| 4 | 4.5 × 10⁴ | >10⁶ |
| 5 | 9.9 × 10⁵ | >10⁶ |
| 6 | 7.36 × 10⁵ | >10⁶ |

TABLE 8

| | Staph. Spp | Control |
|---|---|---|
| sheet | (agents/mL) | (agents/mL) |
| 1 | <10³ | >10⁶ |
| 2 | <10³ | >10⁶ |
| 3 | 9 × 10³ | >10⁶ |
| 4 | 2.7 × 10⁴ | >10⁶ |
| 5 | 4.29 × 10⁵ | >10⁶ |
| 6 | 8.03 × 10⁵ | >10⁶ |

TABLE 9

| | Strept Beta-hemolit. gr. A | Control |
|---|---|---|
| sheet | (agents/mL) | (agents/mL) |
| 1 | 3 × 10³ | >10⁶ |
| 2 | <10³ | >10⁶ |
| 3 | <10³ | >10⁶ |
| 4 | 1.1 × 10⁴ | >10⁶ |
| 5 | 6.71 × 10⁵ | >10⁶ |
| 6 | 8.59 × 10⁵ | >I0⁶ |

TABLE 10

| | Strept Beta-hemolit. gr. G | Control |
|---|---|---|
| sheet | (agents/mL) | (agents/mL) |
| 1 | 2 × 10³ | >10⁶ |
| 2 | 5 × 10³ | >10⁶ |
| 3 | 4 × 10³ | >10⁶ |
| 4 | 2.1 × 10⁴ | >10⁶ |
| 5 | 8.61 × 10⁵ | >10⁶ |
| 6 | 7.8 × 10⁵ | >10⁶ |

TABLE 11

| | Total microbial and fungal agents | Control |
|---|---|---|
| sheet | (colonies) | (colonies) |
| 1 | 3 | 22 |
| 2 | 2 | 18 |
| 3 | 1 | 17 |
| 4 | 9 | 19 |
| 5 | 19 | 21 |
| 6 | 19 | 19 |

Conclusion

Both NAFION™ and sheet no. 3 (the 500 micron thick polyacrylamide with immobilines on polyester base pH 10) showed high antibacterial activities and total antimicrobial and antifungal activities.

### Example 13

### Shelf Life Tests on Milk

The films of embodiments of the present invention were tested for their effect on milk shelf life.

Materials and Methods

Pasteurized, homogenized milk was used in order to test milk stability with the films of embodiments of the present invention. In both sets of experiments the milk was UV treated.

Test 1: Seven empty 35 mm Petri plates were filled to the top with fresh milk. Six plates were covered with the films of embodiments of the present invention, so that their active side contacted the milk w/o air between them. The seventh plate was used as a control. Plates were placed on the table at room temperature for six days. Each day the pH of the plate was tested. In order to compensate for evaporation, sterile DDW was added each day. The total volume of added DDW was less then 5% of the total milk volume and therefore was not expected to influence pH dynamics. This experiment was repeated twice.

Test 2-14 day test with NAFION™: This test was performed with commercial NAFION™ as the active material (layer). Pasteurized, homogenized milk (w/o antibiotics) was used in order to test milk stability. Three empty 35 mm Petri plates were filled with fresh milk up to the top. Two were covered with Nafion, so that active side contacted the milk w/o air between them. The third plate was used as control. Plates were placed on the table at room temperature for fourteen day. Each day pH of the plate was tested. In order to compensate for evaporation, sterile DDW was added each day. The total volume of added DDW was less then 5% of the total milk volume and therefore was not expected to influence pH dynamics.

Testing total microbial and fungal agents: This was tested on Saburo agar using the “sedimentation” method. Uncovered plates with Saburo agar were placed for 8 hours in the open. A piece of NAFION™ (10 mm×10 mm) was placed on the testing plate with active side down. Following overnight incubation at 37° C., the number of colonies was evaluated. Test and control groups were compared.

### Results

The pH results of the milk following test 1 are recorded in Table 12 hereinbelow.

TABLE 12

| | 1 day | 2 day | 3 day | 4 day | 5 day | 6 day |
|---|---|---|---|---|---|---|
| Film I | 7.4 | 7.2 | 6.9 | 6.8 | 6.7 | 6.3 |
| Film 2 | 7.4 | 7.3 | 6.8 | 6.6 | 6.2 | 6.1 |
| Film 3 | 7.4 | 7.3 | 6.9 | 5.9 | 5.4 | 4.9 |
| Film 4 | 7.4 | 7.0 | 6.6 | 6.1 | 5.5 | 4.7 |
| Film S | 7.4 | 6.8 | 6.2 | 5.6 | 4.4 | 3.7 |
| Film 6. | 7.4 | 7.0 | 6.6 | 5.6 | 4.8 | 4.1 |
| Control | 7.4 | 6.9 | 6.1 | 5.4 | 4.1 | 4.0 |

The pH results of the milk (test 1, repeat experiment) are recorded in Table 13 hereinbelow.

TABLE 13

| Day | pH |
|---|---|
| Day 0 | 8.5 |
| Day 1 | 8.7 |
| Day 2 | 8.8 |
| Day 3 | 8.7 |
| Day 4 | 8.5 |
| Day 5 | 8.6 |
| Day 6 | 8.9 |
| Day 7 | 8.5 |
| Day 8 | 8.3 |
| Day 9 | 8.5 |
| Day 10 | 8.7 |
| Day 11 | 8.8 |
| Day 12 | 8.5 |
| Day 13 | 8.5 |
| Day 14 | 8.4 |
| Day 15 | 8.5 |

The pH results of the 14 day test (test 2) are recorded in Table 14 hereinbelow.

TABLE 14

| | 1 day | 2 day | 3 day | 4 day | 5 day | 6 day | 7 day |
|---|---|---|---|---|---|---|---|
| Nafion ™ | 7.5 | 7.4 | 7.3 | 7.1 | 7.1 | 7 | 6.8 |
| 1 | | | | | | | |
| Nafion ™ | 6.8 | 6.6 | 6.6 | 6.7 | 6.6 | 6.5 | 6.5 |
| 2 | | | | | | | |
| Control | 7.4 | 6.7 | 6.2 | 5.1 | 4.2 | 4.1 | 4.1 |
| | 8 day | 9 day | 10 day | 11 day | 12 day | 13 day | 14 day |
| Nafion ™ | 6.8 | 6.6 | 6.6 | 6.1 | 6.6 | 6.5 | 6.5 |
| 1 | | | | | | | |
| Nafion ™ | 4.7 | 4.6 | 4.4 | 4.5 | 4.4 | 4.4 | 4.3 |
| 2 | | | | | | | |
| Control | 4.2 | 4.2 | 4.1 | 4.1 | 4.2 | 4.1 | 4.1 |

The results from testing total microbial and fungal agents are recorded in Table 15 hereinbelow.

TABLE 15

| | Total microbial and fungi agents (colonies) | | |
|---|---|---|---|
| No. | First | Second | Control (colonies) |
| 1 | 2 | 1 | 14 |
| 2 | 2 | 2 | 31 |
| 3 | 3 | 3 | 24 |
| 4 | 0 | 6 | 25 |
| 5 | 4 | 5 | 16 |
| 6 | 0 | 2 | 20 |
| 7 | 2 | 5 | 19 |
| 8 | 3 | 2 | 13 |
| 9 | 2 | 2 | 37 |
| 10 | 1 | 3 | 25 |

### Example 14

### Cytotoxicity Testing of Second Series of Laminates

A second series of polyester base laminates were prepared by thermoplastic lamination methods. The laminates consisted of active anionic components in a PVOH matrix. In some samples the active layer was over-coated with a layer of PVOH.

The compositions and structure of laminates are provided in Table 16 hereinbelow.

TABLE 16

| | Coating Formulation (PVOH + | T | | | |
|---|---|---|---|---|---|
| Coating | Active Component) | (gsm) | Ratio | T₁ (μ) | T₂ (μ) |
| 1 | PVOH + p Toluene sulphonic acid | 0.9 | 3/2 | 18 | 0 |
| | salt of Poly | | | | |
| | (Dimethylamineethylmethacrylate) | | | | |
| 2 | PVOH + p Toluene sulphonic acid | 1.8 | 3/2 | 9 | 0 |
| | salt of Poly | | | | |
| | (Dimethylamineethylmethacrylate) | | | | |
| 3 | PVOH + p Toluene sulphonic acid | 0.9 | 3/2 | 9 | 24 |
| | salt of Poly | | | | |
| | (Dimethylamineethylmethacrylate) | | | | |
| 4 | PVOH + p Toluene sulphonic acid | 0.9 | 3/2 | 9 | 100 |
| | salt of Poly | | | | |
| | (Dimethylamineethylmethacrylate) | | | | |
| 5 | PVOH + p Toluene sulphonic acid | 0.9 | 3/2 | 9 | 0 |
| | salt of Poly | | | | |
| | (Dimethylamineethylmethacrylate) | | | | |
| 6 | PVOH + p Toluene sulphonic acid | 1.8 | 3/2 | 18 | 0 |
| | salt of Poly | | | | |
| | (Dimethylamineethylmethacrylate) | | | | |
| 7 | PVOH + p Toluene sulphonic acid | 0.9 | 3/2 | 9 | 24 |
| | salt of Poly | | | | |
| | (Dimethylamineethylmethacrylate) | | | | |
| 8 | As above + Laponite | 0.58 | 4/1 | 6 | 0 |

(T—total thickness in gram/square meter; R—ratio of the active component and the PVOH binder; T₁—approximate thickness in microns, T₂—thickness in microns of the overlay PVOH layer).

Materials and Methods

Determination of pH: Following wetting of the films in water, pH was determined using pH-Fix 0-14 (Macherey-Nagel).

Cytotoxicity testing: Cytotoxicity tests were performed as described in Examples 12 and 13.

### Results

The pH results are set forth in Table 17 hereinbelow.

TABLE 17

| Film | pH |
|---|---|
| 1. MVC/HT/58/AY | 5.0 |
| 2. MVC/HT/58/AY - pH 5.0 | 5.0 |
| 3. MVC/HT/58/AYTCG - pH 6.0 | 6.0 |
| 4. MVC/HT/58/AYTCG - pH 6.0 | 6.0 |
| 5. MVC/HT/58/BY | <5.0 (4.8) |
| 6. MVC/HT/58/BR | 4.0 |
| 7. MVC/HT/58/BYTCG | <5.0 (4.8) |
| 8. MVC/HT/58/CY | 6.0 |

The cytotoxicity results are set forth in Table 18 hereinbelow. Cytotoxic effect was measured as the % of PI-stained (dead) cells. Following 20 minutes, approximately 80% of cells were green in Control sample (without film).

TABLE 18

| | | Cytotoxic effect, % | | | |
|---|---|---|---|---|---|
| No. | Designation | 1 min. | 2 min. | 10 min. | 20 min. |
| 1 | AY | 95 | ND | 100 | ND |
| 2 | AR | 85 | ND | 100 | ND |
| 3 | AYTCG | 95 | ND | 100 | ND |
| 4 | AYTCB | 50* | 90 | 100 | ND |
| 5 | BY | 90 | ND | 100 | ND |
| 6 | BR | 70* | ND | 100* | ND |
| 7 | BYTCG | 5 | ND | 100* | 100 |
| 8 | CY | 10* | ND | 50* | 50* |

Of note, samples 3, 4 and 7 have a neutral PVOH overcoat and still demonstrated high cytotoxicity.

### Example 15

### Cytotoxic effect of Polyacrylamide Gel (PAAG)-Coated and uncoated Silica Beads on Jurkat cells

Throughout the experimental data section of Examples 15-28, the below terminology and annotation is applicable. Unless otherwise stated, all or part of the below listed materials and compositions (see tables 19 and 20) were used in the following experiments of Examples 15-28. All experiments of Examples 15-28 were repeated at least two or three times.

TABLE 19
Polyacrylamide Gel (PAAG)-Coated and uncoated Silica Beads

| Serial No. | Annotation | pH |
|---|---|---|
| 1 | I | 3 |
| 2 | II | 4 |
| 3 | III | 4.5 |
| 4 | 1A | 6.5 |
| 5 | 2A | 6 |
| 6 | 3A | 6.9 |
| 7 | 4A | 5.1 |
| 8 | 5A | 5.2 |
| 9 | 6A | 5 |
| 10 | 1 | 9.5 |
| 11 | 2 | 9.8 |
| 12 | 3 | 9 |
| 13 | 4 | 10 |
| 14 | 5 | 10.5 |
| 15 | 1a | 3 |
| 16 | 1b | 3.2 |
| 17 | 1c | 3.4 |
| 18 | A | 3 |
| 19 | B | 4 |
| 20 | C | 5 |
| 21 | D | 6 |
| 22 | E | 7 |
| 23 | F | 8 |
| 24 | 1 | 9 |
| 25 | 2 | 9.5 |
| 26 | 3 | 10 |
| 27 | 4 | 10.5 |
| 28 | pH 2 | 2 |
| 29 | pH 3 | 3 |
| 30 | pH 4 | 4 |
| 31 | pH 5 | 5 |
| 32 | pH 6 | 6 |
| 33 | pH 7 | 7 |
| 34 | pH 8 | 8 |
| 35 | pH 9 | 9 |
| 36 | pH 10 | 10 |
| 37 | pH 11 | 11 |
| 48 | 2 | 2 |
| 49 | 3 | 3 |
| 50 | 4 | 4 |
| 51 | 5 | 5 |
| 52 | 6 | 6 |
| 53 | 7 | 7 |
| 54 | 8 | 8 |
| 55 | 8.3 | 8.3 |

TABLE 20
PAAG Beads

| Serial No. | Annotation | pH |
|---|---|---|
| 38 | 2 | 2 |
| 39 | 3 | 3 |
| 40 | 4 | 4 |
| 41 | 5 | 5 |
| 42 | 6 | 6 |
| 43 | 7 | 7 |
| 44 | 8 | 8 |
| 45 | 9 | 9 |
| 46 | 10 | 10 |
| 47 | 11 | 11 |

Materials and Methods

Uncoated Silica beads (˜40 nm size, Sigma, cat.#421553) in suspension and silica beads coated by photpolymerization with polyacrylamide incorporating acidic and basic acrylamido derivatives (immobilines) were stored in refrigerator +4° C. until used.

The acute T-cell leukemia Jurkat cell line, clone E6-1 (ATCC number TIB-152), was used. Jurkat cells were maintained in RPMI-1640 medium supplemented by 1 mmol sodium pyruvate, 10% FBS and penicillin-streptomycin-amphotericin (1:100).

Viability and Microscopic Observation

2 μL of beads (dilute with a 0.1% SDS solution) were added to 10⁶ Jurkat cells in 25 μL of PBS. LIVE/DEAD® Dye (LIVE-DEAD Viability Kit, Molecular Probes) was added (0.15 μL) and incubation was performed at room temperature. Cell morphology and viability was examined using a fluorescent microscope (Axioskop 2 plus; filter 4-3).

### Results

Microscopic observations of Silica-beads-treated Jurkat cells were performed using Molecular Probes' LIVE/DEAD® Viability Kit. This kit utilizes mixture of SYTO9 green-fluorescent nucleic acid stain and the red-fluorescent nucleic acid stain Propidium Iodide (PI). These stains differ both in their spectral characteristics and in the ability to penetrate healthy cells. SYTO9 stain generally labels cells with intact membranes and cells with damaged membranes. In contrast, PI penetrates only cells with damaged membranes, causing a reduction in the SYTO9 stain fluorescence when both dyes are present. Thus cells with damaged membranes stain fluorescent red, whereas cells with intact membranes stain fluorescent green. The fluorescence from both live and dead cells may be viewed simultaneously with standard GREEN or RED filter set.

Jurkat cells were put in contact with the functionalized Silica beads. The Beads/Jurkat-cells ratio was varied from 1:20 to 1:80, corresponding to 3×10⁶ to 0.75×10⁶ particles per one cell, respectively. Percent of dead and live cells for various groups of functionalized Silica Beads was determined by fluorescent microscopy for 7-10 random fields. Uncoated beads were used as control for these experiments.

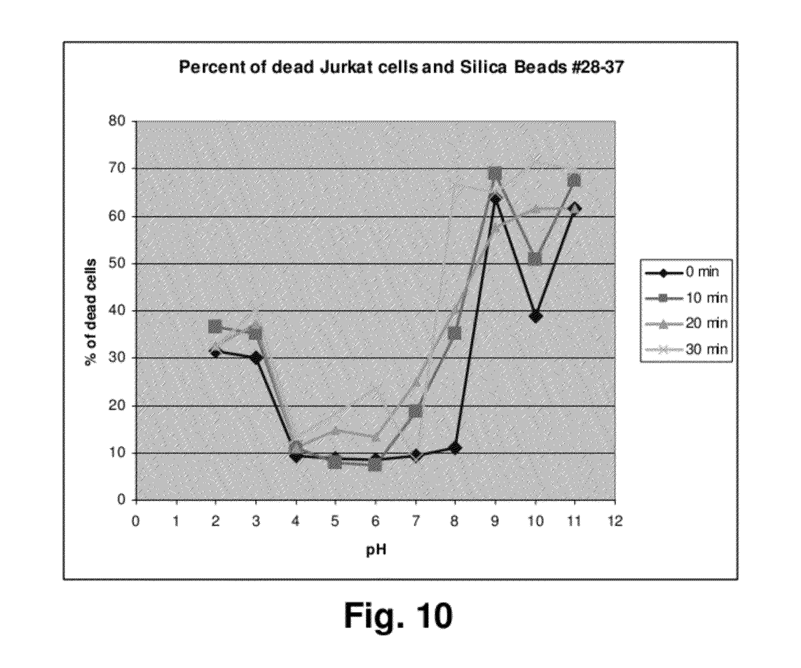

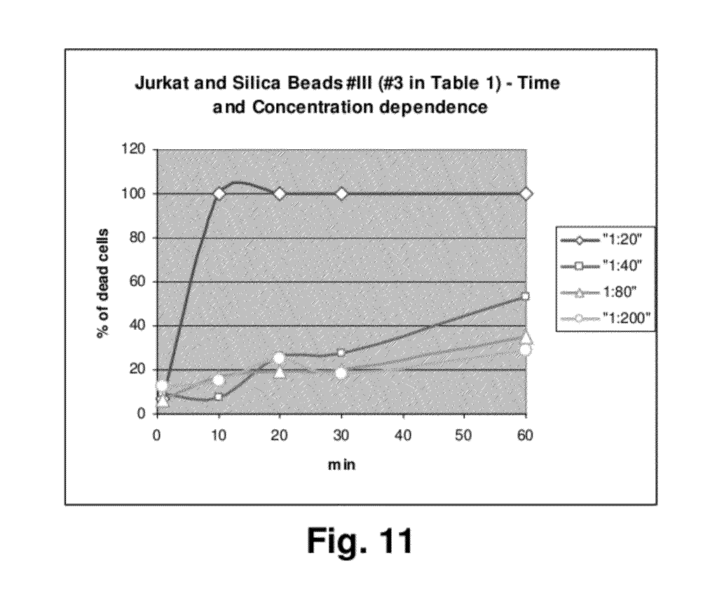

Reference is now made to FIG. 10, illustrating the pH and time dependence of the cytotoxic effect of PAAG-coated silica beads. Similarly, FIG. 11 illustrating the concentration-dependent cytotoxic effect of PAAG-coated silica beads on Jurkat cells.

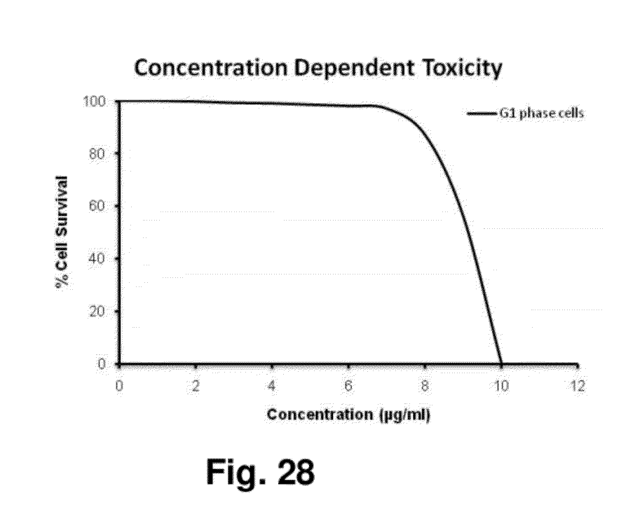

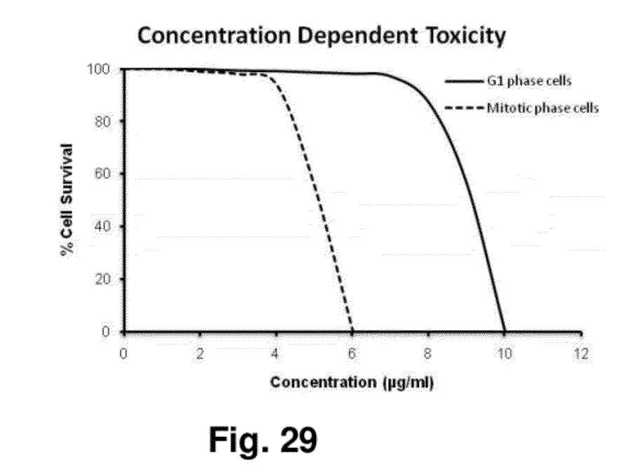

Reference is made to FIG. 28, which shows a concentration dependent toxicity of G1 phase cells; and to FIG. 29, which shows concentration dependent toxicity of G1 phase cells, and mitotic phase cells. FIG. 28 presents that the % cell survival is high up to concentration of about 8 μg/mL. The PSS concentration provides an effective means of differentiation in killing LTCs. FIG. 29 illustrates two types of LTCs, wherein mitotic phase cells are killed at PSS concentration less then 5 μg/mL. In other words, at 5 μg/mL, the selectivity of the PSS towards G1 phase cells is about 2:1. Moreover, FIG. 29 demonstrates the role of PSS in differentiating between LTC and NTC, by providing a critical number of PSS' particles (or applicable surface) with a defined capacity per a given volume.

The Percentage of dead Jurkat cells in each experiment is presented in FIGS. 10 & 11. The data reveal that PAAG-coated-silica beads, carrying both strong positive and strong negative charges, exhibit high cytotoxic properties (FIGS. 10 and 11). This effect was time- and concentration-dependent (FIG. 11). Incubation of Jurkat cells with undiluted silica leads to an immediate lysis of the cells.

Acidic beads (pH 2 to pH 4) have lesser cytotoxic effect in comparison with basic beads. Two types of anionic substituents were assessed: substituents bearing strongly acidic sulfonic groups, which are strong, polarizable under neutral conditions and substituents bearing weakly acidic carboxyl groups for which the degree of dissociation exceeds 98% at pH˜7.

Silica beads bearing weakly acidic carboxylate substituents exhibit no cytotoxic activity compared with those of sulfonic acid substituents.

The Silica Beads bearing slight acidic, neutral and basic properties, pH from 5 to 8, seemed to be non-cytotoxic against Jurkat cells.

### Example 16

### Cytotoxic Effect of PAAG Beads on Jurkat Cells

Materials and Methods

PAAG beads incorporating immobilines (size ˜500 nm) at various pH were prepared by standard emulsification techniques. Stock solutions were stored in refrigerator +4° C. until used.

The acute T-cell leukemia Jurkat cell line, clone E6-1 (ATCC number TIB-152), was used. Jurkat cells were maintained in RPMI-1640 medium supplemented by 1 mmol sodium pyruvate, 10% FBS and penicillin-streptomycin-amphotericin (1:100).

### Viability and Microscopic Observation

2 μL of beads (dilute with a 0.1% SDS solution) were added to 10⁶ Jurkat cells in 25 μL of PBS. LIVE/DEAD® Dye (LIVE-DEAD Viability Kit, Molecular Probes) was added (0.15 μL) and incubation was performed at room temperature. Cell morphology and viability was examined using a fluorescent microscope (Axioskop 2 plus; filter 4-3).

### Results

Microscopic observations of PAAG-beads-treated Jurkat cells were performed using Molecular Probes' LIVE/DEAD® Viability Kit as described above.

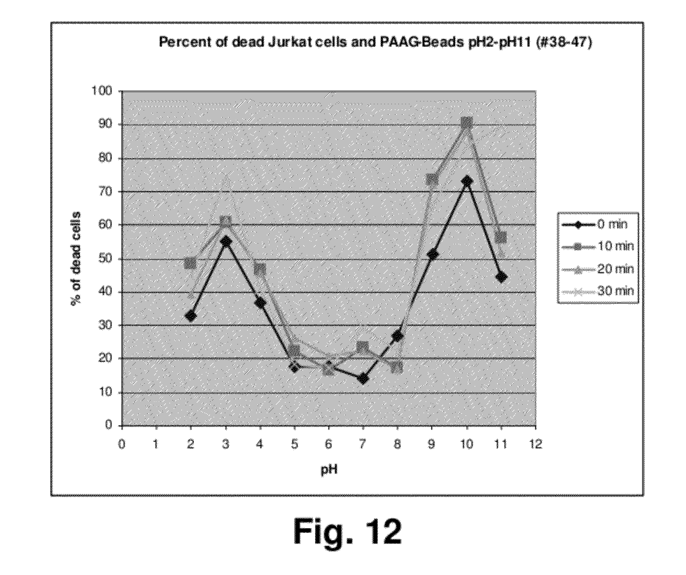

Jurkat cells were put in contact with the PAAG-beads. The Beads/Jurkat-cells ratio was varied from 1:20 to 1:80, corresponding to 3×10⁶ to 0.75×10⁶ particles per one cell, respectively. Percent of dead and live cells for various groups of PAAG-Beads was determined by fluorescent microscopy for 7-10 random fields. Uncoated beads were used as control for these experiments. Reference is now made to FIG. 12, presenting pH and time dependence of the cytotoxic effect of PAAG beads.

The Percentage of dead Jurkat cells in this experiment is presented in FIG. 12. The data reveal that PAAG-beads, carrying both strong positive and strong negative charges, exhibit high cytotoxic properties. This effect was time- and concentration-dependent.

Acidic beads (pH 2-pH 4) have lesser cytotoxic effect in comparison with basic beads. Two types of anionic substituents were assessed: substituents bearing strongly acidic sulfonic groups, which are strong, polarizable under neutral conditions and substituents bearing weakly acidic carboxyl groups for which the degree of dissociation exceeds 98% at pH˜7.

### Example 17

### The Cytotoxic Effect of Two Amberlite™ Beads CG-120-I and CG-400-II on Jurkat Cells

### Material and Methods

Two Amberlite TM Beads CG-120-I and CG-400-II were tested for their effect on Jurkat cells: Amberlite TM CG-120-II (Fluka, 06469), strongly acidic gel-type resin with sulfonic acid functionality Na⁺ form, 200-400 mesh; and Amberlite TM CG-400-II (Fluka, 06471), strongly basic gel-type resin, quaternary ammonium functionality, Cr form, 200-400 mesh.

0.15 μL of the dye mixture (Molecular Probes' LIVE/DEAD® Viability Kit) were added to 20 μL of Jurkat cells in PBS (5×105 cells). 5 μL of Amberlite TM Beads in PBS (5×105 beads) were then added to the cells suspension. 7 μL stained cell suspension were immediately transferred to a picroscope slide and covered with a cover slip. Live and dead Jurkat cells were measured in a fluorescence microscope using 4-3 green filter.

### Results

It was shown that there are no practical differences between Control and the two Amberlite TM Beads. It seems that the Na⁺ form and the Cl⁻ form possess no cytotoxicity capabilities against Jurkat cells.

### Example 18

### The Cytotoxic Effect of Two Converted Amberlite TM Beads CG-120-I and CG-400-II on Jurkat Cells

### Material and Methods

The above mentioned Amberlite TM beads were converted to H+ and OH− forms according to the following procedure: Amberlite TM GC-120 (˜100 mg) were incubated in 2 mL of 0.5 M HCl at room temperature for 30 min. Amberlite TM GC-400 (˜100 mg) were incubated in 2 mL of 0.5 M NaOH at room temperature for 30 min. Beads were then washed with ˜50 mL of distilled water until the wash pH was 5 to 6 for both Amberlite TM types (GC-120 and GC-400). Stock suspension in water was prepared in a concentration of 1 mg/mL (105 beads/mL). Amberlite TM CG-120-II (Fluka, 06469), strongly acidic gel-type resin with sulfonic acid functionality H+ form, 200-400 mesh. Amberlite TM CG-400-II (Fluka, 06471), strongly basic gel-type resin, quaternary ammonium functionality, HO-form, 200-400 mesh. 0.15 μL of the dye mixture (commercially available Molecular Probes' LIVE/DEAD® Viability Kit) were added to 20 μL of Jurkat cells in PBS (5×105 cells). 5 μL of Amberlite TM Beads in PBS (5×105 beads) were then added to the cells suspension. 7 μL stained cell suspension were immediately transferred to a microscope slide and covered with a cover slip. Live and dead Jurkat cells were measured in a fluorescence microscope using 4-3 green filter.

### Results

The two types of converted Amberlite TM Beads CG-120-I and CG-400-II were converted to H⁺ and OH⁻ forms. Interaction of Jurkat cells with CG-400 in HO⁻ form leads to lysis of Jurkat cells; we did not observed any differences between CG-120 H⁺ form and Control.

No differences were found between CG-120 H⁺ form and Control. Interaction of Jurkat cells with CG-400 HO⁻ form leads to cell lysis.

### Example 19

### The Cytotoxic Effect of PAAG-Coated Silica Beads on HT-29 Cells

### Materials and Methods

PAAG-Coated and uncoated Silica beads (Sigma, cat.#421553) were prepared as described above. Stock solutions were stored in refrigerator +4° C. until used. HT-29 cells are maintained in DMEM medium supplemented by 10% FBS and penicillin-streptomycin-amphotericin (1:100).

### Sulphorhodamine Cytotoxicity Test (for HT-29 Cells)

Aliquots of medium containing 1−2×10⁴ cells were distributed into a 96-well plate

(Falcon). The following day, the media were replaced with 95 μL of fresh media and 5 μL of suspension containing different concentration of corresponding beads. The plate was then incubated for 72 h at 37° C. after which, 50 μL of 50% TCA were added to each well. Then after, Sulphorhodamine reagent was added and the cytotoxic effect was determined as described in the following Protocol:

First day: Add 2.5 mL/plate Trypsin-EDTA for 10 min RT (cells detachment); Transfer cells-trypsin-EDTA to 50 mL tube; Add 30 mL of DMEM/10% FCS media; Centrifuge for 10 min at 1500 rpm; Suspend cells in 20 mL of DMEM/10% FCS media; Centrifuge for 10 min 1500 rpm; Re-suspend cells in 4 mL of media; Prepare mix from X mL of cells suspension and Y mL of media; add 200 μL of cells (2×104 cells/200 μL) to each well of 96-well plate; Incubate for 24 hrs in CO2 incubator at 37° C.

Second day: Change Media and add Media and Solvent and Beads at 6 different concentrations: Add fresh medium, Solvent and Beads suspenssion; Incubate for 50 hrs in CO2 incubator at 37° C.

Third day: Wash with fresh medium five times; Add 50 μL of 50% TCA (final conc. 10% TCA); Incubate for 1 hr at 4° C.; Discard the supernatants; Wash 5 times with tap water; Invert plate and tap onto paper to remove water residuals; Let air-dry in a chemical hood over night.

Fourth day: Add 100 μL of Sulforhodamine B (0.4% w/v in 1% acetic acid); Incubate plate for 10 min at RT; Remove unbound dye by washing 5 times with 200 μL of 1% AcOH; Let the plate air-dry in a chemical hood for at least 2 hrs; Extract the dye from the cells with 200 μL of 10 mM Trizma base, pH10.3; Incubate at least 10 min at RT while shaking; Measure OD at 540 nm on a plate reader (background at 620 nm)

### Results

The sulforhodamine B (SRB) assay was used for cell density determination, based on the measurement of cellular protein content. The assay relies on the ability of SRB to bind to protein components of cells that have been fixed to tissue-culture plates by trichloroacetic acid (TCA). SRB is a bright-pink aminoxanthene dye, which bind to basic amino-acid residues under mild acidic conditions, and dissociate under basic conditions. As the binding of SRB is stoichiometric, the amount of dye extracted from stained cells is directly proportional to the cell mass. The strong intensity of SRB staining allows the assay to be carried out in a 96-well format. Results from the SRB assay exhibit a linear dynamic range over densities of 7.5×10³-1.8×10⁵ cells per well, corresponding to ˜1-200% confluence.

The SRB assay has been developed by us for testing functionalized Beads toxicity against human HT-29 cell line (colon adenocarcinoma). To allow comparison between the different experimental conditions, the GI-50 index was expressed as the Relative Number of Beads (RNB) needed in order to induce 50% cell-growth Inhibition. In other words, the RNB value is the reciprocal to the percent of dead cells measurement used in other examples disclosed in this invention.

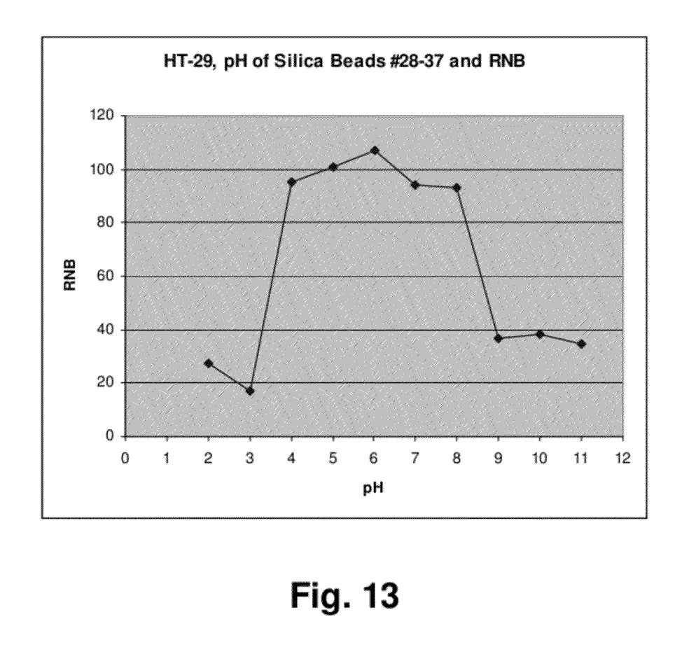

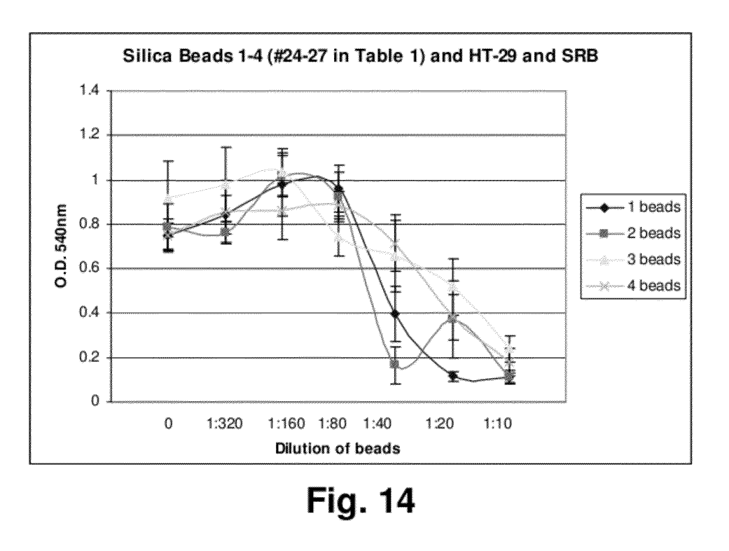

In the following experiments, HT-29 cells were put in contact with of functionalized PAAG-coated silica beads. Control experiments with uncharged beads were also systematically performed. The Beads: HT-29 cells ratio is varied from 1:20 to 1:160 or more, meaning that for each HT-29 cell there are between 156 to 19.5 million beads. SRB assay was repeated, and each concentration of Beads consisted of six to eight replicates (Table 21 and FIGS. 13 and 14).

These experiments show that PAAG-coated silica beads carrying strong acidic and strong basic groups have a cytotoxic effect on HT-29 cells. This effect is qualitatively similar to the effect observed for Jurkat cells (FIGS. 10-12 above). However, a cytotoxic effect of acidic Silica Beads on the adherent HT-29 cell seems to be stronger than the effect of basic Beads.

TABLE 21
RNB as a function of PAAG-coated silica beads pH
(Beads #28-37 in Table 19)

| # | pH | RNB |
|---|---|---|
| 28 | 2 | 27.2 |
| 29 | 3 | 17.2 |
| 30 | 4 | 95.2 |
| 31 | 5 | 101 |
| 32 | 6 | 107 |
| 33 | 7 | 94.3 |
| 34 | 8 | 92.9 |
| 35 | 9 | 36.6 |
| 36 | 10 | 38.5 |
| 37 | 11 | 34.7 |
| Silica | | 80 |

Reference is made to FIG. 13, illustrating the pH dependence of the cytotoxic effect of PAAG-coated silica beads on HT-29, Human adenocarcinoma cells.

Under these experimental conditions, the PAAG-coated silica beads carrying slightly acidic and basic properties seemed to be non-cytotoxic against colon HT-29 cells.

Growth inhibition of HT-29 cells by PAAG-coated silica beads is a concentration-dependent process (FIG. 14). Interaction of HT-29 cells with undiluted Silica Beads #48 (pH2) very quickly leads to lysis of the cell.

Reference is now made to FIG. 14 illustrating Concentration-dependent cytotoxic effect of PAAG-coated silica beads on HT-29 cells.

### Example 20

### Cytotoxic Effect of PAAG Beads on HT-29 Cells

### Materials and Methods

PAAG beads incorporating immobilines (size ˜500 nm) at various pH were prepared by standard emulsification techniques. Stock solutions were stored in refrigerator +4° C. until used. HT-29 cells are maintained in DMEM medium supplemented by 10% FBS and penicillin-streptomycin-amphotericin (1:100).

### Sulphorhodamine Cytotoxicity Test (for HT-29 Cells)

Aliquots of medium containing 1−2×10⁴ cells were distributed into a 96-well plate (Falcon). The following day, the media were replaced with 95 μL of fresh media and 5 μL of suspension containing different concentration of corresponding beads. The plate was then incubated for 72 h at 37° C. after which, 50 μL of 50% TCA were added to each well. Then after, Sulphorhodamine reagent was added and the cytotoxic effect was determined acoording to the above described Protocol.

### Results

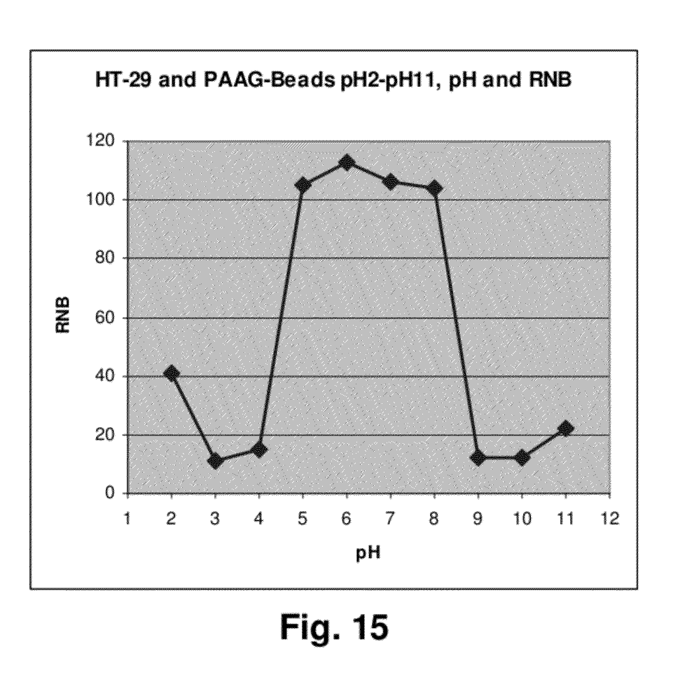

The sulforhodamine B (SRB) assay was used as described in Example 19 above. Reference is now made to FIG. 15 illustrating the pH dependence of the cytotoxic effect of PAAG-beads on HT-29, Human adenocarcinoma cells. In the following experiments, HT-29 cells were put in contact with of functionalized PAAG-beads. Control experiments with uncharged beads were also systematically performed. The Beads: HT-29 cells ratio is varied from 1:20 to 1:160 or more, meaning that for each HT-29 cell there are between 156 to 19.5 million beads. SRB assay was repeated, and each concentration of Beads consisted of six to eight replicates (FIGS. 15, 16 and 17).

These experiments show that PAAG-beads carrying strong acidic and strong basic groups have a cytotoxic effect on HT-29 cells. This effect is qualitatively similar to the effect observed for PAAG-Coated silica beads on HT-29 cells and on Jurkat cells (FIGS. 10-14 above).

Under these experimental conditions, the PAAG-beads carrying slightly acidic and basic properties seemed to be non-cytotoxic against colon HT-29 cells.

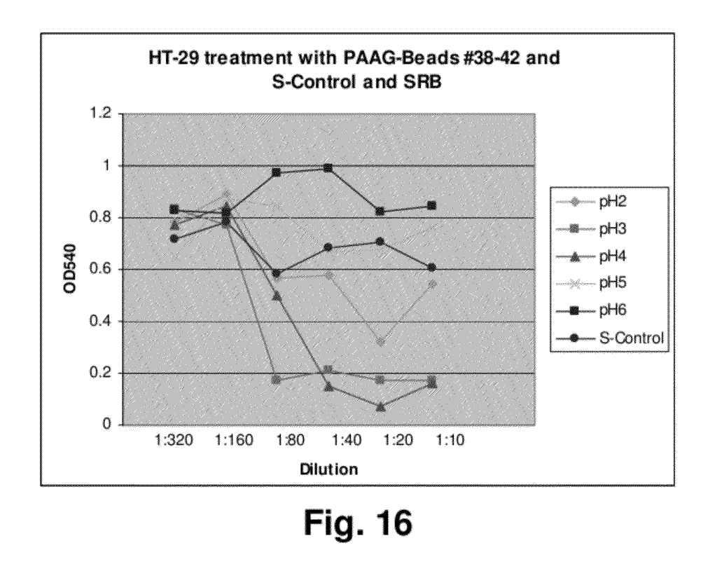

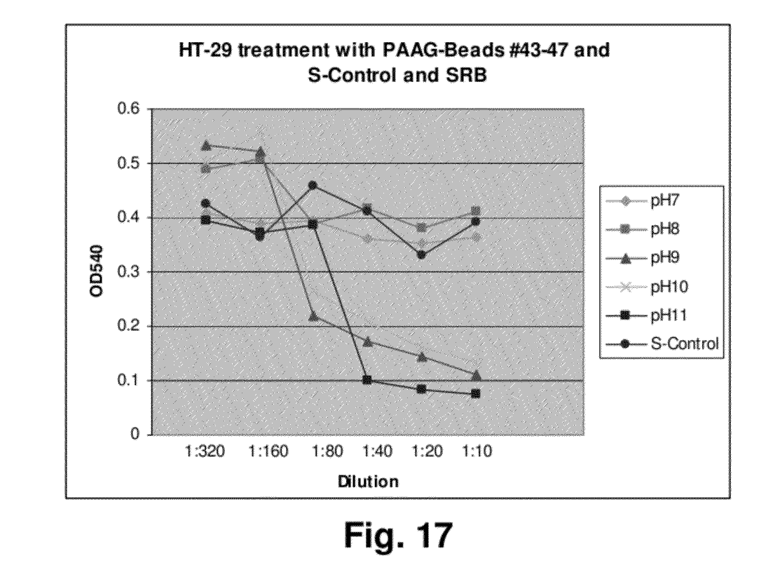

Reference is now made to FIG. 16 illustrating the pH and Concentration-dependent cytotoxic effect of PAAG-beads (pH values 2-6) on HT-29 cells; and to FIG. 17, presenting the pH and Concentration-dependent cytotoxic effect of PAAG-beads (pH values 7-11) on HT-29 cells. Growth inhibition of HT-29 cells by PAAG-beads is a concentration-dependent process (FIGS. 16 and 17). Interaction of HT-29 cells with undiluted Silica Beads #48 (pH2) very quickly leads to lysis of the cell.

### Example 21

### Hemolysis Induced by PAAG-Coated of Silica Beads

### Materials and Methods

Dilution of Beads: Prepare 0.2 mL of diluted beads: 10+190 μL of PBS (Ca, Mg); Preparation of RBC: Add 2 mL of blood to 13 mL of PBS; Mix gently; Centrifuge for 7 min at 2000 rpm, 10° C.; Remove the supernatant, without the RBC; Add 13 mL of PBS to the pellet and mix gently; Centrifuge as in step 3; Remove the supernatant and re-suspend the RBC in PBS to a final volume of 10 mL; Keep on ice until use.

Determination of hemolytic activity: Add 10 μL of diluted Beads to 50 μL of the washed RBC, Incubate at 37° C. with constant shaking for 4 hrs; Centrifuge the plate at 2000 rpm for 7 min at 10° C.; Transfer the supernatant to a new plate (flat bottomed) and measure absorbance at 540 nm.

### Results

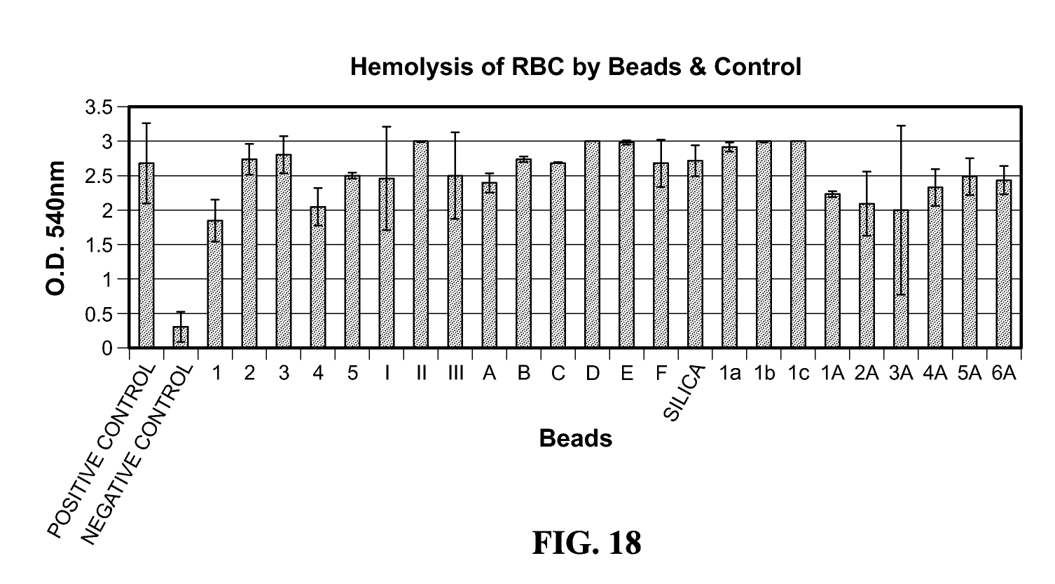

Reference is now to FIG. 18, presenting the role of hemolysis of RBC by PAAG-coated silica beads (see Table 19). It is shown that that all functionalized as well unmodified Silica Beads exert a strong hemolytic effect.

Dilution of Beads: Prepare 0.2 mL of diluted beads: 10+190 μL of PBS (Ca, Mg).

Preparation of RBC: Add 2 mL of blood to 13 mL of PBS; Mix gently; Centrifuge for 7 min at 2000 rpm, 10° C.; Remove the supernatant, without the RBC; Add 13 mL of PBS to the pellet and mix gently; Centrifuge as in step 3; Remove the supernatant and re-suspend the RBC in PBS to a final volume of 10 mL; Keep on ice until use; Determination of hemolytic activity; Add 10 μL of diluted Beads to 50 μL of the washed RBC; Incubate at 37° C. with constant shaking for 4 hrs; Centrifuge the plate at 2000 rpm for 7 min at 10° C.; Transfer the supernatant to a new plate (flat bottomed) and measure absorbance at 540 nm.

### Results

It is shown that all functionalized as well unmodified Silica Beads exert a strong hemolytic effect (FIG. 18).

### Example 22

### Apoptosis of Jurkat Cells Induced by PAAG Beads and PAAG-Coated of Silica Beads

### Materials and Methods

PAAG beads and PAAG-Coated and uncoated Silica beads (Sigma, cat. #421553) were prepared as described above. Stock solutions were stored in refrigerator +4oC until used.

The acute T-cell leukemia Jurkat cell line, clone E6-1 (ATCC number TIB-152), was used. Jurkat cells were maintained in RPMI-1640 medium supplemented by 1 mmol sodium pyruvate, 10% FBS and penicillin-streptomycin-amphotericin (1:100).

### Viability and Microscopic Observation

2 μL of beads (dilute with a 0.1% SDS solution) were added to 106 Jurkat cells in 25 μL of PBS. LIVE/DEAD® Dye (commercially available LIVE-DEAD Viability Kit, Molecular Probes) was added (0.15 μL) and incubation was performed at room temperature. Cell morphology and viability was examined using a fluorescent microscope (Axioskop 2 plus; filter 4-3).

Annexin V Apoptosis Detection Kit (Santa Cruz Biotechnology) was used for detection of apoptosis

### Induction of Apoptosis-Necrosis

The following method was followed: Add 2 μL of Beads (diluted in SDS 1:30) to 20 μL (10⁶ cells) of Jurkat cells in PBS and Incubate at RT for 20 min; Collect cells by centrifugation at 2000 rpm for 3 min; Wash cell pellet with PBS and re-suspend in 1× Assay buffer at a conc. 10⁶ cells/100 μL; Add 2 μL of Annexin V FITC and 10 μL 1 of PI (Annexin V Apoptosis; Detection Kit, Santa Cruz Biotechnology); Vortex and incubate 15 min at RT in the dark; Place 10 μL of cell suspension on glass slide and cover with glass cover-slip; Use filter 4-3 or 4-4 for PI alone for microscopic examination of the results. The following controls were used: Annexin V FITC and +PI; No Annexin V FITC and no PI; Annexin V FITC alone; and PI alone.

### Results

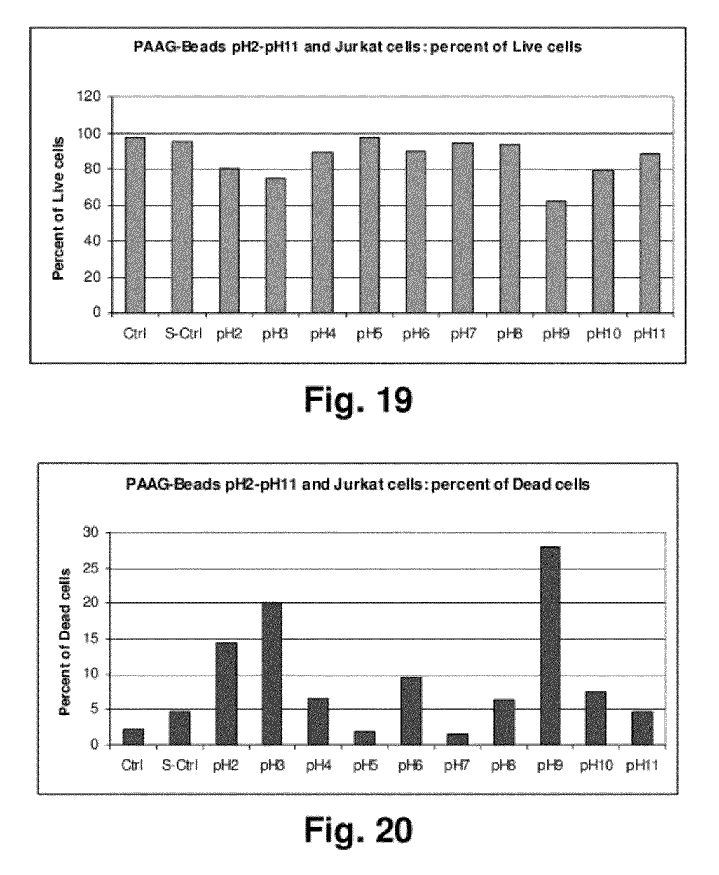

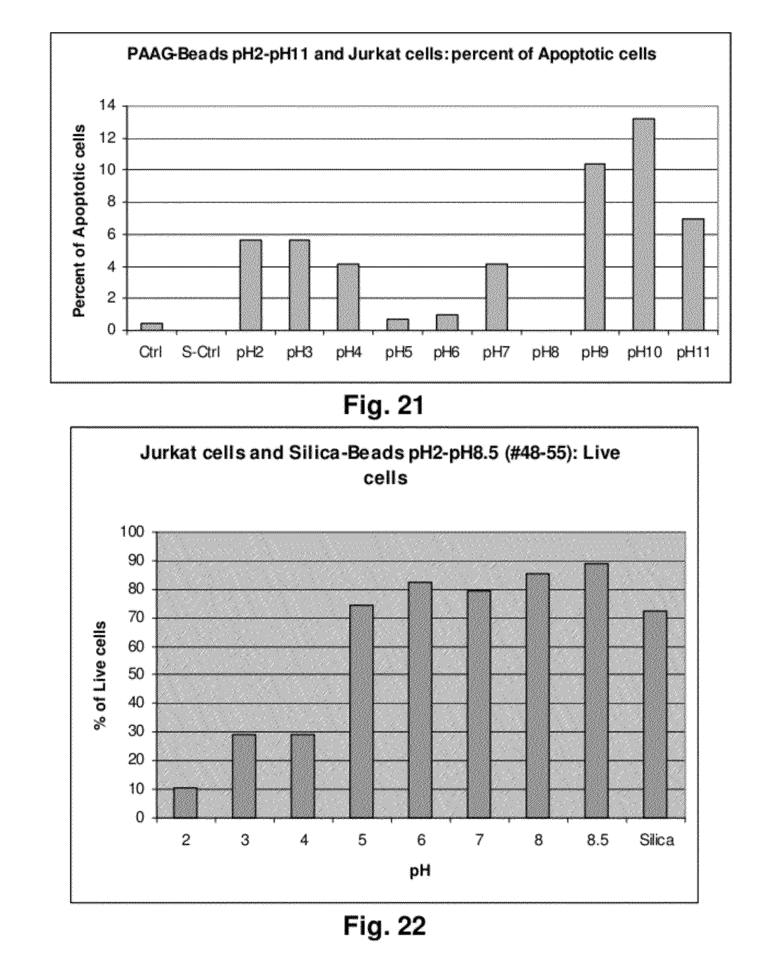

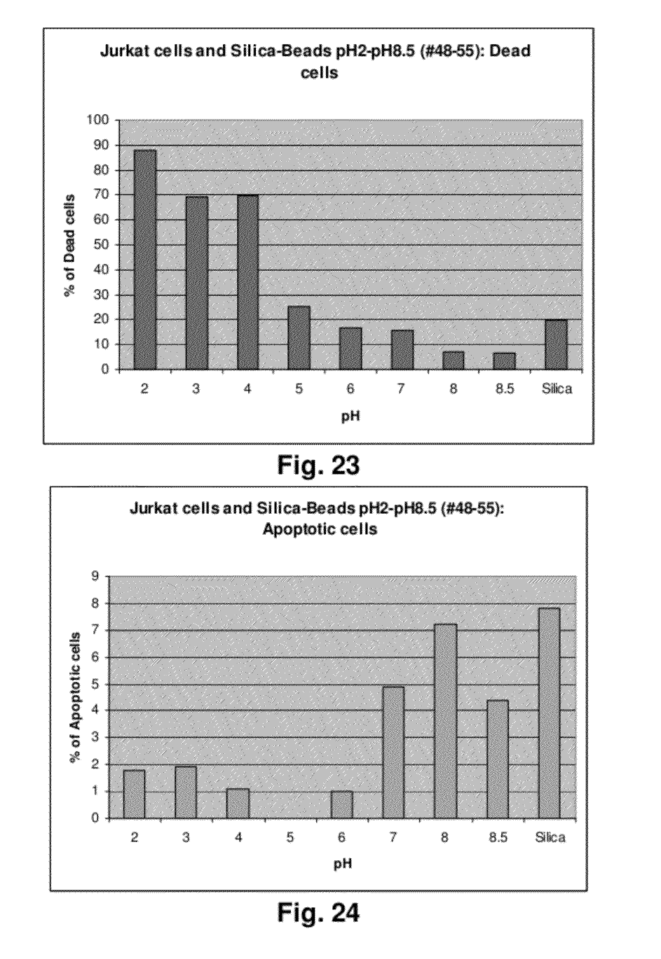

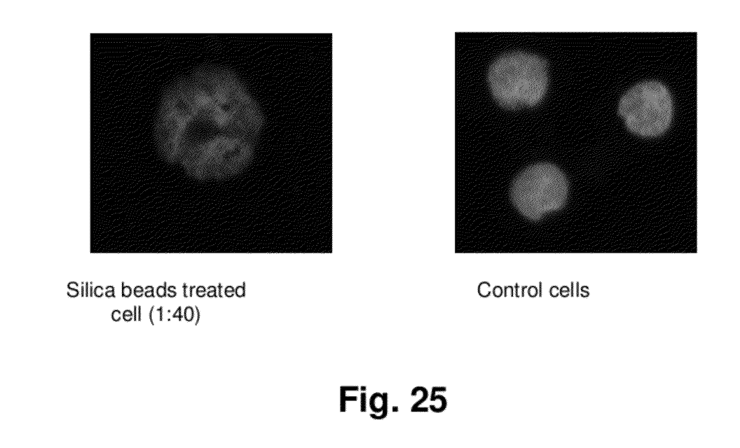

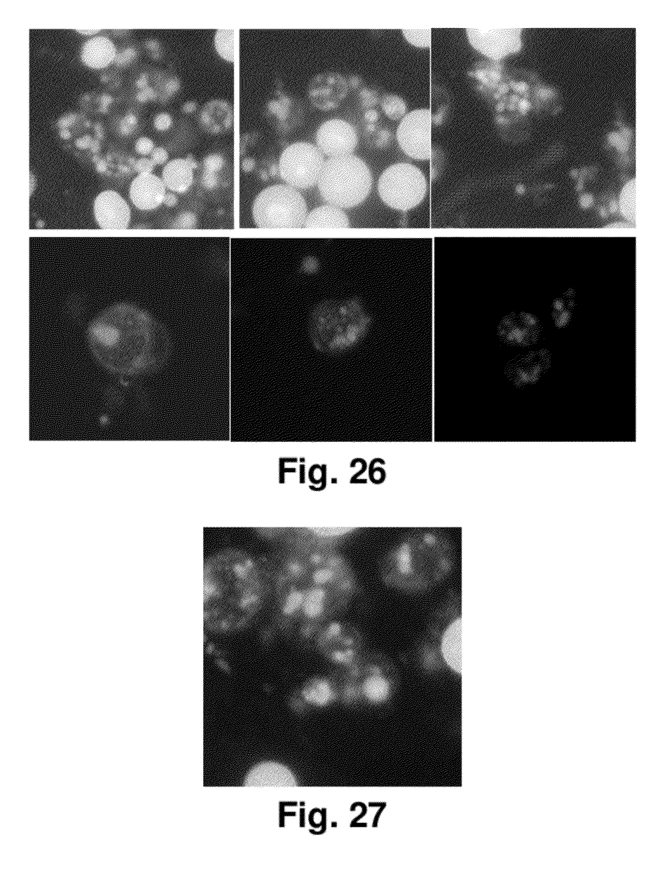

Reference is now made to FIGS. 19-27. FIG. 19 illustrates the pH induced cytotoxicity of PAAG-beads on Jurkat cells: Percentage of live cells. FIG. 20 illustrates pH induced cytotoxicity of PAAG-beads on Jurkat cells: Percentage of dead cells. FIG. 21 illustrates the pH induced apoptosis of Jurkat cells by PAAG-beads. FIG. 22 illustrates the pH induced cytotoxicity of PAAG-coated silica beads on Jurkat cells: Percentage of live cells. FIG. 23 illustrates the pH induced cytotoxicity of PAAG-coated silica beads on Jurkat cells: Percentage of dead cells. FIG. 24 illustrates the pH induced apoptosis of Jurkat cells by PAAG-coated silica beads. FIG. 25 illustrates Jurkat cells staining with Hoechst 33342 reagent after incubation with PAAG-coated silica beads pH-2 (#48 in Table 19) for 5 min. FIG. 26 illustrates Jurkat cells staining with Annexin V-PI and Dead/Live Dye after incubation with PAAG-coated silica beads pH-2 (#48 in Table 19) for 30 min. FIG. 27 is showing Jurkat cells staining with Annexin V-PI and Dead/Live Dye after incubation with PAAG-coated silica beads pH-2 (#48 in Table 19) for 90 min.

The presence of early apoptotic cells (limited nuclear fragmentation and green appearance) has been demonstrated after treatment with Silica Beads #3 (pH4.5) and #48 (pH2) and PAAG Beads #45-47 (pH 9 to pH 11). On the other hand, late apoptosis with characteristic nuclear fragmentation is also observed after treatment of Jurkat cells with Silica Beads #48 (Table 22 and FIGS. 19-27).

TABLE 22
pH induced cytotoxicity and apoptosis of Jurkat cells by
PAAG-coated silica-beads pH 2-pH 8.5 (#48-55)

| | Percentage | | |
|---|---|---|---|
| pH | Dead | Live | Apoptotic |
| 2 | 87.8 | 10.4 | 1.8 |
| 3 | 69.2 | 28.9 | 1.9 |
| 4 | 69.8 | 29.1 | 1.1 |
| 5 | 25.4 | 74.6 | 0 |
| 6 | 16.5 | 82.5 | 4.9 |
| 7 | 15.8 | 79.3 | 4.9 |
| 8 | 7.2 | 85.5 | 7.2 |
| 8.5 | 6.7 | 88.9 | 4.4 |
| Silica | 19.6 | 72.5 | 7.8 |

### Example 23

### Modulation of the pH-Derived Cytotoxicity by Impregnation and Coating of Acidic and Basic Ion Exchange Beads

### Experiment 1

The objective of this example was to show that by impregnation and coating of acidic and basic ion exchange beads with a neutral water permeable polymer which creates an ion selective barrier and slows down the ion exchange process the antibacterial property is enhanced.

### Material and Methods

Commercial ion exchange materials: Amberlite TM CG-400-II beads (OH⁻-form) and Amberlite TM IR-120 II beads (H+-form) (Rohm and Haas, bead size ˜100 microns) were impregnated with 20% polyacrylamide.

Those beads were deposited on an agar plate inoculated with S. aureus and the antibacterial toxicity was estimated by the halo radius generated around the beads after 24 hours of incubation at 37° C.

A control experiment was performed with non treated beads.

### Results

The radius of the halo around coated beads was twice as big as compared with the halo around the uncoated beads (1 mm versus 0.5 mm, respectively)

### Experiment 2

The objective of this example was to demonstrate that pH-derived bacterial toxicity of the materials and compositions of the current invention can be enhanced by impregnation of ion exchange beads with ionomeric polymers.

### Material and Methods

Commercial ion exchange materials and Amberlite TM IR-120 II beads (H-form) (Rohm and Haas, bead size ˜100 microns) were impregnated with commercial NAFION™ (Dupont) solution and left to dry and polymerize inside the porous matrix of the ion exchange resin.

Beads obtained by this manner were deposited on an agar plate inoculated with S. aureus and the antibacterial toxicity was estimated by the halo radius generated around the beads after 24 hours of incubation at 37° C. A control experiment was performed with non treated beads. A control experiment was performed with non treated beads.

### Results

The results were that the halo radius around the NAFION™-coated beads was more than 4-times as bigger as compared with that of the uncoated beads (3 mm versus 0.7 mm, respectively).

### Conclusions

The experimental data disclosed in the present invention demonstrate and provide evidence for the herein proposed principal mechanism for killing cells based on preferential proton and/or hydroxyl-exchange between the cell and strong acids and/or strong basic materials and compositions. The materials and compositions of embodiments of the present invention exert their cell killing effect via a titration-like process in which the cell is coming into contact with strong acids and/or strong basic buffers and the like.

This principal mechanism was tested and found effective against both Jurkat cells which are growing in suspension and against adherent HT-29 cells as well as against bacterial cells.

The cytotoxic effects of the materials and compositions of the current invention were found to be pH, time and concentration-dependent processes; the use of the strong charged Silica Beads at final dilution 1:20 leads to an immediate lysis of the Jurkat and HT-29 cells. This effect was also evident in the Interaction of Jurkat cells with converted Amberlite TM CG-400 in their HO⁻ form.

This pH-derived cytotoxicity can be modulated by impregnation and coating of acidic and basic ion exchange materials with polymeric and/or ionomeric barrier materials

The mechanism of action underlying the cell-killing process by the materials and compositions of the current invention involves, among other things, both early and late apoptosis of the target cells, prior to their membrane disruption and cell lysis. This observation further supports the idea that, as oppose to other materials and compositions known to the art, the materials and compositions of the current invention exert their cell killing effect via a titration-like process that leads to disruption of the cell pH-homeostasis and consequently to cell death.

### Example 24

### pH Preserving Antibacterial Silicone Sheet

A silicone matrix containing a mixture of acidic and basic ion exchange beads was prepared. The composition contained Amberlite TM 1200IRA (OH− form) 40% (Rohm and Haas) and Amberlite IR 120 (H+ form) 60% (Rohm and Haas). This mixture of ion exchange beads was incorporated in an inert silicon rubber solution at ratio of 40% silicon rubber (GE) and 60% Amberlite TM mixture, deposited on the inner surface of small glass jar and polymerized at 80degC for 12 hours.

The antibacterial activity of the coated jars was tested as follows: An input concentration of E. coli bacteria of 660 cfu/mL was prepared. 5 mL of TSB+E. coli bacteria were added into a jar. After 24 hours the jars were sampled and decimal diluted spread on TSA plates. After 24 hours of incubation at 30° C. colonies were counted.

### Results

TABLE 23
Antibacterial activity of “NEUTRAL”

| Material | cfu/mL |
|---|---|
| “NEUTRAL” | 3700 |
| Control (w/o coating) | >10¹⁰ |

pH value was equal to 7 in the tube with antibacterial material “NEUTRAL”.

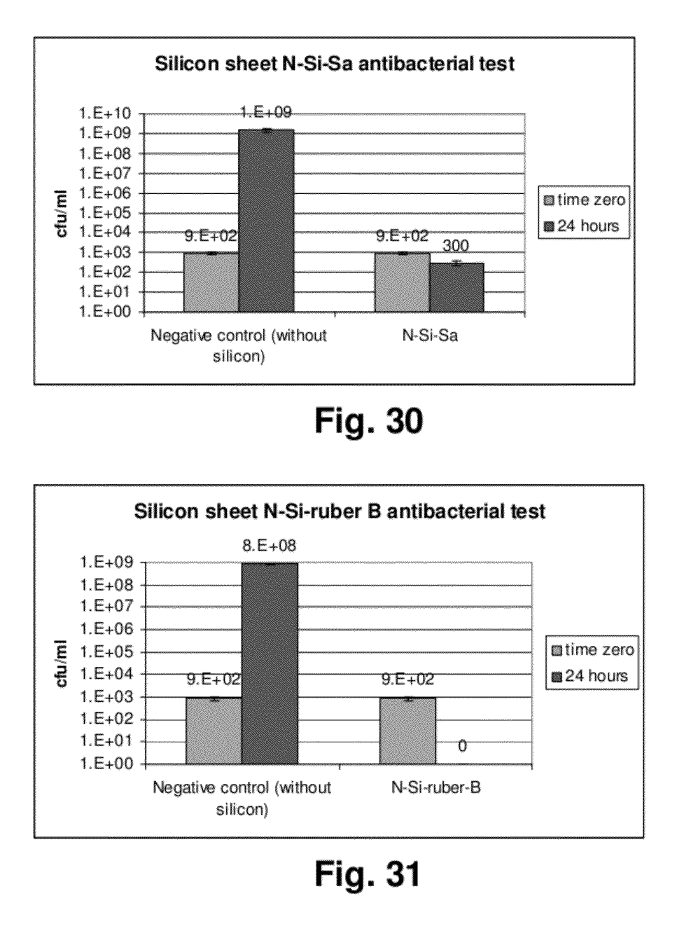

Reference in now made to FIGS. 30 and 31, presenting Activity tests on Composition A and B, respectively.

For leaching experiment, 100 mg of antibacterial material “NEUTRAL” was added to 5 mL of sterile water. Incubation was performed 48 hrs at 30° C. Potassium ions, silicone ions, sodium ions and sulfate ions were determined by ICP method.

TABLE 24
Leaching (mg/L): Exp. from 18.03.08 #1440308

| Elements | Leaching (mg/l) |
|---|---|
| S | 1.15 |
| Si | <0.002 |
| Na | 0.32 |
| K | 0.29 |

The results of table 24 show negligible release of materials from the coatings.

### Example 25

### Non Leaching Bioactive Polymer (Suflon TM)

A composite acidic polymer was synthesized by the following method:

Teflon (tetrafluoroethylene) monomer in n octane (20%) emulsion (CAS [116-14-3] Du Pont) was mixed with of random cross linked polystyrene sulfonate in acid form solution (27%) (Sigma Cat. No. 659592-25 mL) in n-hexane (Frutarom, Israel).

The mixture was deposited in ratio of in an autoclave and copolymerized at 50° C. and pressure of 10 atmospheres.

The resulting solution was sedimented by 0.1% of SDS (sodium dodecyl sulfate) and pressed into 0.5 mm thick sheets.

The antibacterial effect of the polymer on the growth of E. coli bacteria was tested as follows:

A 40 mg fragment of the active polymer was deposited in a 1 mL of diluted bacteria (1.E+04 cfu/mL) in TSB. The Control tube contains only bacteria in TSB. Tubes are kept in Orbital shaker at 30° C. for 24 hrs, and then are sampled for the cfu and pH measurement.

The results are as follows:

TABLE 25
Antibacterial activity of Suflon TM

| Samples | cfu/mL |
|---|---|
| SUflon | 4 × 10⁴ |
| Control | 3.1 × 10⁸ |

The results indicate inhibition of 4 logs in the presence of Suflon TM on the proliferation of E. coli bacteria.

For leaching experiment, 5 mL of sterile water (Control) and 40 mg of Suflon TM in 5 mL of sterile water are incubated at 30° C. for 24 hrs in 15-mL polypropylene tubes. These two water samples were analyzed by the ICP MS method by Spectrolab Ltd (IL).

TABLE 26
ICP analysis

| Samples | Elements | mg/l |
|---|---|---|
| Control (#1) | Na | <0.001 |
| (pH 7) | K | 0.011 |
| | S | <0.001 |
| Suflon TM (#2) | Na | <0.001 |
| (pH 7) | K | 0.018 |
| | S | <0.001 |

The results show negligible release of materials from the polymer matrix.

ICP analysis showed that Na, K and S were not found in the water containing the active polymer sample proving that the polymer composition does not leach any ingredients.

### Example 26

### Antibacterial Activity of Silicone Sheets

Two types of silicone resins exhibiting bactericidal activity were prepared:

Composition A 10% 2-phenyl-5-benzidazole-sulfonic acid (Sigma 437166 25 ml); 5% Poly(styrene ran-ethylene), sulfonated, (Sigma 659401-25mL); 80% Siloprene LSR 2060 (GE); 5% plasticizer R^{E}-AS-2001 (MFK Inc). The mixture was spread on glass plates (thickness 1g/10 cm**2) and polymerized at 200degC for 3 hours. The polymerized sheets were peeled of the glass and tested

Composition B 15% 2-phenyl-5-benzimiddazole-sulfonic acid (Sigma 437166-25 ml) 80% Siloprene LSR 2060 (GE); 5% plastificator RE-AS-2001; The mixture was spread on glass plates (thickness 1 g/10 cm²) and polymerized at 200° C. for 3 hours. The polymerized sheets were peeled of the glass and tested.

E. coli culture was grown overnight and was diluted 1:10⁴. 100 mg of the Silicon Sheet of Composition A and Composition B were cut and kept in Eppendorf tubes. 1 mL of the diluted culture were added the tubes. Tubes were kept rotating at room temperature and were sampled at time zero & 24 hours. Samples were decimaly diluted and were seeded on TSA plates, colonies were counted 24 hours later.

For leaching experiments 100 mg pieces of the silicone sheets of Composition A and B were placed in 5 mL of sterile water. Incubation was performed 48 hrs at 30° C. K, Na, S and Si were determined by ICP method.

TABLE 27
ICP analysis (change) Composition A

| Samples | Elements | mg/l |
|---|---|---|
| Control (#1) | Na | 0.007 |
| (pH 7) | K | 0.002 |
| | S | <0.002 |
| | Si | 0.022 |
| Silicone coating | Na | 0.027 |
| (pH 7) | K | 0.016 |
| | S | 0.006 |
| | Si | 2.238 |

TABLE 28
ICP analysis Composition B

| Samples | Elements | mg/l |
|---|---|---|
| Control (#1) | Na | 1.49 |
| (pH 7) | K | 0.056 |
| | S | 0.66 |
| | Si | 0.13 |
| Silicone coating | Na | 0.81 |
| (pH 7) | K | 0.01 |
| | S | 0.07 |
| | Si | 0.009 |

The results show negligible release of materials from the coatings.

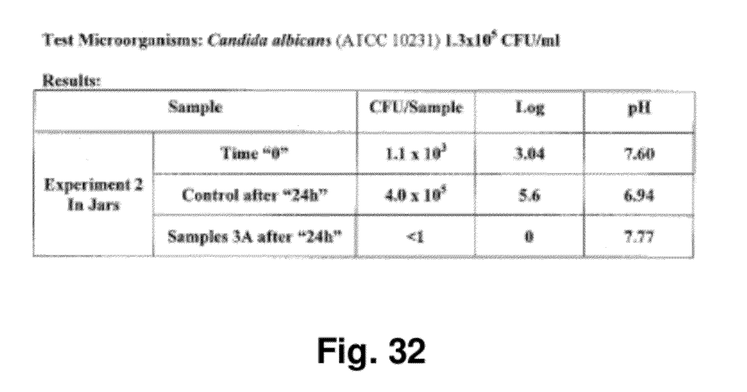

Reference is made to FIGS. 30 & 31, presenting activity test on compositions A & B, respectively. FIG. 32 presents tests microorganisms for Candida albicans (ATCC 10231).

Hence, those PSS systems display high effectively in killing bacteria, while negligible leaching and pH change are obtained in the LTC environment.

### Example 27

### Regeneration of Biocidic Activity of PSS-Containing Silicone Sheets

Two types of silicone resins exhibiting bactericidal activity were prepared. An effective measure of acid, here, ascorbic acid (Vitamin C) was utilized together with a of an ion exchanger comprising effective measure of sodium polystyrene sulphonate, as well as with other types PSSs. It was found that the acid regenerates the salt-form PSS by providing it with protons.

Moreover, articles of manufactures, such as bandages and packages for foodstuffs, beverages (e.g., juices), lotions, creams were provided with and effective measure of acid, and again, regeneration of the PSS activity was obtained.

### Example 28

### Intercellular pH vs. Intracellular pH

### Materials and Methods

The composition contained Amberlite TM 12001R^{A} (OH− form) 40% (Rohm and Haas) and Amberlite IR 120 (H+ form) 60% (Rohm and Haas). This mixture of ion exchange beads was incorporated in an inert silicon rubber solution at ratio of 40% silicon rubber (GE) and 60% Amberlite TM mixture, deposited on the inner surface of small glass jar and polymerized at 80° C. for 12 hours. E. coli bacteria were used as defined above. Similarely, PAAG beads and PAAG-Coated and uncoated Silica beads were prepared as described above. Stock solutions were stored in refrigerator +4° C. until used. The acute T-cell leukemia Jurkat cell line, clone E6-1, was used as defined above. Jurkat cells were maintained in RPMI-1640 medium supplemented by 1 mmol sodium pyruvate, 10% FBS and penicillin-streptomycin-amphotericin (1:100). Commercially available pH-dependent dyes were used.

### Results

A significant change in intracellular pH by incorporating pH indicator dyes internally into cells was demonstrated. The dyes color change was observed as intracellular pH changes.

### Example 29

As a non-limiting example of a method used to increase the surface H⁺ concentration, and hence surface charge, of a zeolite, the following procedure was employed. NH₄-ZSM-5-15 ammoniated zeolite (pH=5.8) was purchased from ZEOlyst (cat. No. CBV-3024E). 50 g of the zeolite was poured into a crucible and placed in a furnace (Electrotherm model MS-8). The zeolite was then heated according to the following sequence: (1) the temperature was raised from room temperature to 120° C. at a rate of 15° C./min, and held at 120° C. for 60 min; (2) the temperature was then raised to 300° C. at a rate of 5° C./min, and held at 300° C. for 120 min; (3) the temperature was then raised to 480° C. at a rate of 5° C./min, and held at 480° C. for 360 min. The pH of a 1% suspension of the treated zeolite stirred at room temperature for 1 hour was determined to be 3.5, i.e. a ˜200-fold increase in the H⁺ concentration relative to the untreated zeolite.

### Example 30

The antibacterial activity of an acid-form zeolite—EVA film on a paper matrix was tested using the ISO 22196 method. The zeolite—EVA material was prepared according to the following protocol. First, 5 g of EVA (EVA EVATANE 40-55, obtained from Arkema) was put into a 50 ml polycarbonate tube, and 40 ml of methylene chloride (CP, obtained from Gadot) were added. The mixture was stirred for 4 h until the EVA fully dissolved. The resulting solution was then divided into two equal parts. 7.5 g of zeolite (commercially available H-Mor-17 zeolite obtained from ZeoChem AG) was sieved through a 250 μm mesh sieve and added to the EVA solution and shaken until a homogeneous suspension was formed. The resulting suspension was then vigorously shaken and stirred for an additional 30 min. The liquid was then poured into a Pyrex container.

Standard white A4 paper was cut into 5 cm×5 cm squares, held by a pin or tweezers and soaked in a 1M HCl solution for 2 min in order to remove CaCO₃ filler from the paper matrix. After bubbling, indicating release of CO₂, was observed to have stopped, the squares were removed from the HCl solution and dried for 0.5 h in a fume hood. The dried paper squares were then dipped into the zeolite suspension, held there for 1 s, and removed, thus coating both sides of the paper. The coated paper was then dried for several minutes in a fume hood.

Microbiological experiments were performed according to the ISO 22196 protocol using E. coli as the test organism and the pour plate sampling method. The results are presented in the in the following table.

TABLE 29
Results for ISO 22196 protocol: E. coli

| Time after introduction of | | | |
|---|---|---|---|
| E. coli | Control | Zeolite | Acid-form zeolite |
| 0 | 3.75 × 10³ | 3.75 × 10³ | 3.75 × 10³ |
| | 4.38 × 10³ | 4.38 × 10³ | 4.38 × 10³ |
| (average, 0 h) | 4.06 × 10³ | 4.06 × 10³ | 4.06 × 10³ |
| 24 h | 2.38 × 10⁵ | 0 | 3.81 × 10¹ |
| | 1.81 × 10⁵ | 0 | 2.31 × 10² |
| | 2.00 × 10⁵ | 0 | 4.69 × 10¹ |
| (average, 24 h) | 2.06 × 10⁵ | 0 | 1.05 × 10² |

### Example 31

The antimicrobial activity of various Zeolite/EVA sheets was evaluated. The seven compositions listed in the following table were prepared. In all cases, a total of 24 g of starting material (zeolite +EVA) was used to prepare the sheets.

TABLE 30
Zeolite/EVA sheet compositions

| | Zeolite (g) | | | |
|---|---|---|---|---|
| Composition | Zeoflair 100 | CP811C-300 | Mordenite-17-H | EVA (g) |
| A | | | 18 | 6 |
| B | 18 | | | 6 |
| C | | 18 | | 6 |
| D | 9 | | 9 | 6 |
| E | 6 | | 12 | 6 |
| F | 9 | 9 | | 6 |
| G | 6 | 12 | | 6 |

Zeolite/EVA sheets were prepared according to the Cath-5-141 sheet preparation method. The sheets were prepared in a polymer mixer. The mixer was set to 80° C. for 30 min prior to introduction of material into the mixer. First, the EVA was fed into the mixer. A few minutes later, after the EVA had melted zeolite was slowly added. The components were mixed and the bulk then transferred to the press. The bulk was placed between 2 silicone sheets and pressed at 10 tons and 80° C. to form a sheet. After the sheets were formed, they were placed on a marble table top to cool. After cooling, the silicone sheets were peeled from the zeolite/EVA sheet. The zeolite/EVA sheet was then cut into 1.5×2 cm rectangles. Each rectangle was weighed and then placed in a 50 ml test tube. Twenty 1.5×2 cm samples of each of the seven compositions were prepared.

The antimicrobial activity of the zeolite/EVA sheets was then tested by the ASTM 2149 method using MEA as the growth medium. Test microorganisms included Saccharomyces cerevisiae, E. coli, and Klebsiella Pneumoniae. All samples were incubated at 30° C. The pour plate sampling method was used.

Tables 31-33 present the results of the experiments.

TABLE 31
Results for ASTM method 2149: Klebsiella pneumoiae (concentrations in CFU/ml)

| | Negative | Positive | | | | | | | |
|---|---|---|---|---|---|---|---|---|---|
| Time | control | control | A | B | C | D | E | F | G |
| 0 | 5 × 10⁵ | 5 × 10⁵ | 5 × 10⁵ | 5 × 10⁵ | 5 × 10⁵ | 5 × 10⁵ | 5 × 10⁵ | 5 × 10⁵ | 5 × 10⁵ |
| 24 h | 1 × 10⁸ | 0 | 0 | 2 × 10⁸ | 2 × 10⁸ | 2 × 10⁸ | 0 | 2 × 10⁸ | 2 × 10⁸ |
| | 2 × 10⁸ | 0 | 0 | 2 × 10⁸ | 2 × 10⁸ | 2 × 10⁸ | 0 | 2 × 10⁸ | 2 × 10⁸ |
| avg | 1.5 × 10⁸ | 0 | 0 | 2 × 10⁸ | 2 × 10⁸ | 2 × 10⁸ | 0 | 2 × 10⁸ | 2 × 10⁸ |

TABLE 32
Results for ASTM method 2149: E. Coli (concentrations in CFU/ml)

| | Negative | Positive | | | | | | | |
|---|---|---|---|---|---|---|---|---|---|
| Time | control | control | A | B | C | D | E | F | G |
| 0 | 5 × 10⁵ | 5 × 10⁵ | 5 × 10⁵ | 5 × 10⁵ | 5 × 10⁵ | 5 × 10⁵ | 5 × 10⁵ | 5 × 10⁵ | 5 × 10⁵ |
| 24 h | 2.0 × 10⁸ | 0 | 0 | 2.8 × 10⁸ | 2.5 × 10⁸ | 2.3 × 10⁸ | 0 | 2.7 × 10⁸ | 2.6 × 10⁸ |
| | 2.5 × 10⁸ | 0 | 0 | 2.7 × 10⁸ | 2.6 × 10⁸ | 2.1 × 10⁸ | 0 | 2.4 × 10⁸ | 2.7 × 10⁸ |
| | 2.0 × 10⁸ | 0 | 0 | 2.6 × 10⁸ | 2.4 × 10⁸ | 2.4 × 10⁸ | 0 | 2.8 × 10⁸ | 2.3 × 10⁸ |
| avg | 1.5 × 10⁸ | 0 | 0 | 2.7 × 10⁸ | 2.5 × 10⁸ | 2.3 × 10⁸ | 0 | 2.6 × 10⁸ | 2.5 × 10⁸ |

TABLE 33
Results for ASTM method 2149: S. cerevisiae (concentrations in CFU/ml)

| | Negative | Positive | | | | | | | |
|---|---|---|---|---|---|---|---|---|---|
| Time | control | control | A | B | C | D | E | F | G |
| 0 | 4.1 × 10⁵ | 4.1 × 10⁵ | 4.1 × 10⁵ | 4.1 × 10⁵ | 4.1 × 10⁵ | 4.1 × 10⁵ | 4.1 × 10⁵ | 4.1 × 10⁵ | 4.1 × 10⁵ |
| 24 h | 1.1 × 10⁶ | 8.0 × 10³ | 4.0 × 10² | 5.0 × 10⁵ | 6.0 × 10⁵ | 6.0 × 10⁵ | 6.0 × 10⁵ | 6.0 × 10⁵ | 8.0 × 10⁵ |
| | 4.0 × 10⁵ | 1.2 × 10⁴ | 4.0 × 10¹ | 6.0 × 10⁵ | 5.0 × 10⁵ | 5.0 × 10⁵ | 5.0 × 10⁵ | 6.7 × 10⁵ | 3.0 × 10⁵ |
| | 1.3 × 10⁶ | 4.0 × 10³ | 1.0 × 10⁰ | 4.2 × 10⁵ | 4.0 × 10⁵ | 5.0 × 10⁵ | 4.2 × 10⁵ | 5.5 × 10⁵ | 3.0 × 10⁵ |
| avg | 9.3 × 10⁵ | 8.0 × 10³ | 1.5 × 10² | 5.1 × 10⁵ | 5.0 × 10⁵ | 5.5 × 10⁵ | 5.1 × 10⁵ | 5.8 × 10⁵ | 4.7 × 10⁵ |

As can be seen from the results summarized in the tables, composition “A” (acid-form zeolite in EVA) provided the most active biocide against all three microorganisms. Composition “E” (comprising base-form zeolite and acid-form zeolite in a 1:3 ratio) was effective against K. pneumoniae and E. coli, but not against S. cerevisiae.

### Example 32

The biocidic properties of several different zeolites were compared. Rates of killing of four different species of microorganisms (E. coli, Staphylococcus Aureus, Candida, and B. Fulva) were measured for six types of zeolites (Clinoptilolite was obtained from Incal Materials). The activities are summarized in Table 34. As can be seen from the results summarized in the table, naturally occurring forms of Clinoptilolite and an Na⁺-form zeolite showed no biocidic activity whatsoever, while all of the charged forms (acid, base, and mixed) showed significant ability to reduce the populations of pathogenic microorganisms.

TABLE 34
Biocidic properties of different types of zeolite
(rates of killing in CFU/h)

| | Commercial | | S. | Yeast | B. |
|---|---|---|---|---|---|
| Zeolite form | name | E. Coli | Aureus | (Candida) | Fulva |
| Na⁺ (pH ~8) | Zeoflair 300 | Not | Not | Not active | Not |
| | | active | active | | active |
| acid (pH ~3.2) | Mordenite | 10² | 10³ | 10¹-10² | 10¹ |
| | 17-H | | | | |
| base (pH ~11.8) | Zeoflair 100 | 10¹ | 10¹ | 10¹ | 0 |
| | | | | | (static) |
| Mg²⁺ | Clinoptilolite | Not | Not | Not active | Not |
| | | active | active | | active |
| Ca²⁺ | Clinoptilolite | Not | Not | Not active | Not |
| | | active | active | | active |
| mixed acidic + | | 10¹-10² | 10¹-10³ | 10¹-10² | 10¹-10² |
| basic zeolites | | | | | |

As can be seen from the results summarized in the table, naturally occurring forms of Clinoptilolite and an Na⁺-form zeolite showed no biocidic activity whatsoever, while all of the charged forms (acid, base, and mixed) showed significant ability to reduce the populations of pathogenic microorganisms.

### Example 33

The biocidic activity of various zeolite/EVA sheets against Staphylococcus aureus was evaluated.

Zeolite/EVA sheets were prepared according to the Cath-5-141 sheet preparation method. The sheets were prepared in a polymer mixer. The mixer was set to 80° C. for 30 min prior to introduction of material into the mixer. First, 6 g of EVA were fed into the mixer. A few minutes later, after the EVA had melted, 18 g of zeolite were slowly added. The components were mixed and the bulk then transferred to the press. The bulk was placed between 2 silicone sheets and pressed at 10 tons and 80° C. to form a sheet. After the sheets were formed, they were placed on a marble table top to cool. After cooling, the silicone sheets were peeled from the zeolite/EVA sheet. The zeolite/EVA sheet was then cut into 1.5×2 cm rectangles. Each rectangle was weighed and then placed in a 50 ml test tube. Twenty 1.5×2 cm samples of each of the seven compositions were prepared.

The antimicrobial activity of the zeolite/EVA sheets was then tested by the ASTM E2149 method using TSA as the growth medium. All samples were incubated at 30° C. The pour plate sampling method was used. Three independent replications were performed both for the control studies (no biocide) and the experimental runs. The results are summarized in Table 35.

TABLE 35
Results for ASTM method E2149: S. aureus (concentrations in CFU/ml)

| | | | Clinoptolite | Clinoptolite | Zeoflair 300 | Zeoflair 100 |
|---|---|---|---|---|---|---|
| Time | Control | Mordenite | (Mg²⁺ form) | (Ca²⁺ form) | (pH 8) | (pH ~11.8) |
| 0 | 7.0 × 10⁴ | 7.0 × 10⁴ | 7.0 × 10⁴ | 7.0 × 10⁴ | 7.0 × 10⁴ | 7.0 × 10⁴ |
| 24 h | 1.7 × 10⁷ | 2.1 × 10⁴ | 2.9 × 10⁵ | 1.4 × 10⁶ | 6.3 × 10⁶ | 3.4 × 10⁴ |
| | 2.7 × 10⁷ | 7.8 × 10³ | 9.0 × 10⁵ | 1.2 × 10⁶ | 2.5 × 10⁶ | 2.5 × 10⁵ |
| | 1.8 × 10⁷ | 3.7 × 10⁴ | 2.1 × 10⁶ | 1.9 × 10⁶ | 1.9 × 10⁶ | 6.4 × 10⁴ |
| avg | 2.1 × 10⁷ | 2.2 × 10⁴ | 1.1 × 10⁶ | 1.5 × 10⁶ | 3.6 × 10⁶ | 1.2 × 10⁵ |
| (24 h) | | | | | | |

As can be seen from the results presented in the table, the acidic form zeolite (Mordenite) was the most effective biocide, with commercially available Zeoflair 100 (the more highly basic of the two basic forms tested) showed biocidic activity to a lesser extent.

### Example 34

The biocidic activity of various zeolite/EVA sheets against E. coli was evaluated.

Zeolite/EVA sheets were prepared according to the same protocol used in the previous example. Their effectiveness against E. coli was determined using the ASTM E2149 method. The experimental conditions were as in the previous example. The results are summarized in Tables 36A and 36B.

TABLE 36A
Results for ASTM method E2149: E. coli
(concentrations in CFU/ml)

| Time | Control | Mordenite |
|---|---|---|
| 0 | 2.1 × 10⁵ | 2.1 × 10⁵ |
| 24 h | 2.7 × 10⁸ | 5.0 × 10⁰ |
| | 3.3 × 10⁸ | 5.0 × 10⁰ |
| | 3.4 × 10⁸ | 5.0 × 10⁰ |
| avg (24 h) | 3.1 × 10⁸ | 5.0 × 10⁰ |

TABLE 36B
Results for ASTM method E2149: E. coli
(concentrations in CFU/ml)

| | | | | Zeoflair | Zeoflair |
|---|---|---|---|---|---|
| | | Clinoptolite | Clinoptolite | 300 | 100 (pH |
| Time | Control | (Mg²⁺ form) | (Ca²⁺ form) | (pH 8) | ~11.8) |
| 0 | 2.1 × 10⁵ | 2.1 × 10⁵ | 2.1 × 10⁵ | 2.1 × 10⁵ | 2.1 × 10⁵ |
| | 1.9 × 10⁸ | 5.4 × 10⁴ | 2.2 × 10⁸ | 8.0 × 10⁴ | 5.9 × 10³ |
| 24 h | 3.1 × 10⁸ | 3.0 × 10⁴ | 2.6 × 10⁸ | 5.3 × 10⁴ | 4.4 × 10⁴ |
| | 1.7 × 10⁸ | 2.4 × 10⁴ | 2.1 × 10⁸ | 6.2 × 10⁴ | 4.1 × 10⁴ |
| avg | 2.2 × 10⁸ | 3.6 × 10⁴ | 2.3 × 10⁸ | 6.7 × 10⁴ | 3.0 × 10⁴ |
| (24 h) | | | | | |

As can be seen from the results summarized in the tables, once again, the acidic form of the zeolite (mordenite) showed excellent biocidic activity against E. coli. Although except for the Ca²⁺ form of clinoptolite, the other zeolite forms showed some biocidic activity, the acidic form reduced the concentration of the bacteria more effectively than the others by some four orders of magnitude.

### Example 35

In a separate series of experiments, the biocidic activity of various zeolite/EVA sheets against E. coli and S. cerevisiae was evaluated. In this set of experiments, the biocidic activity of an acid-form zeolite prepared as described above was compared with that of an acid-form zeolite prepared in such a way as to provide a significantly more porous surface.

Zeolite/EVA sheets were prepared according to the same protocol used in the previous example. The antimicrobial activity of the sheets was tested by ASTM method E2149. The pour plate method was used. Tests were done in a 10 ml container. Microorganisms were incubated at 30° C. for 24 hours. For E. coli, the liquid was TSB diluted 1:100, TSA medium was used for the plates, and the initial concentration was 3.5×10⁵ CFU/ml. For S. cerevisiae, the liquid was PDB diluted 1:100, MEA medium was used for the plates, and the initial concentration was 8×10⁶ CFU/ml. Test results are presented in tables 37A and 37B.

TABLE 37A
ASTM E2149 results for antimicrobial activity against E. coli

| | | Initial | Concentration |
|---|---|---|---|
| | | concentration, | after 24 h, |
| Zeolite type | Sample No. | CFU/ml | CFU/ml |
| Control (no zeolite) | 1 | 3.5 × 10⁵ | 7.0 × 10⁷ |
| | 2 | 3.5 × 10⁵ | 2.7 × 10⁸ |
| | 3 | 3.5 × 10⁵ | 2.1 × 10⁸ |
| | average | 3.5 × 10⁵ | 1.8 × 10⁸ |
| Acid-form zeolite | 1 | 3.5 × 10⁵ | <1 |
| | 2 | 3.5 × 10⁵ | <1 |
| | 3 | 3.5 × 10⁵ | <1 |
| | average | 3.5 × 10⁵ | <1 |
| “Porous surface” acid- | 1 | 3.5 × 10⁵ | <1 |
| form zeolite | 2 | 3.5 × 10⁵ | <1 |
| | 3 | 3.5 × 10⁵ | <1 |
| | average | 3.5 × 10⁵ | <1 |

TABLE 37B
ASTM E2149 results for antimicrobial activity
against S. cerevesiae

| | | Initial | Concentration |
|---|---|---|---|
| | | concentration, | after 24 h, |
| Zeolite type | Sample No. | CFU/ml | CFU/ml |
| Control (no zeolite) | 1 | 8 × 10⁵ | 1.0 × 10⁶ |
| | 2 | 8 × 10⁵ | 2.0 × 10⁶ |
| | 3 | 8 × 10⁵ | 1.3 × 10⁶ |
| | average | 8 × 10⁵ | 1.4 × 10⁶ |
| Acid-form zeolite | 1 | 8 × 10⁵ | 5.1 × 10¹ |
| | 2 | 8 × 10⁵ | 3.0 × 10² |
| | 3 | 8 × 10⁵ | 3.1 × 10² |
| | average | 8 × 10⁵ | 2.2 × 10² |
| “Porous surface” acid- | 1 | 8 × 10⁵ | 1.0 × 10² |
| form zeolite | 2 | 8 × 10⁵ | 4.8 × 10¹ |
| | 3 | 8 × 10⁵ | <1 |
| | average | 8 × 10⁵ | 5.1 × 10¹ |

Both the acid-form and the porous acid-form zeolites showed excellent activity against E. coli, producing a population reduction of 6 orders of magnitude relative to the control, and effectively eliminating the entire population. Against S. cerevisiae, the acid-form zeolite produced a population reduction of 4 orders of magnitude relative to the control, while the porous acid-form zeolite was on average 4 times more effective than the plain acid-form zeolite. Without wishing to be bound by theory, it appears that the presence of additional pores on the surface produces a larger effective surface and hence a larger effective surface charge, increasing the effectiveness of the “porous surface” acid-form zeolite relative to that of the acid-form zeolite.

### Example 36

An antimicrobial zeolite immobilized by extrusion in an EVA matrix was manufactured and its efficacy for control of the population of E. coli was tested.

Compounding of the zeolite/EVA formulation was performed as follows. The temperature of a BUSS MDK-46 extruder was set to 90° C. Due to friction, the temperature rose to 134° C. The temperature of the secondary extruder was set to 126° C. A 1:1 by weight mixture of EVATANE 40-55 EVA, obtained from Arkema (France), and CP 811C-300 zeolite (H-Beta-360), obtained from Zeolyst (USA), was fed through the first feeding zone. The second feeding zone was fed with zeolite. The total ratio of the weight of material fed into the first feeding zone to the weight of material fed into the second feeding zone was 60:40, to yield a granular zeolite/EVA composition comprising 70% by weight zeolite.

The composition was then placed between two nylon sheets in a press that had been heated to 90° C. The press was closed but without pressure and the sample was heated for about 20 sec. A pressure of 350 bars was then applied. The resulting pressed sheet was then cooled on the metal plate of the press.

Six squares were cut from the cooled pressed zeolite/EVA sheets. Scratches were made in three of the six squares in order to increase the surface area.

The antimicrobial activity of the sheets was tested by ASTM method E2149. The pour plate method was used. Tests were done in a 10 ml container. Microorganisms were incubated at 30° C. for 24 hours. For E. coli, the liquid was TSB diluted 1:100, TSA medium was used for the plates, and the initial concentration was 3.4×10⁵ CFU/ml. Results of the microbiology experiments are given in Table 38.

TABLE 38
ASTM E2149 results for antimicrobial activity of
zeolite/EVA extruded sheets against E. coli

| | | Initial | Concentration |
|---|---|---|---|
| | | concentration, | after 24 h, |
| Zeolite type | Sample No. | CFU/ml | CFU/ml |
| Control (no zeolite) | 1 | 3.4 × 10⁵ | 1.8 × 10⁷ |
| | 2 | 3.4 × 10⁵ | 1.1 × 10⁷ |
| | 3 | 3.4 × 10⁵ | 1.9 × 10⁷ |
| | average | 3.4 × 10⁵ | 1.6 × 10⁷ |
| 70% H-Beta-360 in | 1 | 3.4 × 10⁵ | <1 |
| EVA, scratched surface | 2 | 3.4 × 10⁵ | <1 |
| | 3 | 3.4 × 10⁵ | <1 |
| | average | 3.4 × 10⁵ | <1 |
| 70% H-Beta-360 in | 1 | 3.4 × 10⁵ | <1 |
| EVA, surface untreated | 2 | 3.4 × 10⁵ | <1 |
| | 3 | 3.4 × 10⁵ | <1 |
| | average | 3.4 × 10⁵ | <1 |

As can be seen from the results reported in the table, 24 hours of exposure of the medium to the zeolite/EVA led to complete elimination of the E. coli population.

### Example 37

An antimicrobial zeolite/LDPE composition was prepared, and bottles manufactured from the composition. The efficacy of these bottles in controlling the microbial population in milk contained within them was tested.

Zeolite immobilized in an LDPE matrix was prepared as follows. The temperature of a BUSS MDK-46 extruder was set to 135° C. Due to friction, the temperature rose to 160° C. The temperature of the secondary extruder was set to 145° C. A 1:1 by weight mixture of LDPE, obtained from Carmel Olefins (Israel), and CP 811C-300 zeolite (H-Beta-360), obtained from Zeolyst (USA), was fed through the first feeding zone. The second feeding zone was fed with zeolite. The total ratio of the weight of material fed into the first feeding zone to the weight of material fed into the second feeding zone was 60:40, to yield a stable granular zeolite/LDPE composition comprising 60%-70% by weight zeolite. The process was performed for three different grades of LDPE (LDPE 111, LDPE 323, and LDPE 670), and similar results were obtained for all three grades.

Two-layer bottles were then prepared by extrusion blow molding. The 0.1 mm thickness internal layer consisted of a composition containing either 50% or 60% by weight zeolite immobilized in LDPE. The external layer was a standard HDPE 0.5 L 27gr HDPE bottle. The bottles were then filled with fresh milk (3% fat) and incubated at 30° C. or room temperature. As a control, was filled in Oplon active and control bottles and incubated at 30° C. or room temperature. Contamination levels were tested over the course of 21 days.

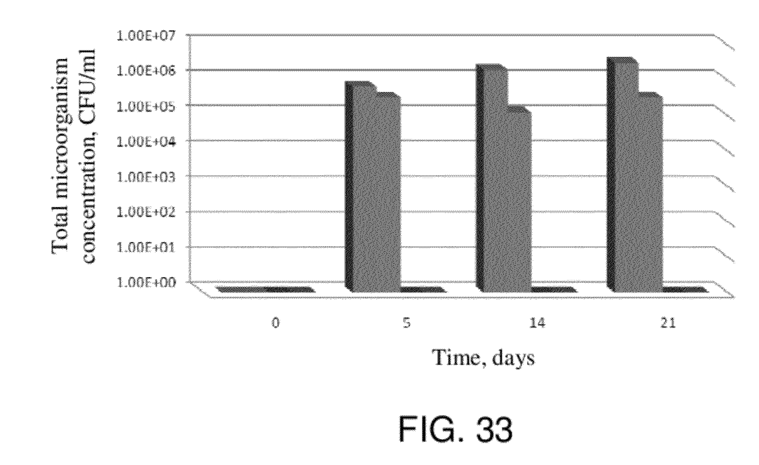

Reference is now made to FIG. 33, which presents a histogram summarizing the results of the test. Results are presented showing the microbial population (total concentration of microorganisms in CFU/ml on a logarithmic scale) at 0, 5, 14, and 21 days following introduction of milk into the bottles. The four bars at each time represent, from left to right, results for control bottles, bottles containing a layer of 50% zeolite in LDPE, and two independent sets of data for bottles containing a layer of 60% zeolite in LDPE. The bottles containing a layer of 50% zeolite in LDPE produced an approximately 1-log reduction in the microbial population relative to the controls, while those containing a layer of 60% zeolite in LDPE succeeded in completely preventing microbial growth during the time over which tests were made.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The applicant reserves the right to pursue such inventions in later claims.

We claim:

1. A biocidic composition comprising an ion exchange material, wherein when said material is in an environment capable of transporting H⁺ ions, said material is adapted to cause the death of at least one cell within or in contact with said environment.

2. The composition of claim 1, wherein said cell is a prokaryotic cell or a eukaryotic cell.

3. The composition of claim 2, wherein said cell is a bacterial cell.

4. The composition of claim 1, wherein said ion exchange material is adapted to kill said cell without inserting any of its structure into the membrane of said cell or without creating a covalent bond with the membrane of said cell.

5. The composition of claim 1, wherein said ion exchange material comprises one or more functional groups selected from the group consisting of sulfonic acid, phosphonic acid, quaternary amine, tertiary amine, hydroxyl, sulfonated polystyrene, and derivatives thereof.

6. The composition of claim 1, wherein said ion exchange material comprises one or more functional groups selected from the group consisting of carboxylic acid and derivatives thereof, phosphinic acid and derivatives thereof, phenol and derivatives thereof, arsonic acid and derivatives thereof, selenic acid and derivatives thereof, secondary amine and derivatives thereof, and primary amine and derivatives thereof.

7. The composition of claim 1, wherein the material has volumetric buffering capacity is at least 20 mM H⁺/(L.pH unit).

8. The composition of claim 7, wherein the volumetric buffering capacity is at least 100 mM H⁺/(L.pH unit).

9. The composition of claim 1, wherein the composition has an H⁺ concentration of greater than about 3.2×10⁻⁵ M or less than about 10⁻⁸ M.

10. The composition of claim 1, wherein the composition comprises a pH gradient along at least a portion thereof.

11. The composition of claim 1, wherein the composition comprises a plurality of regions of differing pH.

12. The composition of claim 1, wherein the ion exchange material comprises a zeolite is substantially free of heavy metals, ions or salts thereof.

13. The composition of claim 12, wherein substantially all cations outside of the zeolite framework have been exchanged by protons (H⁺), thereby forming an acidic zeolite; and/or said zeolite is a product of a reaction that imparts to it Lewis-base character, thereby forming a basic zeolite;

14. The composition of claim 13, wherein the H⁺ concentration within said acidic zeolite biocide is ≧10⁻³ mol L⁻¹.

15. The composition of claim 13, wherein the H⁺ concentration within said basic zeolite biocide is ≦about 10⁻⁸ mol L⁻¹.

16. The composition of claim 13, wherein the surface of said zeolite has a surface charge with a surface charge density of at least about 1×10⁻⁹ C/cm², and further wherein substantially all of said surface charge density originates from said zeolite.

17. The composition of claim 13, wherein said acidic zeolite is chosen from the group consisting of mordenite, clinoptilite and acidic zeolites prepared from zeolites chosen from the group consisting of β-zeolite, ZSM-23, ZSM-5, zeolite A, and zeolite Y.

18. The composition of claim 1, wherein the ion exchange material comprises a polymer.

19. The composition of claim 1, wherein the ion exchange material comprises cationic silica.

20. The composition of claim 1, wherein the composition comprises at least a portion of a coating or a component of a medical device, a wound dressing, sutures, cloth, fabric and a wound ointment.

21. The composition of claim 1, wherein the composition is in the form of a shaped article, a coating, a spray, a film, a laminate on a film, a film in a laminate, sheets, beads, beads incorporated in fabric, particles, microparticles, microcapsules, microemulsions or nanoparticles.

22. The composition of claim 1, further covered by a barrier layer, said barrier layer characterized as being selectively permeable to water.

23. The composition of claim 1, further covered by a barrier layer, wherein said barrier layer is adapted to prevent ions larger than H⁺ and OH⁻ from neutralizing said ion exchange material.

24. The composition of claim 1, further covered by a barrier layer, said barrier layer characterized as being permeable to a preselected target cell but not to preselected non-target cells.
